(19) United States
(12) Patent Application Publication
(10) Pub. No.: US 2024/0354567 A1
(43) Pub. Date: Oct. 24, 2024

(54) KNOWLEDGE-DRIVEN AUTOMATION PLATFORM TO CONNECT, CONTEXTUALIZE, AND CONTROL ARTIFICIAL INTELLIGENCE TECHNOLOGIES INCLUDING GENERATIVE AI REPRESENTING A PRACTICAL IMPLEMENTATION OF NEURO-SYMBOLIC AI

(71) Applicant: ENTERPRISEWEB LLC, Glens Falls, NY (US)

(72) Inventors: Dave M. DUGGAL, Glens Falls, NY (US); William J. MALYK, Guelph (CA)

(73) Assignee: ENTERPRISEWEB LLC, Glens Falls, NY (US)

(21) Appl. No.: 18/638,378

(22) Filed: Apr. 17, 2024

Related U.S. Application Data
(60) Provisional application No. 63/459,911, filed on Apr. 17, 2023.

(51) Int. Cl. G06N 3/08

(52) U.S. Cl. CPC G06N 3/08

(57) ABSTRACT

Disclosed herein are system, method, and device embodiments for integrating artificial intelligence technologies, including generative AI with a knowledge-driven automation platform, to realize a practical implementation of Neuro-Symbolic AI. The disclosed techniques mediate interactions with artificial intelligences, grounding and enriching the interactions with context in order to optimize the processing of the interactions, the quality of the related outputs of artificial intelligence technologies, and the related actions of the automation platform, which may be part of a larger activity.

### CROSS-REFERENCE TO RELATED APPLICATIONS

This application claims the benefit of U.S. Provisional Patent Application No. 63/459,911 by Duggal, et al., titled “Generative Artificial Intelligence Automation,” filed on Apr. 17, 2023, which is incorporated by reference herein in its entirety.

### BACKGROUND

While generative Artificial Intelligence (“AI”) use in industry is nascent with narrow use-cases and lots of non-production experimentation, it represents a new secular trend that has already shaken up the software and IT industry. The highly-interactive and contextual, natural language, human-computer interactions that generative AI demonstrates have captured the imagination and raised expectations of what user-experiences can be.

Despite appearances of its natural language, conversational interface, the large language models (“LLMs”) associated with Generative AI do not understand the context of the prompts they receive or the relevance of their own responses. LLMs do not reason, they cannot explain, which is why Generative AI has earned the epithet “Stochastic Parrot.” LLM processing does not involve knowledge-based logical deductions. Its outputs are the result of vector approximations of point-based, geometric, or other embedding methods to support induction; they are not exact matches and they never return deterministic results.

LLM outputs are based on purely statistical probabilities drawn from its training data. Deep Learning technologies, such as those found in generative AI and neural networks, are based on vast amounts, often petabytes, of unlabeled, unstructured data with unsupervised model training. Deep Learning is an alternative to, and often viewed as a reaction to, Symbolic or “classic” AI, which involves labeled and structured data with manually curated models. Deep Learning focuses on a computational brute force approach to inferring relationships between words (or pixels), as opposed to the bespoke logical models.

Attempts to recreate structured knowledge in LLMs have limited efficacy. The act of flattening SQL relational or graph database (i.e., RDF or LPG) models to vector-embeddings for the LLM removes all logical relationships. Adding weights to the deconstructed data in an effort to approximate the modeled relationships inside the LLM is a form of fine-grained tuning (i.e., manual curation) to manipulate the LLM to produce a marginally better outcome. However, such workarounds do not change the probabilistic nature of LLM processing and cannot lead to consistent, predictable results (i.e., an irrational actor).

Since LLM processing is not deterministic there is no guarantee of the LLM output for a given set of inputs, no matter what the training, tuning, and prompting methods are (n.b., studies have even shown a diminishing return on over-training, tuning, or prompting LLMs). Consequently, LLM benchmarks are not an objective measure of LLM output accuracy for a given context, but rather a subjective measure of whether an LLM output is arguably acceptable; does it satisfice the prompt, even if objectively wrong in context of the use-case. That is a low standard of correctness.

Despite concerns about Generative AI's well-documented limitations and undesirable characteristics (e.g., inaccuracy, inconsistency, bias, hallucinations, lack of explainability, source training data copyright concerns, company intellectual property concerns, security, latency, cost, energy and resource consumption issues, model collapse, catastrophic forgetting), there is a global competition to determine what companies will dominate the next generation of AI-enabled software.

Large incumbent vendors are under market pressure to refresh their product portfolios to boost sales and stock prices, lest they be disrupted. Conversely, small and new companies are rushing to fill the void and become innovative leaders in this emerging space.

One of the early use-cases for generative AI involves generating summaries of large volumes of unstructured information, which is a time consuming, error-prone, and tedious task for humans. Generative AI is quite good at this subjective task, which has been historically out of the reach of business software. Another use-case is generating draft documents, artwork, code, etc., much as a human assistant might do. Again, outputs are subjective and the process tends to be iterative with human oversight, which plays to Generative AI's strengths. It tends to do less well on complex tasks that require accuracy based on deep domain knowledge or temporal awareness of current state. In this regard, the use-cases for generative AI are wide, but significantly constrained.

Code generation is a widely promoted direct use case for generative AI (MICROSOFT CODEPILOT, JETBRAINS AI, AMAZON CODEWHISPERER, IBM WATSON CODE ASSISTANT, META CODE LLAMA, COGNITION LABS DEVIN AI, etc.), but given the complexity of software code, the bespoke nature of software development and the impact of even minor syntactic errors within code, code generation has limited efficacy. Code generation tools do not build complete applications, processes, or services. They are generally used by software developers in combination with Integrated Development Environments (IDEs). Since the likelihood of defects goes up with the complexity of the request, more effort may be spent tediously reviewing, debugging, and testing LLM-generated code than the effort required to produce it manually. The lack of deterministic measures for correctness, consistency, and explainability introduce software safety concerns. To date, code generation has generally been used narrowly as a development assistant for routine development tasks (i.e., debug, code analysis, documentation generation, etc.).

While a few of the giant tech “hyper-scaler” companies (e.g., MICROSOFT AZURE, GOOGLE CLOUD PLATFORM, AMAZON WEB SERVICES) have spent years working behind the scenes to refine Deep Learning technologies and build the related infrastructure to support Generative AI, much of the surrounding technology eco-system is being sped to market to fill voids quickly. The gold-rush zeitgeist of this moment in the software industry makes it hard to comprehend the rapidly evolving product landscape, let alone build a stable, future-forward solution architecture.

There are an ever-growing number of new tools (e.g., LANGCHAIN, HAYSTACK, DSPY, COHERE, AIRFLOW) that focus on techniques for improving LLM training, tuning, or prompting to realize better LLM outputs (i.e., an LLM-oriented generative AI architecture) to compensate for generative AI accuracy, consistency, bias, and hallucination issues. These tools are not standalone solutions, but rather discrete functions that have to be integrated as part of a larger solution. They focus on specific tasks related to working with the Large Language Models (LLMs) associated with Generative AI. As a result, the individual tools generally give little consideration of non-functional concerns (e.g., security, scalability, performance).

Big and often unsupported claims are made by vendors and the media suggesting varying combinations of tools solve all problems associated with Generative AI. However, such tool-chain based approaches, including open-source frameworks (i.e., a prescribed set of tools), introduce their own complexity and overhead. Manually integrating a set of static and targeted tools will not necessarily provide an optimal solution. Such bolt-on approaches result in ad-hoc solutions (i.e., “accidental” architecture) that are only as secure, scalable, and performant as the weakest solution element. These tools combine to generally form flimsy scaffolding rapidly assembled to let developers experiment with Generative AI.

One emerging technique, Retrieval Augmented Generation (“RAG”) uses external information, typically unstructured documents or a database (e.g., relational databases, NoSQL databases, graph databases) to support LLM tuning and prompts. While there are many RAG variants, the common objective is to feed use-case specific domain knowledge to the LLM as context with the intent of refining LLM outputs.

RAG is generally implemented as a tool-chain with static, manually-coded workflows or “pipelines” to connect an LLM with the external information, in a series of prescribed steps per use-case (e.g., static Directed Acyclic Graph (“DAG”) or Business Process Management Notation (“BPMN”)-like flowchart). In general, other training, tuning and prompting techniques are implemented in a similar manner. Each technique, and each variant of a technique, generally involves a different combination of tightly-coupled tools in a use-case specific configuration. As a result, training, prompting, and tuning largely remains a specialized practice, without a general solution for automation and management.

The need for RAG, and the many other LLM tuning and prompting techniques (e.g., graph RAG, agentic RAG, right for right reasons, graph-of thoughts, chain-of-thoughts, step-back prompting, retrieval augmented thoughts, retrieval-augmented thought process, retrieval-augmented fine-tuning, generative representational instruction tuning, reasoning on graphs) is a tacit acknowledgement of the limitations of standalone LLMs. All of these techniques are forms of iterative trial-and-error that attempt to mimic the recursive reasoning possible with classic AI. Most of these techniques lean on tree-based induction, which has known limitations and leads to processing inefficiency and implementation complexity.

While tuning and prompting techniques may incorporate rules and models to make their internal process of retrieving contextual content to the LLM more automated and deterministic, such techniques cannot change the probabilistic nature of LLMs. All of these techniques, intended to marginally improve LLM outputs and minimize hallucinations, are labor intensive workarounds for Deep Learning methods, which are supposed to be unsupervised. Deep Learning has not eliminated curation; it merely outsourced the quality control task to every user. Apparently, “attention” is not all you need.

However, the software industry is undeterred. The race is already underway to leverage Generative AI, along with other Deep Learning (i.e., Neural Networks), classic AI, and Machine Learning (“ML”) methods, and traditional analytics (i.e., collectively hybrid-AI) to improve business productivity and automation across all industry sectors. The “killer app” is real-time, contextual automation for its promise to transform user-experiences, improve business outcomes and dramatically reduce labor costs.

While LLMs can generate outputs of various types, they do not directly execute general application behavior. They must be combined with other technologies (e.g., bots, agents) that can take such actions. To date, automation using generative AI is limited to simple bots, often implemented as Actors, with coded functions, typically using Python, generally handling lite tasks where the threshold for safety and correctness is lower and human oversight is anticipated. The combination of LLMs and bots or agents that generally perform some limited behaviors and potentially call some functions is being referred to as Large Action Models (“LAMs”). LAMs are an emerging area bringing together emerging technologies. At this early stage, LAMs are not general enterprise-grade platforms for mission critical automation use-cases. Work on autonomous agents remains primarily the subject of academic research and is typically heavily engineered for targeted use-cases.

The challenge for Generative AI is that it is probabilistic. Deep Learning methods are not deterministic and transactional as is required for authoritative, enterprise-grade Information Technologies (“IT”) and Operational Technologies (“OT”) where software safety, correctness, and explainability are critical. While Generative AI appears to provide unprecedented and seemingly magical new capabilities, its methods are not dependable, undermining trust in its outputs.

This probabilistic-deterministic divide echoes a historic boundary in software between Online Analytics Processing (“OLAP”) and Online Transaction Processing (“OLTP”). Traditional analytics and “classic” AI methods draw statistical inferences and predictions from labeled, structured data that depends on manual or semi-automated curation. This approach makes OLAP outputs logical, predictable and explainable so they can be tested and trusted. OLAP and OLTP are understood to be complementary technologies. It is generally understood that timely inferences, even predictions, can improve automated decisions and optimize actions.

Traditionally, automation platforms can call analytics or AI services as part of their runtime processing (e.g., complex event processing, intelligent automation). Relevant context is passed with each request, and the probabilistic output of the service is an input to the automation system. The platform's interface ensures each analytics or AI service is an authorized system client and that the values it provides are properly formatted, typed and validated so they can be safely processed.

However, with generative AI, the context of LLM outputs has to be established upfront with each interaction with the automation system. LLM outputs have to be grounded by domain knowledge to deterministically interpret the context so the output is transformed into a set of values the automation system can syntactically and semantically validate so they can be safely processed.

While Graph Databases (i.e., Resource Description Framework (“RDF”) and Labeled Property Graphs (“LPG”)) are leveraged to optimize training, tuning, and prompting to improve LLM outputs, the fundamental design of Graph Databases (i.e., triples, explicit mappings, set theory, trees, first order logic) generally lacks many of the characteristics necessary for complex, real-time, enterprise-grade, knowledge-driven behavior (e.g., functional programming methods, higher-order logic, categories, commutative properties, system types, software contracts, temporal history), which is the motivation of this filing. As a class, Graph Databases tend to be data-centric for data-science, queries, analytics, and recommendations, but are not directly capable of deterministically translating Generative AI outputs into safe, contextual actions.

Beyond the design issues outlined above, Graph Databases are generally not used for operational systems that are responsible for state management because they either they lack the transaction controls required to ensure consistency or because they do not have the required read and write performance to serve context for real-time applications at scale. Analytics, queries, and recommendations tend not to have the same consistency or performance requirements. Extending Graph Databases with other related languages, tools, and libraries (e.g., OWL, SHACL, PathQL, TTL, TriG, JSON-LD, RDF*) run into similar limits of the LLM tool-chains mentioned above (i.e., complexity, performance), and still do not result in real-time, enterprise-grade automation systems.

Conversely, there are innumerable application development technologies of various types and capabilities, including model-driven and no-code platforms, but they generally lack the technical foundation for knowledge-driven automation. They can integrate generative AI capabilities, but just like Graph Database techniques, they are not directly capable of deterministically translating Generative AI outputs into safe, contextual actions.

Exclusive focus on improving LLM outputs (i.e., LLM-oriented generative AI architecture) is not a path to complex, real-time, enterprise-grade, knowledge-driven behavior. For this objective, industry must consider that Deep Learning technologies such as generative AI are not solutions, but rather parts of larger future-forward and backward-compatible solution architectures. The problem is understood to be complex, and solutions are generally considered to be years out.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a block diagram of a generic architecture, according to some embodiments.

FIG. 2 is a block diagram of a generic architecture with common UC elements, according to some embodiments.

FIG. 3 is a block diagram of a system architecture diagram, according to some embodiments.

FIG. 4 is a block diagram of a domain-oriented generative AI architecture, according to some embodiments.

FIGS. 5A-5I illustrate a method for performing knowledge-driven orchestration for complex, multi-step processes to optimize fine-tuning and prompting that can be applied to voice-based generative AI requests, according to some embodiments.

FIGS. 6A-6H illustrate a method for performing knowledge-driven orchestration for complex, multi-step processes to optimize fine-tuning and prompting that can be applied to LLM prompting, according to some embodiments.

FIG. 7 is a block diagram of a conceptual architecture for deploying and assuring an optimized 5G/RAN (Radio Access Network) with a secure Edge Gateway, according to some embodiments.

FIG. 8 is a block diagram of a functional architecture for deploying and assuring an optimized 5G/RAN (Radio Access Network) with a secure Edge Gateway, according to some embodiments.

FIG. 9 is a block diagram of a service topology for deploying and assuring an optimized 5G/RAN (Radio Access Network) with a secure Edge Gateway, according to some embodiments.

FIG. 10 is a block diagram of a solution architecture for deploying and assuring an optimized 5G/RAN (Radio Access Network) with a secure Edge Gateway, according to some embodiments.

FIGS. 11A-11D illustrate a method for performing Day 0 onboarding for an optimized 5G/RAN (Radio Access Network) with a secure Edge Gateway, according to some embodiments.

FIGS. 12A-12J illustrate a method for performing Day 0 design for an optimized 5G/RAN (Radio Access Network) with a secure Edge Gateway, according to some embodiments.

FIGS. 13A-13C illustrate a method for performing day-one deployment for an optimized 5G/RAN (Radio Access Network) with a secure Edge Gateway, according to some embodiments.

FIG. 14 illustrates a method for performing day-two closed-loop RAN optimization for an optimized 5G/RAN (Radio Access Network) with a secure Edge Gateway, according to some embodiments.

FIG. 15 illustrates a method for performing day-two closed-loop 5G core optimization for an optimized 5G/RAN (Radio Access Network) with a secure Edge Gateway, according to some embodiments.

FIG. 16 is a block diagram of a conceptual architecture for code support where static and dynamic analysis of an application is continually performed and feedback is provided to the programmer on a real-time basis using generative AI, according to some embodiments.

FIG. 17 is a block diagram of a functional architecture for code support where static and dynamic analysis of an application is continually performed and feedback is provided to the programmer on a real-time basis using generative AI, according to some embodiments.

FIG. 18 is a block diagram of a service topology for code support where static and dynamic analysis of an application is continually performed and feedback is provided to the programmer on a real-time basis using generative AI, according to some embodiments.

FIG. 19 is a block diagram of a solution architecture for code support where static and dynamic analysis of an application is continually performed and feedback is provided to the programmer on a real-time basis using generative AI, according to some embodiments.

FIGS. 20A-20B illustrate a method for performing service configuration and LLM tuning, according to some embodiments.

FIG. 21 illustrate a method for performing design-time support, according to some embodiments.

FIG. 22 illustrate a method for performing run-time support, according to some embodiments.

FIG. 23 is a block diagram of a conceptual architecture for using generative AI to design and order a physical Fibre Network, according to some embodiments.

FIG. 24 is a block diagram of a functional architecture for using generative AI to design and order a physical Fibre Network, according to some embodiments.

FIG. 25 is a block diagram of a service topology for using generative AI to design and order a physical Fibre Network, according to some embodiments.

FIG. 26 is a block diagram of a solution architecture for using generative AI to design and order a physical Fibre Network, according to some embodiments.

FIGS. 27A-27D illustrate a method for performing an order and fulfil service, according to some embodiments.

FIG. 28 is a block diagram of a conceptual architecture for developing and deploying an industrial IoT application for computer-vision-based security, according to some embodiments.

FIG. 29 is a block diagram of a functional architecture for developing and deploying an industrial IoT application for computer-vision-based security, according to some embodiments.

FIG. 30 is a block diagram of a service topology for developing and deploying an industrial IoT application for computer-vision-based security, according to some embodiments.

FIG. 31 is a block diagram of a solution architecture for developing and deploying an industrial IoT application for computer-vision-based security, according to some embodiments.

FIGS. 32A-32D illustrate a method for performing day-zero onboarding for developing and deploying an industrial IoT application for computer-vision-based security, according to some embodiments.

FIGS. 33A-33I illustrate a method for performing Day 0 design for developing and deploying an industrial IoT application for computer-vision-based security, according to some embodiments.

FIGS. 34A-34C illustrate a method for performing day-one deployment for developing and deploying an industrial IoT application for computer-vision-based security, according to some embodiments.

FIG. 35 is a block diagram of a domain-oriented generative AI architecture for multi-model applications, according to some embodiments.

FIG. 36 is a block diagram of a general platform for hypergraph-based metaprogramming, according to some embodiments.

FIG. 37 is a block diagram of a monadic transformer/hypergraph interaction model, according to some embodiments.

FIG. 38 illustrates a computer system, according to exemplary embodiments of the present disclosure.

The present disclosure will be described with reference to the accompanying drawings. In the drawings, like reference numbers indicate identical or functionally similar elements. Additionally, the left-most digit of a reference number identifies the drawing in which the reference number first appears.

### DETAILED DESCRIPTION OF THE INVENTION

EnterpriseWeb's generative AI solution is a novel implementation of Neuro-Symbolic AI. It bridges modern Deep Learning technologies with classic AI methods (e.g., Knowledge Graphs, List Processing, Metaprogramming, Expert Systems) that go back as far as the origins of AI in the 1950s. Enterprise Web provides a single platform-based solution that supports knowledge-driven orchestration for complex, multi-step processes to optimize fine-tuning and prompting (e.g., intelligent ModelOps and graph Retrieval-Augmented Thought processes) and is capable of extending such processing with complex, real-time, enterprise-grade, knowledge-driven behavior as part of a larger system interaction.

Rather than focusing on solely on LLM code generation or on improving LLM outputs and simply accepting the fundamental limitations and issues with probabilistic Deep Learning methods, EnterpiseWeb presents a practical enterprise-grade solution to leveraging generative AI strengths, while mitigating its weaknesses.

Enterprise Web provides a declarative abstraction and a behavioral, intent-based, no-code interface over the platform, enabling users to describe “what” they want, without having to specify “how” it gets implemented. Its platform user interface (“UI”) and application programming interface (“API”) are interactive; users provide inputs and make selections and the platform's runtime contextualizes its response, speeding and easing business and technical tasks. In this regard, EnterpriseWeb was already offering a more natural form of human computer interaction, which is an understood objective of metaprogramming and symbolic AI techniques generally.

Enterprise Web incorporates generative AI as a third-platform interface that is fully integrated into the platform, enabling users to have a natural language conversation with Enterprise Web and its wide range of design, automation and management capabilities. Users can even flexibly move between working in the platform UI, API, and now generative AI interfaces, without switching their work context. The platform keeps all interactions across the interfaces synchronized. At any time, a user can engage the generative AI interface, much like they might address AMAZON ALEXA or APPLE SIRI, except that the interaction is with an enterprise-grade automation platform. EnterpriseWeb even incorporates generative AI cues on the UI that indicate the type of prompts available on any given screen. The generative AI cues update as the user moves through the platform following the flow of their work as an intelligent assistant.

By primarily using generative AI as a natural language interface over its knowledge-driven platform, Enterprise Web shifts most processing away from the LLM running on GPUs (or CPUs) to its platform running on CPUs to securely, deterministically, and efficiently translate Generative AI outputs into safe, contextual actions, including complex, multi-step actions and long-running processes.

EnterpriseWeb's knowledge-based automation platform is built on the company's symbolic language called the Graph Object Action Language (“GOAL”). GOAL implements a multi-dimensional hypergraph. Hypergraphs allow for complex, one-to-many and conditional relationships, which support the modeling of true ontologies with concepts, types, and policies.

EnterpriseWeb's implementation of hypergraph (hereinafter “EnterpriseWeb's hypergraph” or “The hypergraph”) supports the modeling and management of complex, real-time, distributed domains, objects and processes (i.e., ABox information). The hypergraph also captures related operational activity data, metadata and state (i.e., TBox information). By supporting both ABox and TBox information, EnterpriseWeb's hypergraph realizes a formal Knowledge Graph.

EnterpriseWeb's hypergraph also supports rich notions of behavior (i.e., declarative expressions in GOAL, metaprogramming facilities, generative programming primitives), contracts (i.e., pre- and post-conditions) and temporal history (i.e., log of state changes) as graph relationships.

EnterpriseWeb's own system concepts, types, and policies are implemented in the hypergraph, which is logically partitioned as the platform's upper ontology. The upper ontology also contains generic business concepts (i.e., organizational units, people, roles, locations, devices) and a type system with generic IT and distributed system concepts (i.e., types, formats, protocols, interfaces, configurations, behavior).

The upper ontology supports the platform operations, including the design of industry or solution domains (i.e., a Domain Specific Language for modeling Domain Specific Languages). Domains are modeled in the hypergraph and logically partitioned from the upper ontology to separate the concerns, though by design the domain model retains references to the upper ontology. In turn, domains support the modeling of domain objects, which are themselves logically partitioned, and individually loosely-coupled, but likewise retain references to the domain.

EnterpriseWeb's hypergraph is one graph, logically partitioned in three hierarchical layers with references between them. While the hypergraph does support complex, real-time, enterprise-grade, knowledge-driven behavior, GOAL is a symbolic language and so it cannot directly communicate with Deep Learning technologies, such as generative AI and neural networks without first transforming its logical structures into an unstructured format they can process.

Enterprise Web has specific systems and methods for managing interoperability with Deep Learning technologies, such as generative AI and neural networks. EnterpriseWeb describes its solution architecture as a “Domain-oriented generative AI architecture”. The company deploys a vector-native database with a time-series analytics capability as an intermediary between an LLM and knowledge-driven automation platform. This creates a separation of concerns that isolates and contains the use of the LLM so that the LLM can never directly communicate with the automation system. In this way, an OLAP to OLTP-like boundary and trust relationship is established.

Enterprise Web programs the intermediary to translate between the vector language of the LLM and its symbolic language, GOAL.

EnterpriseWeb's intermediary program: 1) Integration Function: syntactically and semantically summarizes EnterpriseWeb's interface, along with high-level system concepts, types and policies (i.e., upper ontology) for the intermediary; and 2) Gateway Function: the program syntactically and semantically summarizes domain concepts, types and policies (i.e., domain model) for the intermediary. The intermediary flattens the symbolic information, into vector embedding, which allow it to mediate communications between the LLM and Enterprise Web.

Outbound communications, from Enterprise Web to the LLM (i.e., training data or prompts), via the intermediary, are tagged with interaction-specific embeddings from the intermediary program, so that intermediary can map LLM responses (i.e., outputs) to the Enterprise Web program and translate them back into the originally provided Symbolic Language. In this regard, EnterpriseWeb's solution is an implementation of Neuro-Symbolic AI; bridging Deep Learning technologies, such as generative AI and neural networks and Symbolic or classic, knowledge-based, AI methods.

For inbound communications, from the LLM to Enterprise Web via the intermediary, EnterpriseWeb uses the Intermediary's interaction-specific references to the upper ontology and domain model concepts, types and policies to ground the LLM output to terms that Enterprise Web deterministically understands, and can efficiently relate to knowledge in the hypergraph (i.e., global context). The references bootstrap the contextualization of LLM outputs. The references provided to domain concepts, types and policies in the upper ontology and knowledge graph, allow EnterpriseWeb to efficiently and deterministically translate LLM outputs using GOAL. Determinism ensures accurate, consistent, explainable system responses that support safe, contextual actions with strong IT governance.

Note: Beyond Deep Learning interoperability support, Enterprise Web can also leverage the intermediary for analytics and observability, in support of closed-loop automation behavior for customer use-cases. It provides EnterpriseWeb the extended capability to autonomously enforce declared operational policies (e.g., service-level agreements, latency requirements, energy consumption preferences) or to continuously optimize performance (e.g., scale, heal, re-configure) in response to a volatile network, attacks, failing nodes or issues with participating solution elements, etc.

Instead of implementing various types of tuning and prompting techniques with varying tools per Deep Learning technology, model and use-case, Enterprise Web provides a single platform-based solution. It supports knowledge-driven orchestration for complex, multi-step processes to optimize fine-tuning and prompting (e.g., intelligent ModelOps and graph Retrieval-Augmented Thought processes), and is capable of extending such processing with complex, real-time, enterprise-grade, knowledge-driven behavior as part of a larger system interaction.

EnterpriseWeb uses generative AI with its ontology to support a natural language interface for intent-based, no-code development and knowledge-driven, automation and zero-touch management. It provides a unified developer abstraction (e.g., common model, libraries and single platform-based workflow) to simplify and automate IT tasks for working in a multi-model, hybrid AI world. It supports ModelOps, intelligent automation and AIOps with security and identity, reliable messaging, transaction guarantees, state management and lifecycle management.

EnterpriseWeb's domain-oriented generative AI architecture, by externalizing context processing and automation outside the LLM acting as a stateful knowledge-based backend, directly addresses the long list of LLM concerns. It provides indirection for security, improves outputs, reduces the number of LLM prompts and tokens, minimizes LLM training and tuning requirements, lowers overall resource and energy consumption. EnterpriseWeb supports public Cloud LLMs and locally-deployed open-source models. It supports multiple LLM models to avoid lock-in and allow for continuing innovation.

EnterpriseWeb's platform can be described as a cloud-native Integrated Development Environment (“IDE”), that includes a design and execution environment, a hypergraph-based Domain Specific Language (DSL), shared catalog and libraries, and common platform services with a serverless runtime.

EnterpriseWeb's knowledge-driven automation platform's general ability to integrate with third-party systems as part of a federated solution, enables it to rapidly onboard innovation, such as generative AI. Enterprise Web deterministic platform naturally complements all forms of analytics and AI, including generative AI and neural networks, leveraging inferences and predictions to optimize actions in a controlled deterministic manner, while still capable of simply optimizing an LLM output in support of a client request, where an LLM output itself is the desired system response.

EnterpriseWeb's implementation of its platform and its GOAL language also represents a novel implementation of Metaprogramming, Hypergraphs, Hindley-Milner types, Monadic Laws, and Serverless that advances the state-of-the-art.

Metaprogramming is a programming technique, supporting homoiconicity for software reflection, which enables generic programming, higher-order logic (HOL), and generative programming (i.e., code that writes code). John McCarthy, generally regarded as the founder of Artificial Intelligence (AI), was the inventor of Lisp (i.e., LISt Processing), the first Metaprogramming language, which used primitive functions as symbolic expressions supporting recursive reasoning over code and data.

Metaprogramming languages are designed for general compute and application behavior, moving further from machine code to human like expressions to ease and automate software development and management. In these regards, Metaprogramming is well suited foundation for bridging probabilistic Deep Learning technologies, such as generative AI and Neural Networks, with deterministic Symbolic AI to realize an implementation of Neuro-Symbolic AI enabling a conversational natural language interface for intent-based, knowledge-driven automation.

Metaprogramming is related to, but distinct from Logic Programming (e.g., Prolog, et al.), which is based on first order logic (FOL) and generally used for computing complex queries, not behavior. The objective of Metaprogramming is to use high-level abstraction to hide complexity of programming leaving it to a Metaprogramming language's interpreter to provide optimized implementations. Metaprogramming, by definition, includes many powerful development features implemented at the language level (e.g., garbage collection, forward and backward chaining, Read-Eval-Print Loop, higher-order functions, conditionals). However, the design and use of Metaprogramming languages requires advanced understanding of Computer Science, Mathematics, and Systems Engineering, which accounts for their low popularity and mostly academic use.

Enterprise Web was motivated by the requirements and challenges of real-time intelligent automation for complex distributed systems. To that end, it provides a novel implementation of Metaprogramming, raised from a software language to an intent-based no-code knowledge-driven automation platform with interactive user interfaces (“UIs”), dynamic application programming interfaces (“APIs”) and conversational natural language processing (“NLP”) interfaces. Rather than simply process static arrays, types, and functions contained in lists, EnterpriseWeb's GOAL and its runtime interpreter provide an abstracted implementation over a set of common Metaprogramming patterns that supports a practical and general Metaprogramming platform for highly-dynamic and responsive business, infrastructure, and Industrial Internet of Things (“IoT”) applications. The design of EnterpriseWeb's knowledge-driven automation platform is naturally congruent with analytics and AI tools or systems, so that it can receive inferences and predictions as inputs to inform decisions and optimize actions. Conversely, Enterprise Web can expose, on a controlled basis, its internal models and activity to analytics and AI for observability and machine learning. These properties of Enterprise Web are leveraged for its integration with generative AI for an implementation of Neuro-Symbolic AI.

To realize a practical implementation, EnterpriseWeb's GOAL is distinguished from conventional Metaprogramming languages in several ways, including, but not limited to: 1) static arrays are raised to a hypergraph to support a multi-dimensional ontology, a type system, and an operational domain model; 2) Enterprise Web uses the hypergraph to implement a Bigraph as per the work of Computer Scientist Robin Milner, which provides for discrete management of objects and abstract rewriting from types and transitions; 3) the physical data layer is implemented as an entity, attribute, value (“EAV”) data structure, which supports the most efficient storage model for highly dynamical information (i.e., sparse matrix); 4) static types and class-based inheritance are replaced by dynamic, polymorphic types and prototypal inheritance; 5) static primitive functions are replaced by Monads (i.e., algebraic operators based on Monad Laws) as symbolic expressions in GOAL that enhances recursive reasoning and code re-use (i.e., developer leverage); 6) Monadic Transformers are the runtime interpreter (i.e., encoder and decoder) of the GOAL dynamic language, which provides highly-efficient transaction processing with referential integrity; and 7) since Monadic Transformers are stateless functions that support asynchronous, event-driven, and parallel processing, EnterpriseWeb's platform implements a Serverless-style (i.e., Function-as-a-Service) architecture for efficient resource and energy consumption.

EnterpriseWeb's GOAL uses a form of list style storage and processing because lists generally support highly-efficient storage and transformations. However, EnterpriseWeb implements a hypergraph-based abstraction over the list to move beyond static arrays of conventional Metaprogramming to model, query, navigate, design, deploy, and manage complex communicating and mobile systems that evolve in space and time, which would be otherwise incomprehensible if represented merely in an unstructured list.

The hypergraph supports conditional, typed relations (i.e., abstract sets, category theory, manifolds, lattices) allowing for complex objects with software contracts, temporal history, and non-hierarchical types. EnterpriseWeb's implementation of the hypergraph is created by adding a column for tags so that rows in the list can represent complex, one-to-many and conditional relationships with other rows. The approach virtualizes structure itself. Conceptual and logical views of data are projections for convenience and comprehension, distinct from physical storage. All system requests, queries and commands, from human and system or device clients, are interpreted by the runtime based on their real-time interaction context. The underlying columnar database (e.g., CASSANDRA, COSMOSDB, REDIS) is abstracted away with minimal use of its native services to avoid overhead and enable portability.

Enterprise Web uses an EAV data structure (i.e., “a long-skinny table”) to implement a list over a columnar database. In an EAV data model, each attribute-value pair is a fact describing an entity, and a row in an EAV table stores a single fact.

It is worth noting that RDF triples (subject, object, predicate), the data structure for the Semantic Web, is a specialized form of EAV implemented as a two-dimensional graph database. In contrast, Enterprise Web is an EAV persisted in a columnar database that supports the implementation of a novel form of a multi-dimensional hypergraph, which is projected from the columnar database.

EAV supports the addition of tags as attributes, which map to other rows representing concepts, types and policy in an upper ontology, as well as entities, implementations and instances in a domain. The EAV is deployed as an immutable, append-only, log-style database so it captures state changes (i.e., temporal history as a hypergraph dimension) with efficient non-blocking writes (i.e., inserts for “diffs”) that are dynamically tagged for a chain of history.

| Data | | | EAV | RDF | |
|---|---|---|---|---|---|
| Structure | Label | Implementation | mapping | mapping | Notes |
| Key | Address | URI | Entity | Subject | Like RDF (not a string as in |
| | | | | | LPG) |
| Value | Resource | Blob | Value | Object | Atomic value like RDF |
| | | | | | unless content (not a struct |
| | | | | | as in LPG) |
| Tag | Metadata | HREF | Attribute | Predicate | EnterpriseWeb has |
| | | | | | Metamodel and upper |
| | | | | | ontology (DSL for DSLs) |
| | | | | | This is hard for RDF/OWL |
| | | | | | (verbose hierarchical |
| | | | | | structures) and not part of |
| | | | | | LPG (separate coded |
| | | | | | schemas). EnterpriseWeb is |
| | | | | | Hypergraph: Typed tags are |
| | | | | | indexed and derived |
| | | | | | pointer/relationships |
| | | | | | (concepts, types, policies, |
| | | | | | entities and |
| | | | | | implementations) for both |
| | | | | | functional and non- |
| | | | | | functional concerns |
| | | | | | (security, reliable |
| | | | | | messaging, transaction |
| | | | | | guarantees, state mgt), to |
| | | | | | process an object as a list or |
| | | | | | to project an object from the |
| | | | | | indexes or generate a |
| | | | | | representation |

Columnar-databases generally provide and maintain in-memory indexes, which Enterprise Web leverages for non-blocking reads, to support optimistic concurrency control and a first-in-first out (“FIFO”) queue. This arrangement naturally supports Command Query Separation (“CQS”). EnterpriseWeb uses the physical store for non-blocking writes or commands, and the index for non-blocking reads or queries. This separation divides processing so both can be optimized discretely. Together they give EnterpriseWeb the ability to efficiently “read its own writes.” Dynamically maintaining a complete index in-memory also provides a bidirectional fail-safe; the database can be reconstructed from the index and the index can be reconstructed from the database.

Enterprise Web leverages tags in the EAV data structure to add dimensions, typed relationships, to the hypergraph. The platform includes an upper ontology, a domain knowledge graph, and domain objects with instance data. In addition, EnterpriseWeb models interfaces, workflows, and configurations and related instance data. They all reside in the same EAV and columnar database but are logically separated by the tags. By virtually partitioning data, EnterpriseWeb's language can apply shared libraries rather than introduce new components. EnterpriseWeb's GOAL is a Domain, Object, Interface, Workflow and Configuration language all-in-one. It can apply common methods over shared models and memory (i.e., the ontology) in a unified and extensible platform that is optimized for both reasoning across complex problem spaces and performance. In this regard, Enterprise Web expands on the formal definition of a knowledge graph (i.e., TBox Terminology Component plus ABox Assertion component).

Enterprise Web also adds tags for typed relationships to software contracts, which provide hooks for pre- and post-conditions. The contracts are a vehicle to globally apply policies for non-functional or cross-cutting concerns, which are historically difficult to implement, particularly for complex, distributed systems. EnterpriseWeb uses contracts to enforce system controls (e.g., security and identity, reliable messaging, transaction guarantees), as well as IT governance and business compliance.

Since Metaprogramming supports homoiconicity, allowing functions to be expressed in the language, Enterprise Web can use tags for typed relationships to add another dimension to GOAL's hypergraph separating objects and entities from behavior and implementations, creating a Bigraph. Bigraphs allow Enterprise Web to implement objects as a link graph (e.g., a set of connected nodes optimized for abstract rewriting) and types as a place graph (i.e., trees optimized for continuations). This allows another logical separation of concerns, allowing some specialized methods for each, while they physically reside in the same physical store subject to common system-wide methods.

| Link Graph | Place Graph |
|---|---|
| Object/Concept | Types/Behavior (Hindley-Milner, |
| Abstract Rewriting | Polymorphic Types, Prototypal |
| Entity/Data | Inheritance) |
| Configures types/processes | Transitions |
| | (Continuations/Resumptions) |
| | Declarative expression (composition) |
| | Transforms objects |
| | Directed traversals |
| Conceptualization | Instantiation |
| Encode hypergraph | Decode EAV reference |
| object and write to | and construct |
| EAV (“flatten”) | graph (“project”) |

Enterprise Web implements a form of Hindley-Milner types for dynamic, polymorphic types with non-hierarchical, prototypal inheritance. Since the information persisted as a list in the columnar database is in 6th Normal Form, abstracted from its meaning, direct queries and commands with static functions against the underlying database untenable.

Enterprise Web uses Monadic Transformers as the interpreters of the GOAL language. The Monadic Transformers act as generic and ephemeral agents that are responsible for encoding and decoding system interactions (i.e., events or requests). They hydrate and dehydrate context on behalf of human and system clients.

Monadic Transformers encode new facts by inserting new rows in the EAV data structure. Monadic Transformers decode interactions (i.e., events, requests) by leveraging list processing techniques and affordances over rows.

At machine-level, Monadic Transformers do not perform graph processing, the hypergraph is an abstraction that aids comprehension and use by supporting logical and contextual representations of the unstructured EAV data (i.e., long skinny table or list in columnar database). That being said, there are natural parallels between graph processing and list processing (e.g., abstract sets, adjacency, associativity, rewriting) and the way list pointers work (e.g., tail-calls, continuations), which allows lists to naturally project graphs, but information is not physically persisted in graph form as found in graph databases.

The data in-memory and in the database has only the EAV columnar structure. Monadic Transformers allow interaction context to be efficiently “lifted” from local context (i.e., session and transaction state), following typed hypergraph relationships through the domain model and upper ontology to efficiently construct the global or Monadic context for an interaction, something that is generally deemed too “expensive” (i.e., resource cost, Input/Output cost, and latency of fetching, processing that information if it was even available and the permissions were in place) in any typical distributed systems context. However, this is a foundational capability for a knowledge-driven automation system. lists are processed by the agents the projection is a “force” Directed Acyclic Graph (i.e., a dataflow), where context is used to realize a concrete instantiation.

The control flow of Enterprise Web is a chain of parallel and serial agent (i.e., Monadic Transformer) processing, which affects a dynamically constructed dataflow process to resolve all system events and requests based on interaction context (i.e., saga pattern). Since the hypergraph and its EAV implementation support tags for contracts, non-functional concerns are efficiently processed in-line with the control flow, which means system controls, IT governance and business compliance are enforced dynamically and contextually for every interaction, rather than secondary concerns with separate components and processes. The language runtime enforces software contracts and takes responsibility for application completeness and correctness.

Monadic Transformers leverage the in-memory index as shared memory akin to a Blackboard or “Tuple space” in Linda language. The tags on rows bootstrap traversals across the projected hypergraph relationships. Monads implement a polymorphic Type System, projecting contextual hypergraph relationships from the list for dynamic typing and sub-typing in support of for prototypal inheritance (non-hierarchical types). At the completion of an interaction, the Monads write back to the EAV as durable memory for state changes and dynamic tagging, which triggers other agents to update indexes in-memory.

The Monadic Transformers are a symbolic expression of an algebraic operation (i.e., a stateless, generic constructor pattern) persisted in the database. Monadic Transformers call Monads, also symbolic expressions of algebraic operations (i.e., stateless generic functions or patterns) persisted in the database, as methods to process interactions. Enterprise Web combines Monadic Transformers and generic programming to support highly-complex interactions with a few, re-usable primitive functions that are composed, configured and coordinated to generate all system responses (note: akin to how the four bases of DNA (adenine, thymine, cytosine and guanine) are variously composed as the basis of all life on Earth).

For the purposes of comprehension and use, Enterprise Web composes primitive algebraic operations into higher-level functions that provide recognizable and well understood Message-oriented Middleware behavior (e.g., queue, gateway, broker, connection, integration, orchestration, workflow) that would generally be implemented in discrete software components and manually integrated as a middleware stack. In Enterprise Web, the middleware capabilities are implemented as generic patterns, which are attached by the type system or are specified by developers to support their use cases. In either case, in EnterpriseWeb traditional components are virtualized; middleware is rendered as a service, dynamically dispatched, configured and coordinated by the platform based on interaction context.

While these services are generally exploited with EnterpriseWeb's deterministic methods, Enterprise Web can expose these services as APIs to system clients, even external bots or autonomous agents, that can invoke, if permissioned, Enterprise Web APIs based on their own internal models. As bot and agent planning, reasoning and safety improve, EnterpriseWeb's generalized and contextualizable middleware-as-a-service capabilities can powerfully enable bot and agent capabilities.

Since Monadic Transformers and Monads are stateless, symbolic expressions they support asynchronous, event-driven, and parallel processing. They naturally support a Serverless-style (i.e., Function-as-a-Service) architecture for efficient and elastically-scalable resource and energy consumption.

By using Monadic Transformers and Monads as the runtime, Enterprise Web can leverage their powerful mathematical properties (e.g., associative and commutative) across all interactions. In addition, Monadic Transformers, Monads and related Monad Laws enable Enterprise Web to realize efficient implementation of sophisticated system engineering patterns (e.g., continuations, CRDTs, serialization, aggregates, global context, closures, time stamps) system-wide, rather than requiring their manual, one-off implementation per use-case or as low-level code implementations (e.g., promises, call backs, static dataflows).

The result of EnterpriseWeb's collective design decisions is exceptionally concise code (˜50 mb) that is highly-portable, scalable, and performant. An instance of the Enterprise Web platform eliminates the need for a stack of middleware components or a tool-chain, rather the middleware services are exposed as libraries, alongside the hypergraph, to provide a powerful developer abstraction that simplifies and automates IT tasks. By applying high-level Computer Science techniques and advanced Systems Engineering patterns, Enterprise Web methodically eliminated physical structures that would impede performance and change. Enterprise Web processing performance is independent of the size of the state space.

EnterpriseWeb's concise code provides for a small platform footprint without the usually expected compromises. EnterpriseWeb's platform can be rapidly deployed as a cloud-native application on-premise, in the cloud or at the edge providing advanced capabilities and desirable characteristics. The impact cannot be understated, as it enables new business, infrastructure and industrial IoT use cases. Enterprise Web can provide a distributable knowledge-driven automation platform that supports multi-model and hybrid AI close to the customers need and capable of keeping the processing local, where resources are constrained.

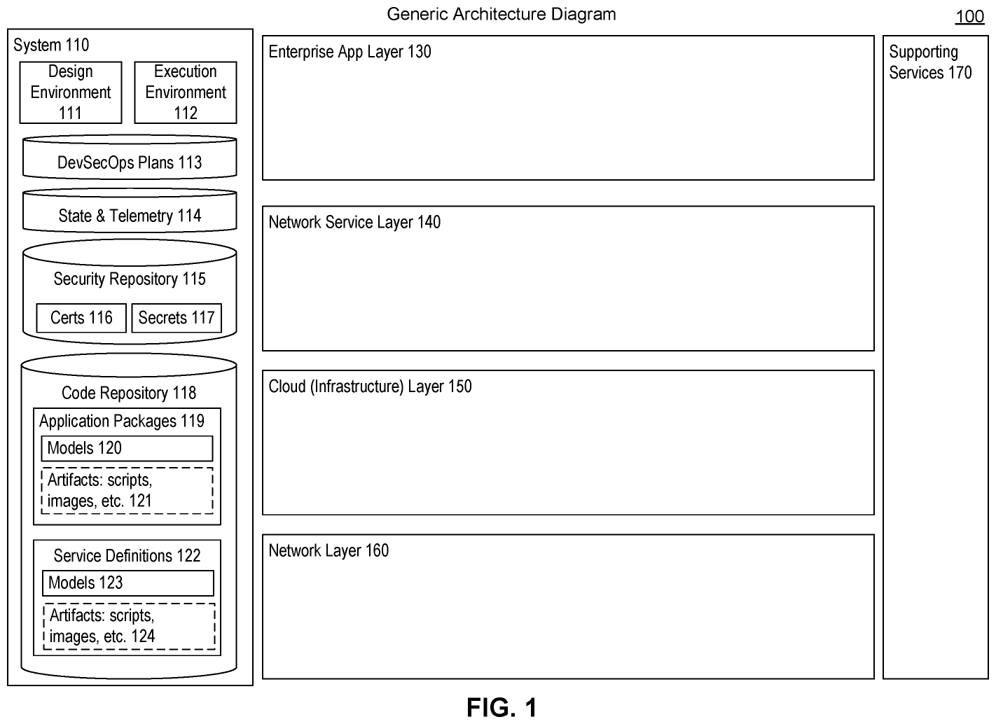

FIG. 1 is a block diagram of a generic architecture 100, according to some embodiments. 4-layer architecture representing Cloud and Telco use-cases in general. “System” on the left represents the typical components used to implement Cloud and Telcom use-cases. Architecture 100 may include system 110, design environment 111, execution environment 112, DevOps plans 113, state and telemetry 114, security repository 115, certificates 116, secrets 117, code repository 118, application packages 119, application package models 120, artifacts related to the application packages 121, service definitions 122, service definition models 123, artifacts related to the service definitions 124, enterprise application layer 130, network service layer 140, cloud layer 150, network layer 160, and supporting services 170.

Systems include a Design Environment supporting: A) onboarding Applications Packages (deployable software components), by modeling their properties and behaviors and uploading connected artifacts such as scripts and images; B) creating Service Definitions by modeling their service graphs and uploading connected artifacts such as scripts and images. Collectively these are referred to as Day 0 Operations. Conventional Design Environments are typical IDEs providing code editors and basic graphic modeling of BPMN processes.

Systems include an Execution Environment supporting the instantiation of the Service Definitions (Day 1 Operations), and their ongoing management (Day 2 Operations). Conventional Execution Environments are “tool chains”, large collections of capabilities including multiple runtime engines, workflow/process execution tools, and supporting middleware, typically tightly coupled/integrated to a particular deployment architecture.

Systems sometimes include dedicated DevSecOp plans (workflows) for executing use-case related operations, conventionally using dedicated CI/CD pipeline/DevOps execution engines.

Systems include a method for gathering State & Telemetry, conventionally this is a set of tightly integrated analytics/monitoring components.

Systems include a Security Repository for storing required security credentials including Certs and Secrets.

Systems include a Code Repository (Catalog) for storing the Application Packages and Service Definitions created in the Design Environment and instantiated/managed by the Execution Environment.

The 4 layers in the middle are the levels of implementation found in most Cloud and Telco Solutions. The Network Layer includes the base connectivity used to connect sites, solution elements, etc. The Cloud (Infrastructure) Layer includes compute, storage and infrastructure management components such as Container or VM controllers. The Network Service Layer includes the network-related solution elements involved in the realizing the use-case including things like Firewalls, RAN controllers, etc. The Enterprise App Layer includes any end-user applications running “over the top” of the constructed network service such as consumer apps, IoT apps, etc.

“Supporting Services” on the right represents the set of additional solution elements supporting the use-case. They can include LLMs and other AI models, non-functional components such as testing/monitoring, and also cloud-based services which may be included in the final solution such as remote databases, external DNS, etc.

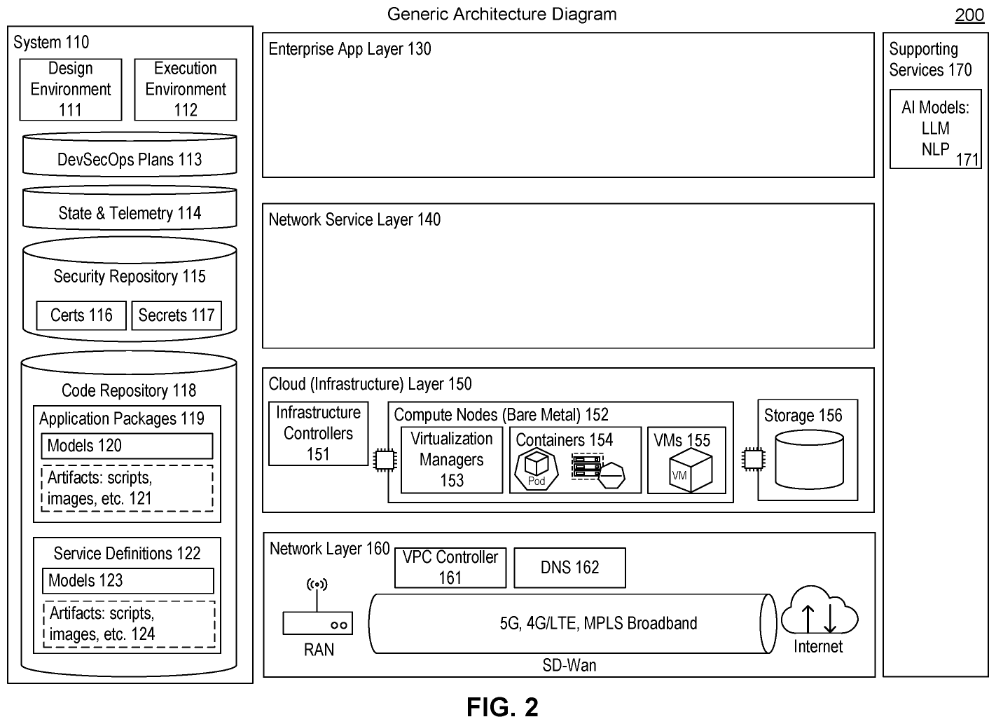

FIG. 2 is a block diagram of a generic architecture 200 with common UC elements, according to some embodiments. Architecture 200 may include system 110, design environment 111, execution environment 112, DevOps plans 113, state and telemetry 114, security repository 115, certificates 116, secrets 117, code repository 118, application packages 119, application package models 120, artifacts related to the application packages 121, service definitions 122, service definition models 123, artifacts related to the service definitions 124, enterprise application layer 130, network service layer 140, cloud layer 150, infrastructure controllers 151, compute nodes 152, virtualization manager 153, containers 154, virtual machines 155, storage 156, network layer 160, virtual private cloud (“VPC”) controller 161, domain name system (“DNS”) 162, supporting services 170, and AI models 171.

The same content as FIG. 1 with common elements depicted in the Cloud (Infrastructure) and Network layers.

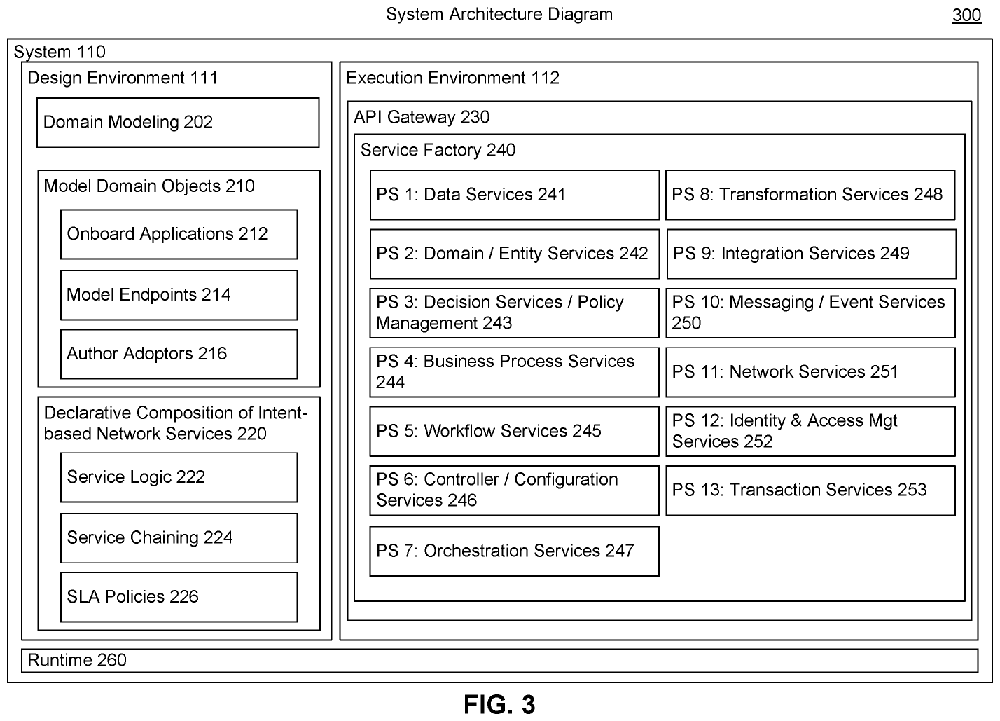

FIG. 3 is a block diagram of system architecture 300, according to some embodiments. The EnterpriseWeb System Architecture includes Design and Execution Environments with a shared Runtime. System architecture 300 may include system 110, design environment 111, domain modeling 202, model domain objects 210, onboard applications 212, model endpoints 214, author adaptors 216, declarative composition 220, service logic 222, service chaining 224, SLA policies 226, execution environment 112, application programming interface (“API”) gateway 230, service factory 240, and platform services 241-253, and runtime 260.

The declarative no-code Design Environment is used for modeling objects, compositions, and processes. Users are supported during design by a type system which dynamically prompts them for inputs based on the context of the tasks they are engaged in, and supports all required tasks for “implementing” Cloud (including Telco) use-cases ranging from high level-domain modeling to composing service definitions.

The integrated Execution Environment provides middleware capabilities implemented as stateless, event-driven Serverless Functions that are dynamically configured and coordinated based on interaction context. Each Platform Service relates to broad area of Message-oriented Middleware and other supporting Services, and is implemented as a generalized pattern for middleware capabilities sharing a common design. Platform Services are composed of a set of algebraic operators that render the contextualized functionality on a per interaction basis.

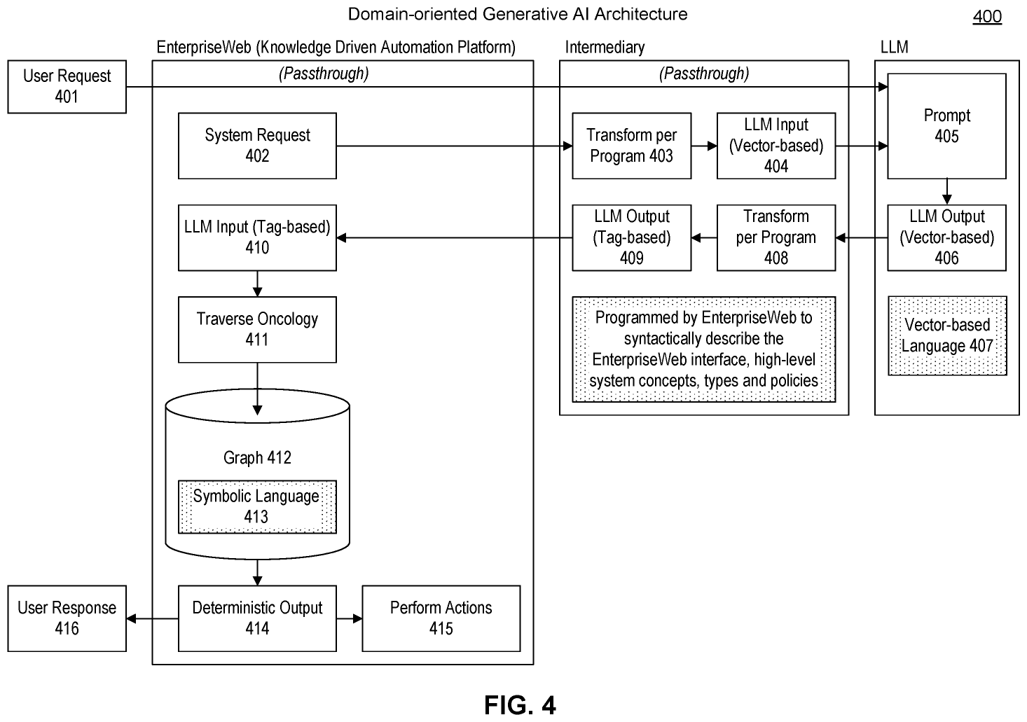

FIG. 4 is a block diagram of a domain-oriented generative AI architecture 400, according to some embodiments. This diagram depicts a high-level flow from request (User or System based) through an LLM and how the architecture allows Enterprise Web to translate the output of LLM based processes to deterministic results.

The architecture uses a vector-native database with a time-series analytics capability as an intermediary between an LLM and the knowledge-driven automation platform, providing a separation of concerns that isolates and contains the use of the LLM so that the LLM never directly communicates with the automation system.

Enterprise Web programs the intermediary to translate between the vector language of the LLM and the symbolic language of its knowledge-based automation platform. The program syntactically describes EnterpriseWeb's interface, high-level system concepts, types, and policies, which get flattened to embeddings, so the intermediary can mediate communications between the LLM and EnterpriseWeb. In addition, EnterpriseWeb's program semantically describes high-level domain concepts, types, and policies so the intermediary can tag outbound Enterprise Web embeddings and prompts and inbound LLM outputs.

Enterprise Web uses the tags on LLM outputs inbound from the intermediary to bootstrap traversal of an ontology. The tags provide mappings back to Enterprise Web's graph; the mappings to the domain concepts, types, and policies allow Enterprise Web to efficiently and deterministically translate LLM outputs. Determinism ensures accurate, consistent, explainable system responses that in turn support safe, contextual actions with strong IT governance.

The flow starts with either a “User Request” or a “System Request.” In the case of a “User Request” the data is passed through EnterpriseWeb and the Intermediary to the LLM directly as a prompt. In the case of a “System Request,” since it will consist of Symbolic Terms from the Enterprise Web ontology, it will be transformed by the Intermediary into a vector-based Input which is added to the LLM prompt. In all cases, the vector-based LLM Output, which is probabilistic in nature, will be passed to the Intermediary which translates it to a tag-based form, which can be syntactically understood by the platform. The intermediary then passes this result as a Tagged-based “LLM Input” to the platform, which uses the tags to traverse its ontology. This traversal contextualizes the response and converts it to one, and only one, deterministic output. That output is then returned as a “User Response” or used to perform subsequent actions by the platform.

Each sequence diagram is organized the same. “System” components for “Platform Services”, “Service Factory”, “API Gateway”, “Persistence”, “Hypergraph” and “Monadic Transformer”, which together are responsible for “Execution”, are shown to the left. For each system interaction, a note indicating which Platform Service is rendered to deliver the task it represents is listed across the set of System Components, then the right side shows the resulting interaction of the actors (federated components) with the system which results.

The Intermediary is a vector-native database with a time-series analytics capability, which mediates/controls interactions with LLMs and other AI Models (via vector embedding capabilities), and separately, can be used to provide programmable AI/Analytics functions. Note, these functions could be performed separately by discrete components, but as they are often handled by the same system so they are depicted here as such. In advance of any execution, the Enterprise Web platform programs the Intermediary to translate between the vector language of the LLM and the symbolic language of its knowledge-based automation platform.

Finally, on the right are a set of federated elements. “NLP” and “LLM” components represent an AI model for Natural Language Processing, and an AI model for Large Language Model prompt/response services, respectively. In practice these could be substituted for any AI-based models, even those with different underlying inference models (example: RNNs). Finally, an “Other Federated Endpoint” component is included to show interactions with external systems at large.

These sequence diagrams are generic system patterns which are executed for common generative AI (“GenAI”) tasks using the EnterpriseWeb canonical method/pattern.

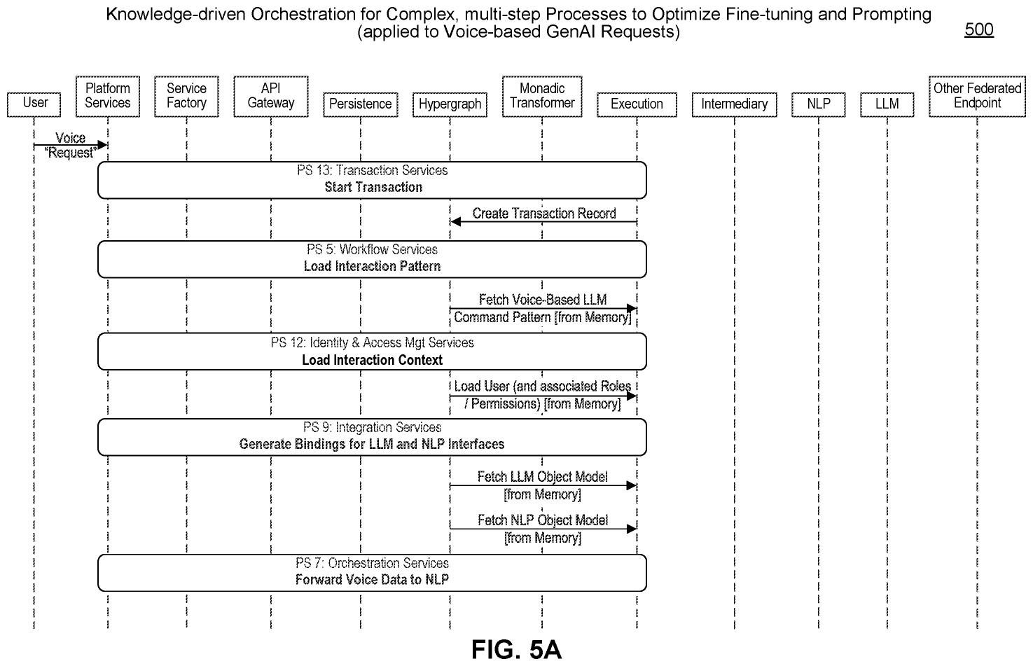

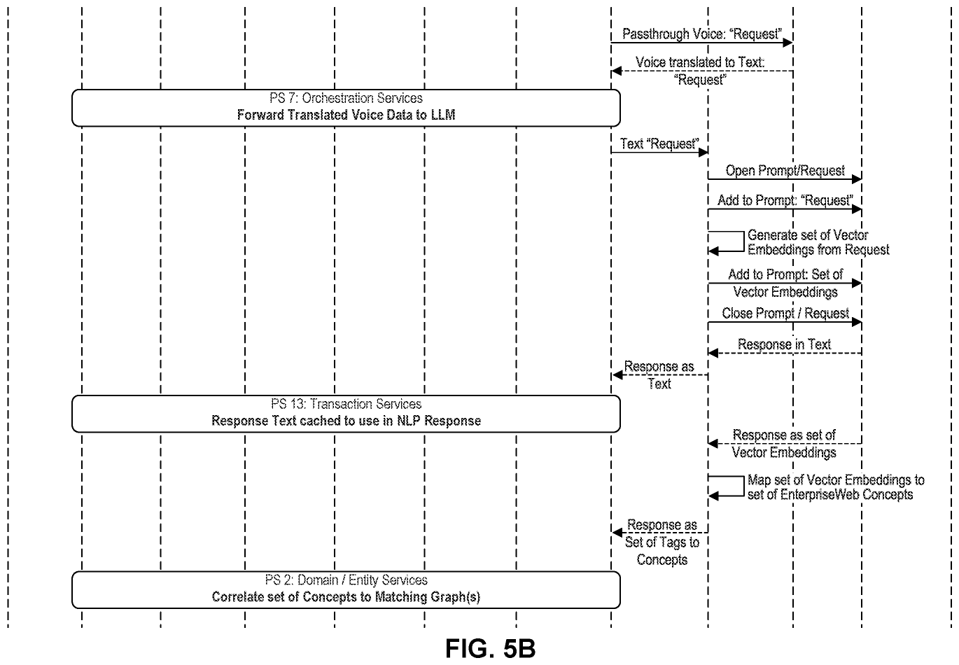

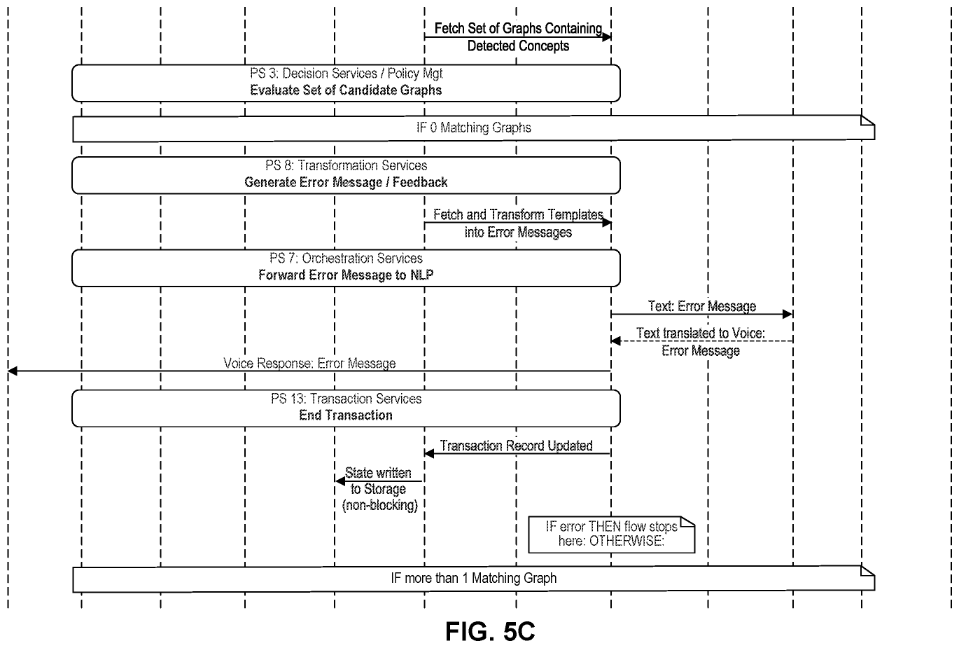

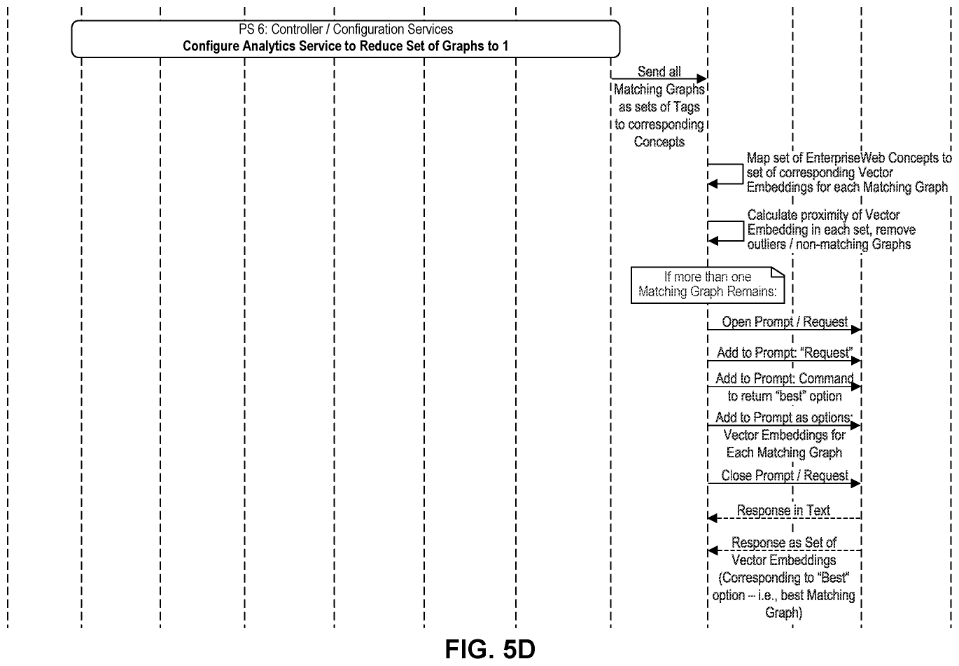

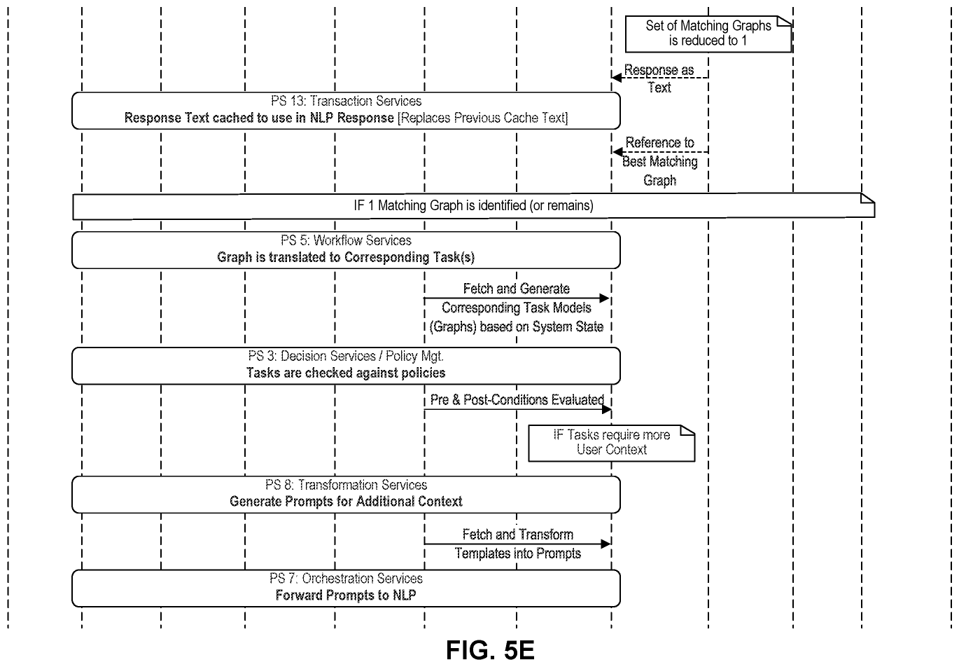

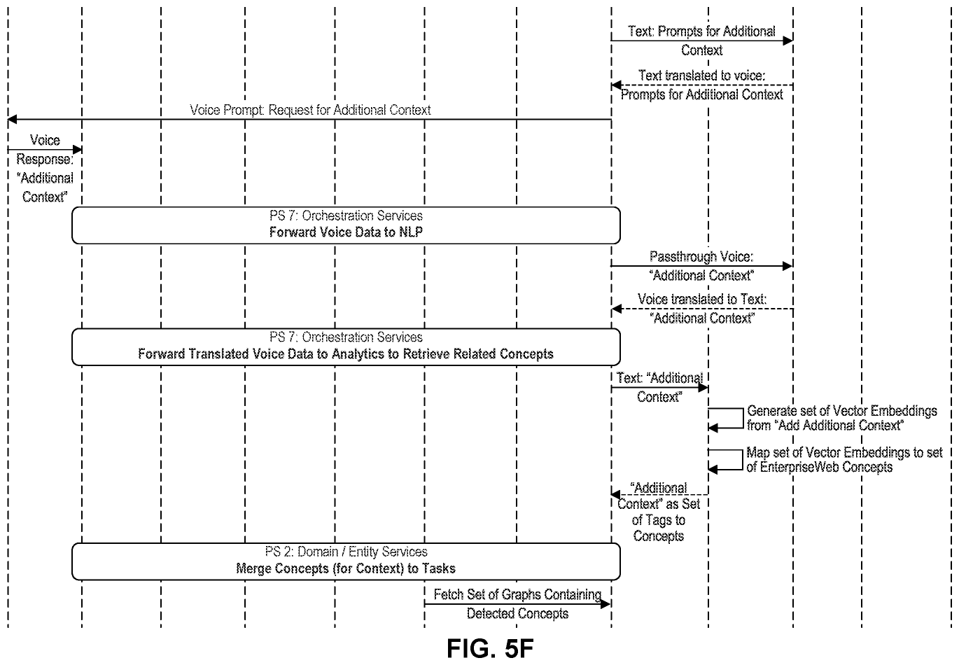

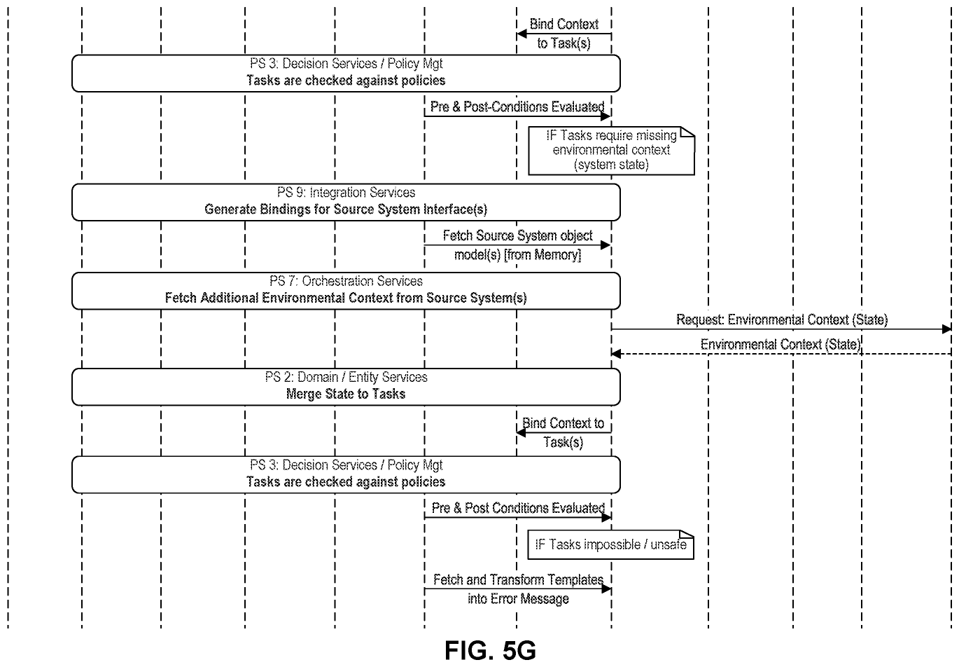

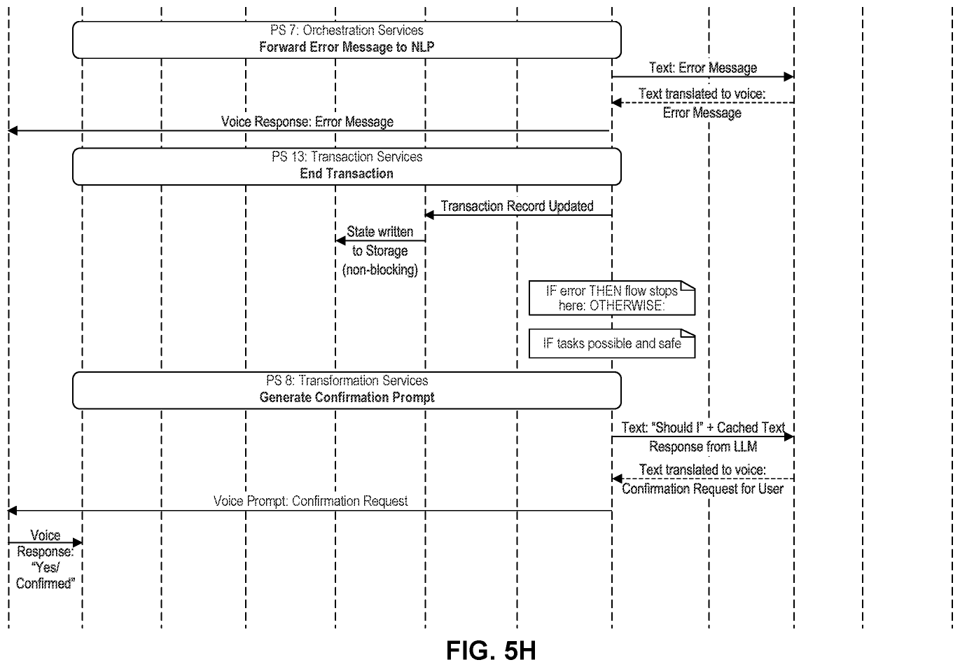

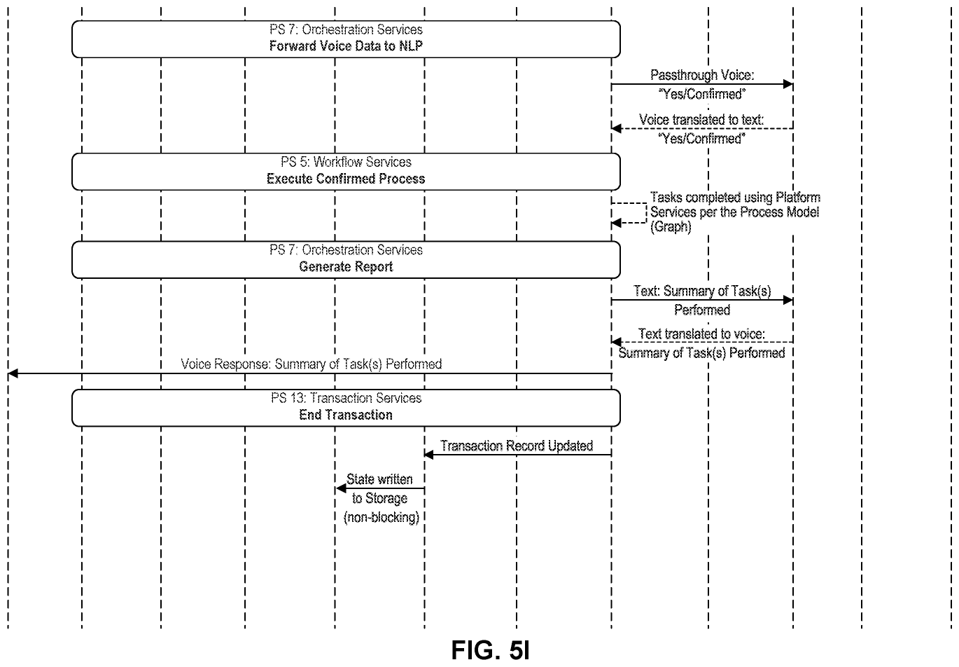

FIGS. 5A-5I illustrate method 500 for performing knowledge-driven orchestration for complex, multi-step processes to optimize fine-tuning and prompting that can be applied to voice-based generative AI requests, according to some embodiments. Method 500 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art(s).

A GenAI pattern that invokes an action (behavior) based on a voice command from a user.

The purpose of this pattern is to extract the intent of the user's request, select an underspecified plan to realize that intent from the Enterprise Web ontology (hypergraph), confirm its correctness with the user, to execute that plan in context to realize the intent, and report the results back to the user.

Overall, this pattern uses an NLP service to convert the user's voice to text. That text is passed to an Intermediary (Vector-native analytics DB) programmed with a set of vectors (tags) corresponding to concepts in the EnterpriseWeb Hypergraph. The user request is passed both in raw form and as a set of corresponding vectors from the Intermediary to an LLM for analysis (as part of a prompt). Vectors returned from the LLM are sent back from the Intermediary to Enterprise Web as a set of Tags corresponding to concepts in the Enterprise Web Hypergraph. The EnterpriseWeb runtime matches the Tags returned to subgraphs (models) found in the Hypergraph that represent plans for potential actions to be carried out in response to the user request. If there are no available actions, the user is informed via voice. If there is more than one potential action, all of their associated concepts (for each action) are passed back to the intermediary. The intermediary attempts to reduce the set to the most applicable/likely action based on its internal methods (such as proximity search based on the corresponding vectors in each plan), and if more than one potential action remains will invoke the LLM to help identify the most likely action. Once the set of actions is reduced to 1, the policies related to the action (Pre- and Post-conditions related to the tasks in the plan used to realize the action) are evaluated. If more details are required from the user to carry out the action, they are queried by voice to provide the additional “user context” which is then passed through the same NLP/Intermediary/LLM process as described above to convert it to a set of tags corresponding to Enterprise Web concepts, which are then appended to the plan (as additional details associated with each Task). If more details are required from the environment to carry out the action, system-to-system interactions are automated by the system to obtain the required ‘system state/context’, which are then appended to the plan (as additional details associated with each Task). At this time, all policies are re-evaluated, and if the action is deemed safe and enough context is present to carry out the plan, the user is informed by voice what the system will do to realize their stated intent, and asked to confirm. Upon confirmation the action is carried out by the system, and any results reported to the user.

The GenAI pattern starts when a User makes a voice request to the system. Processing starts with the system opening up a transaction, so that all tasks can be rolled back/resource can be restored if there is a failure, and so that the entire interaction can be inspected in future. All interactions of the system happen within a transaction. For this, the system renders a Platform Service (PS 13: Transaction Services), then upon opening the transaction creates a record (i.e., root node) in the Hypergraph to track the state of the interaction. Since the interaction pattern itself is encoded as a model (underspecified process) in the Hypergraph, the system renders a Platform Service (PS 5: Workflow Services) to fetch it from memory. To interpret the pattern, the system needs context related to the user invoking the voice interface, so the system renders a Platform Service (PS 12: Identity & Access Mgt Services) to fetch User profile information (an object) and associated Roles/Permissions (objects) from the Hypergraph.

Since the pattern involves interaction with federated AI Models for LLM and NLP, the system renders a Platform Service (PS 9: Integration Services) to fetch the associated object models for each (LLM and NLP) from the Hypergraph and creates bindings for each, so that each interaction it passes through the Intermediary (example: voice data to be converted to text via the NLP) can be syntactically understood by the native EnterpriseWeb interface (tags to high-level EnterpriseWeb system concepts, types and policies). With those bindings in place, Enterprise Web is configured to deterministically translate LLM and NLP outputs inbound from the Intermediary to bootstrap traversal of its ontology (as encoded in the Hypergraph).

With all of the required late-binding of federated components in place, the system begins to carry out the pattern to convert the user intent, expressed via voice, into an actionable command. The system first renders a Platform Service (PS 7: Orchestration Services) to pass the voice request, via a direct passthrough of the Intermediary, to the NLP component for conversion to text. The converted text is then relayed back through the Intermediary to the system. The system then renders a Platform Service (PS 7: Orchestration Services) to pass the request, as text, to the LLM, so that a set of tags can be generated to act as input to the system. In other words, the system will now use the Intermediary to generate a set of tags it can use for traversing its ontology to realize intent. Per the earlier description, the Intermediary is programmed by the system to carry out this conversion process. The Intermediary starts by opening a prompt to the LLM. It then adds the initial voice request as text. It then generates a set of vector embeddings (corresponding to concepts from the system ontology) for use in the LLM based on the text, which it also adds to the prompt. The prompt is then executed, the LLM results returned to the Intermediary. The text returned by the LLM is forwarded, as is, to the system to be used later in constructing voice responses to the user, and is cached as part of the transaction, once received the system renders a Platform Service (PS 13: Transaction Services) to cache this result. At the same time, the vector embeddings returned from the LLM are converted by the Intermediary to tags corresponding to concepts from the system ontology, which are then returned to the system.

With the initial user intent converted to a set of deterministic tags, the system proceeds to traverse the ontology to select a single matching action for later execution. To do this, the system first renders a Platform Service (PS 2: Domain/Entity Services) to correlate the set of tagged concepts returned to a set of all task/process models containing all such sets of tags found in the Hypergraph, producing a set of candidate graphs. The system then renders a Platform Service (PS 3: Decision Services/Policy Mgt) to evaluate the candidate graphs and reduce the number to a result corresponding to the action to be taken.

If there are zero candidate graphs, the system renders a Platform Service (PS 8: Transformation Services) to fetch an error message from the hypergraph, then renders a Platform Service (PS 7: Orchestration Services) to pass the message, via a direct passthrough of the Intermediary, to the NLP component for conversion to voice. The converted voice data is then relayed back through the Intermediary to the system, which is relayed (spoken) to the user. The system then renders a Platform Service (PS13: Transaction Services) to close the associated transaction in the Hypergraph, which is then persisted in the underlying database.

If there is more than one candidate graph, the system uses the Intermediary to help determine the “best” amongst the options. To do this, the system renders a Platform Service (PS 6: Controller/Configuration Services) to send all candidate graphs (as sets of tags to related objects) to the Intermediary which it has programmed to reduce the set as follows. First, the Intermediary translates the tags sets to embeddings. Next it uses proximity search (or other such vector-related techniques) to score all candidate graphs, and cuts all graphs that fall below an established threshold. If more than one candidate graph remains at this point, the Intermediary is programmed to invoke the LLM again to help further reduce the set of graphs. To do this, the Intermediary opens a prompt to the LLM. It then adds the initial voice request as text again. It then adds a directive to evaluate the best option meeting the request to the prompt. It then adds as options each set of translated vectors (each set corresponding to one of the candidate graphs). The prompt is then executed, the LLM results returned to the Intermediary. If this second LLM interaction is performed, then the next text returned by the LLM is forwarded, as is, to the system to be used later in constructing voice responses to the user, once received the system renders a Platform Service (PS 13: Transaction Services) to cache this result, replacing the previous. At this point the set of candidate graphs has been reduced to one by the Intermediary (either via its own methods, or through a second prompt to the LLM as directed by the system), a reference (tag) to the matching graph is returned to the system.

At this point, either the set of candidate graphs within the system is 1 (either through its initial traversal of the ontology, or via a secondary reduction performed through the programmed Intermediary). Since the graph corresponds to a process (one or more tasks) to be carried out by the system, it now needs to be evaluated for safety and completeness. To do this, the system first renders a Platform Service (PS 5: Workflow Services) to generate corresponding task models from the Hypergraph based on the current system state. The system then renders a Platform Service (PS 3: Decision Services/Policy Mgt) to evaluate all the policies (pre- and post-conditions) related to each task.

If tasks require more user context (i.e., are ambiguous or have missing parameters that need to be specified by the user) the system renders a Platform Service (PS 8: Transformation Services) to fetch templates from the hypergraph related to the missing/additional context, then renders a Platform Service (PS 7: Orchestration Services) to pass the message, via a direct passthrough of the Intermediary, to the NLP component for conversion to voice. The converted voice data is then relayed back through the Intermediary to the system, which is relayed (spoken) to the user as a set of “User Prompts”. The user will then speak, supplying the new/additional context as voice data which once again is translated to a set of tags for use by the system. As with the initial request, the system renders a Platform Service (PS 7: Orchestration Services) that is used to forward the voice data through the Intermediary to the NLP which is returned to the system as text, and then renders another Platform Service (PS 7: Orchestration Services) which is used to pass the text to the Intermediary. This time, the Intermediary performs the vector to tag related mapping as it previously would have done when it was going to pass the request through the LLM, but in this case data is specific to the already established execution context (i.e., the identified tasks), so no further translation is required. The tag set is returned to the system, which renders a Platform Service (PS 2: Domain/Entity Services) which binds the additional context to the original task objects. Once again, the tasks need to be rechecked to see if they are complete. To do this, the system renders a Platform Service (PS 3: Decision Services/Policy Mgt) to reevaluate all the policies (pre- and post-conditions) related to each task. If still more user context is required, this process of fetching more context via voice prompts to the user is repeated. If sufficient/complete user context is present, the evaluation then checks to see if any additional environment context (i.e., system state) is required that it does not already have in the Hypergraph.

If additional environmental context (i.e., system state) is required, the system renders a Platform Service (PS 9: Integration Services) to fetch objects from the Hypergraph for “Other Federated Endpoint” where the context/state can be queried, and transform them to any required bindings (e.g.: generate a REST call, synthesize a set of CLI operations, etc.). The system will then render a Platform Service (PS 7: Orchestration Services) which will carry out the required call/operations on the “Other Federated Endpoint”, and renders a Platform Service (PS 2: Domain/Entity Services) which binds the additional returned context/state to the original task objects. Once again, the tasks need to be rechecked to see if they are complete. To do this, the system renders a Platform Service (PS 3: Decision Services/Policy Mgt) to reevaluate all the policies (pre- and post-conditions) related to each task. If still more environmental context/state is required, this process of fetching more environmental context/state is repeated. Once all context (user and environmental) is sufficient/complete user context is present and a final evaluation is performed to check if the resulting tasks would be safe to execute as specified (i.e., that they do not violated any system policies).

If the task(s) are evaluated to be either unsafe, or if the process of gathering context could not be completed, then the system renders a Platform Service (PS 8: Transformation Services) to fetch an appropriate error message from the Hypergraph, then renders a Platform Service (PS 7: Orchestration Services) to pass the message, via a direct passthrough of the Intermediary, to the NLP component for conversion to voice. The converted voice data is then relayed back through the Intermediary to the system, which is relayed (spoken) to the user. The system then renders a Platform Service (PS13: Transaction Services) to close the associated transaction in the Hypergraph, which is then persisted in the underlying database.

If the task(s) are evaluated and determined to be safe, the system will verify the intent of the user before performing any actions. To do this, the system renders a Platform Service (PS 7: Orchestration Services) to pass a confirmation message of what actions are to be taken, via a direct passthrough of the Intermediary, to the NLP component for conversion to voice. The converted voice data is then relayed back through the Intermediary to the system, which is relayed (spoken) to the user. The user will then speak, their voice data which once again is translated to a set of tags for use by the system. As with the previous voice-based inputs, the system renders a Platform Service (PS 7: Orchestration Services) that is used to forward the voice data through the Intermediary to the NLP which is returned to the system. If the user confirms the action is to be taken the system renders a Platform Service (PS 5: Workflow Services) which is used to execute the associated process (i.e., set of tasks). Upon completion the tasks are summarized and the system renders a Platform Service (PS 7: Orchestration Services) to pass the summarized results, via a direct passthrough of the Intermediary, to the NLP component for conversion to voice. The converted voice data is then relayed back through the Intermediary to the system, which is relayed (spoken) to the user. The system then renders a Platform Service (PS13: Transaction Services) to close the associated transaction in the Hypergraph, which is then persisted in the underlying database. Completing the interaction.

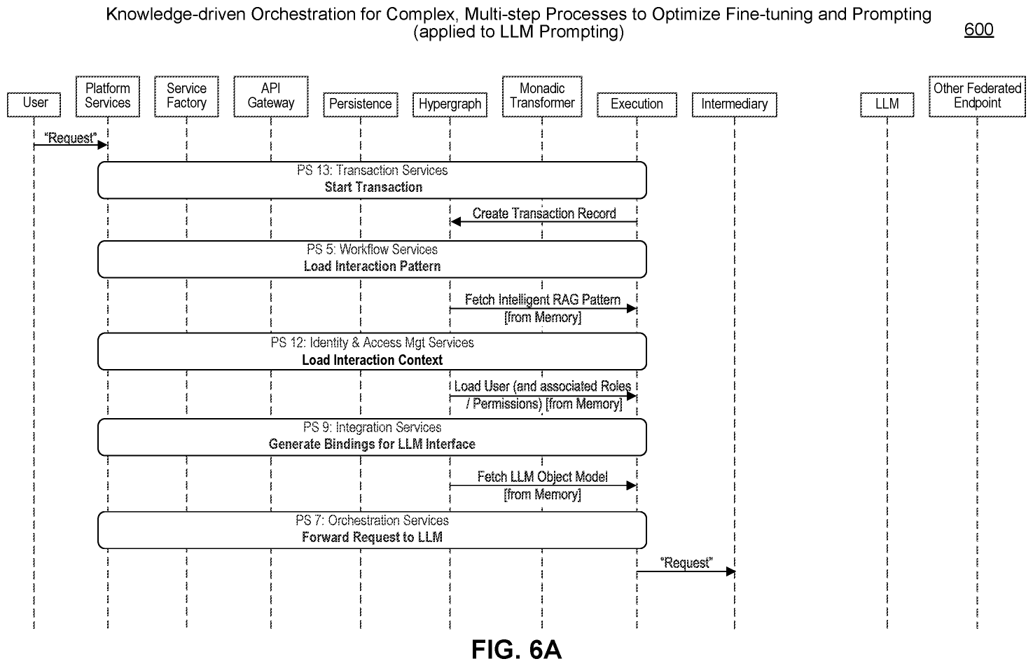

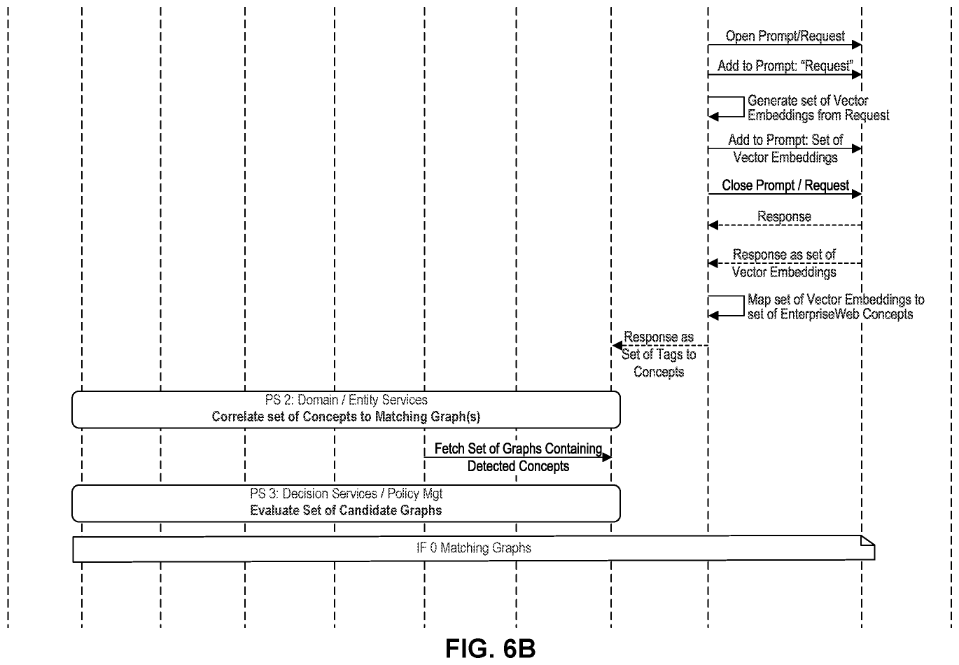

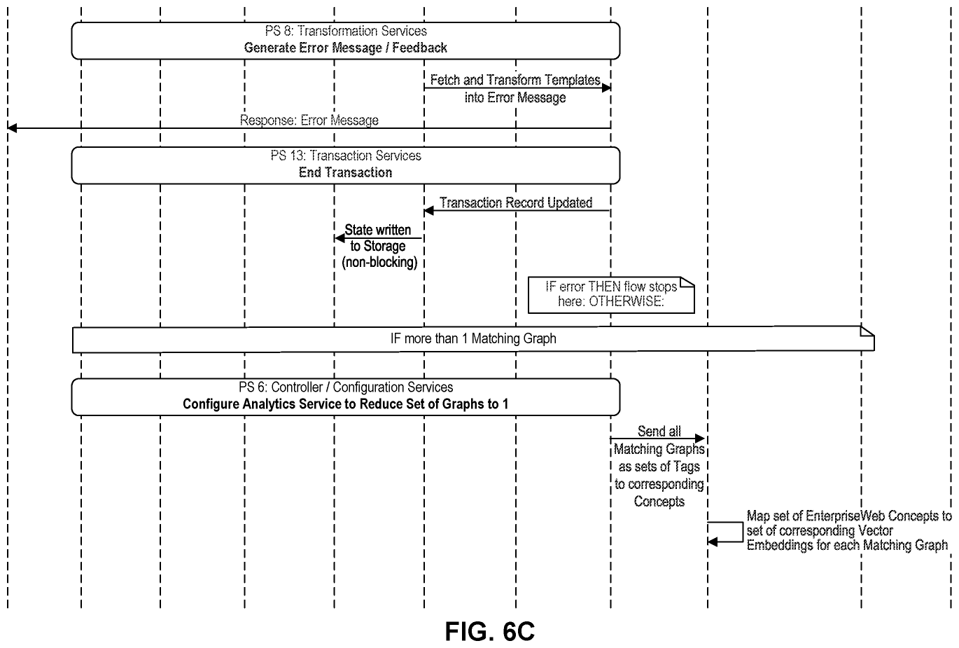

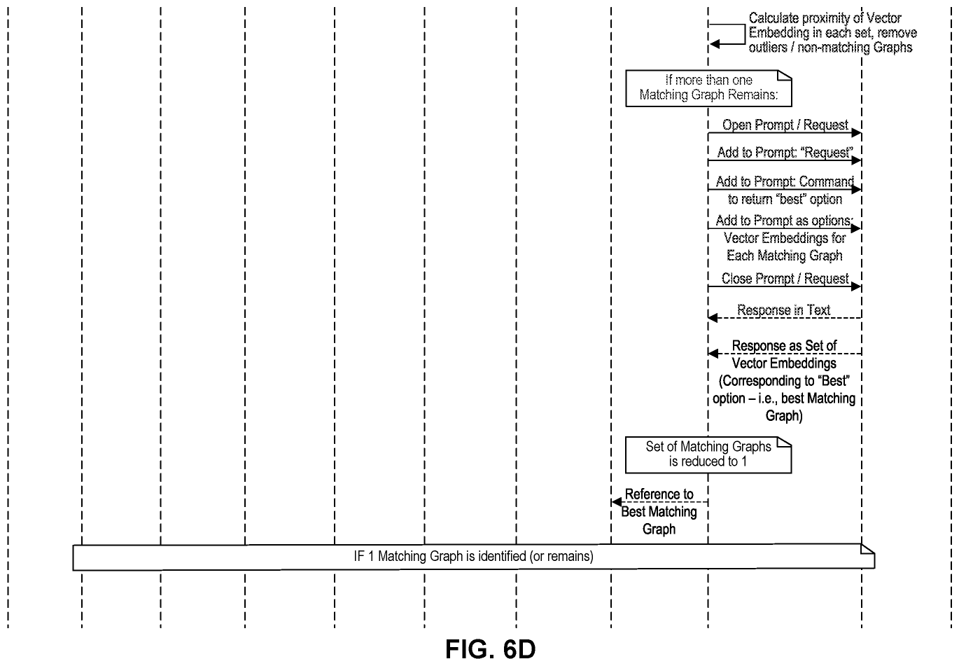

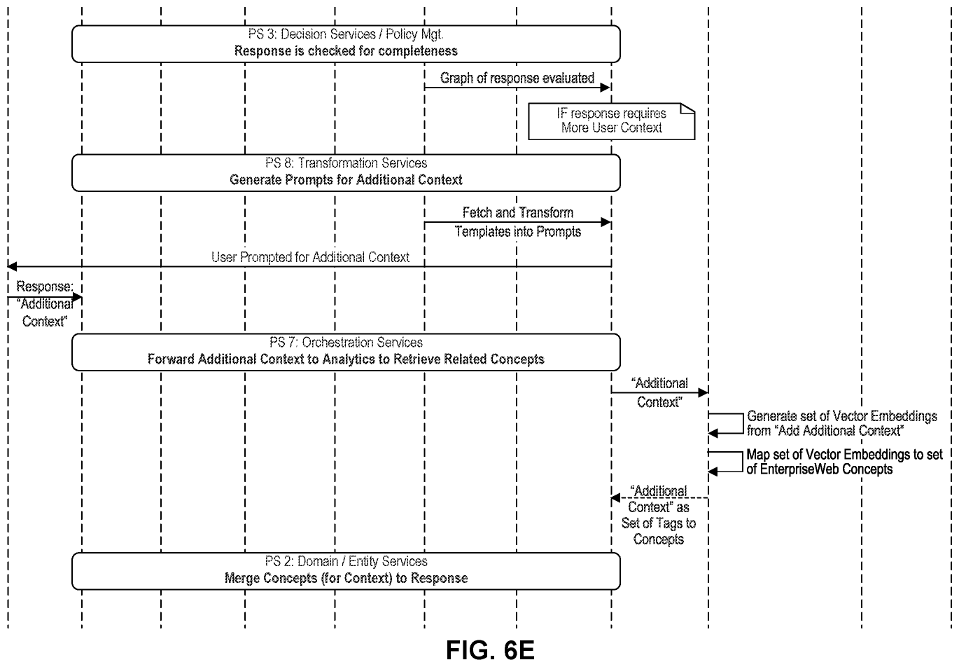

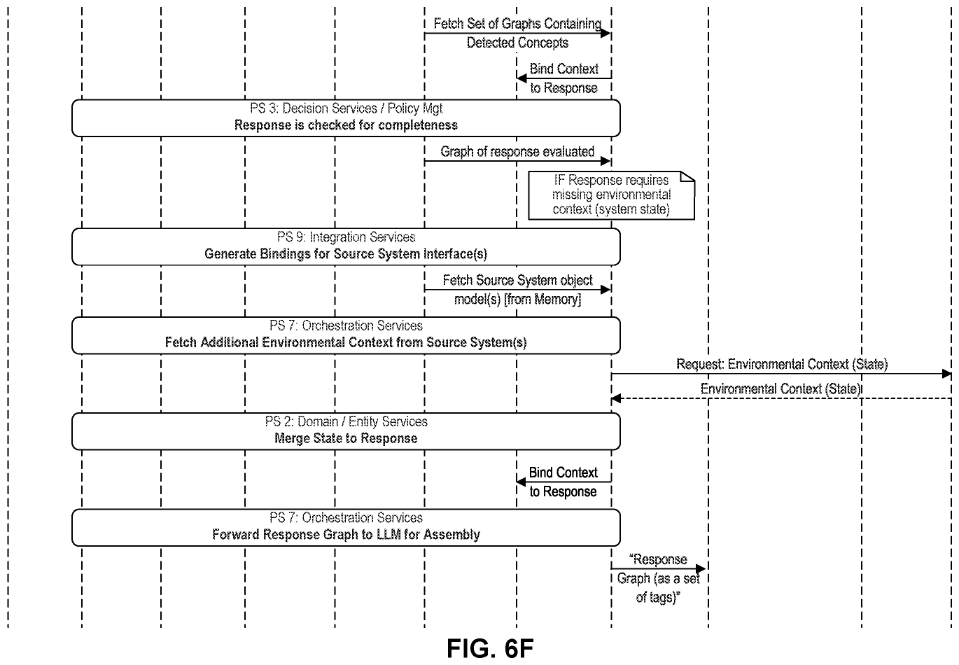

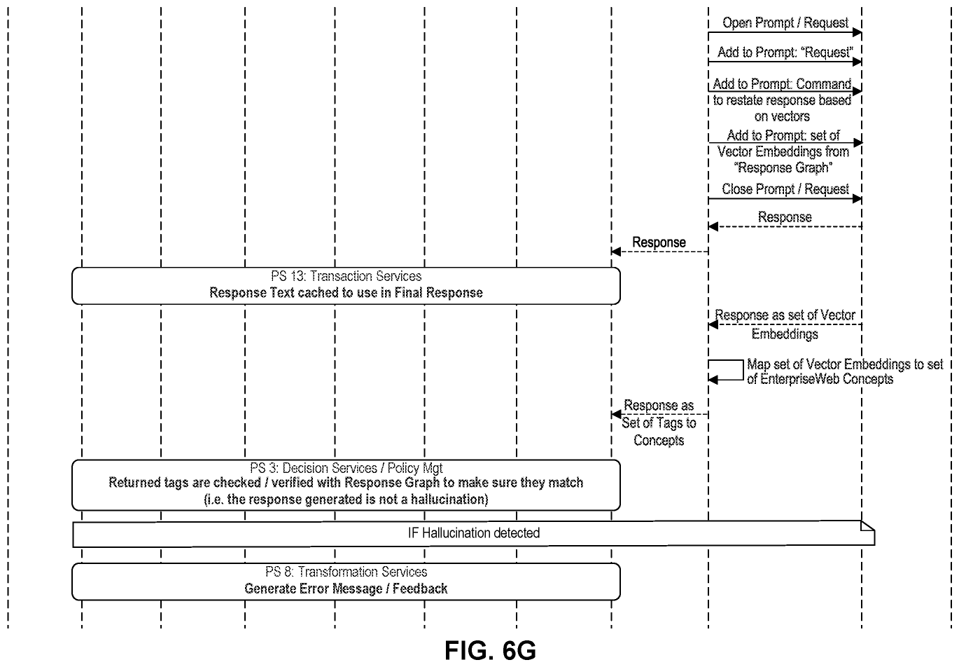

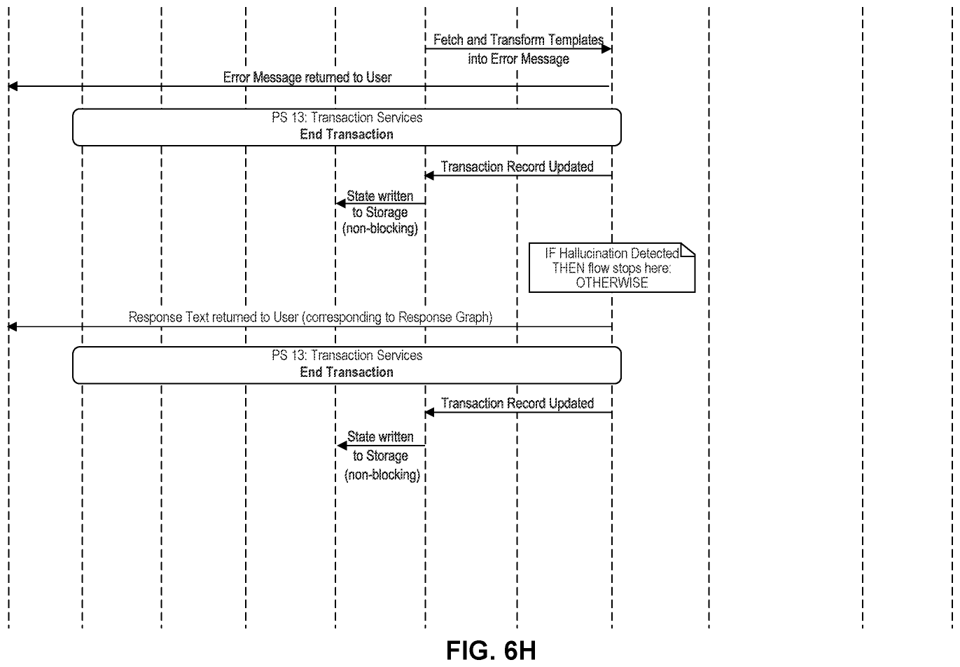

FIGS. 6A-6H illustrate method 600 for performing knowledge-driven orchestration for complex, multi-step processes to optimize fine-tuning and prompting that can be applied to LLM prompting, according to some embodiments. Method 600 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art(s).

A GenAI pattern performs an intelligent query process, taking a request (prompt) from a user, passing it through an LLM, then intelligently processing its outputs to: A) add additional real-time context to the response; B) ensure its accuracy (i.e., remove hallucinations); and C) make it deterministic.

Overall, this pattern passes a user request to an Intermediary (Vector-native analytics DB) programmed with a set of vectors (tags) corresponding to concepts in the EnterpriseWeb Hypergraph. The user request is passed both in raw form and as a set of corresponding vectors from the Intermediary to an LLM for analysis (as part of a prompt). Vectors returned from the LLM are sent back from the Intermediary to Enterprise Web as a set of Tags corresponding to concepts in the Enterprise Web Hypergraph. The Enterprise Web runtime matches the Tags returned to subgraphs (models) found in the Hypergraph that represent graphs of potential responses to the initial user prompt. If there are no available graphs (indicating the response returned from the LLM was a hallucination from the outset), the user is informed. If there is more than one potential graph, all of their associated concepts (for each action) are passed back to the intermediary. The intermediary attempts to reduce the set to the most applicable/likely graph based on its internal methods (such as proximity search based on the corresponding vectors in each plan), and if more than one potential graph remains will invoke the LLM to help identify the most likely graph. Once the set of graphs is reduced to 1, the completeness of the response graph is evaluated. If more details are required from the user to complete the graph, they are queried to provide the additional “user context” which is then passed through the same Intermediary/LLM process as described above to convert it to a set of tags corresponding to Enterprise Web concepts, which are then appended to the response graph. If more details are required from the environment to carry out the action, system-to-system interactions are automated by the system to obtain the required ‘system state/context’, which are then appended to the response graph. At that time, if the response graph is complete, its set of corresponding concepts are flattened as tags and sent through the same Intermediary/LLM process as described above to A) assemble a composite response to pass as text back to the user as an output; and B) collect a new set of output vectors responding to the output so that it can be verified. These final output vectors are converted to Enterprise Web tags, compared against the assembled response graph, and if they match the system is able to verify that one (deterministic) response was assembled which is not a hallucination. The text associated with that response is then returned to the user.

The GenAI pattern starts when a User makes a request (prompt) to the system. Processing starts with the system opening up a transaction, so that all tasks can be rolled back/resource can be restored if there is a failure, and so that the entire interaction can be inspected in future. All interactions of the system happen within a transaction. For this, the system renders a Platform Service (PS 13: Transaction Services), then upon opening the transaction creates a record (i.e., root node) in the Hypergraph to track the state of the interaction. Since the interaction pattern itself is encoded as a model (underspecified process) in the Hypergraph, the system renders a Platform Service (PS 5: Workflow Services) to fetch it from memory. To interpret the pattern, the system needs context related to the user invoking the voice interface, so the system renders a Platform Service (PS 12: Identity & Access Mgt Services) to fetch User profile information (an object) and associated Roles/Permissions (objects) from the Hypergraph.

Since the pattern involves interaction with a federated AI Model for the LLM, the system renders a Platform Service (PS 9: Integration Services) to fetch the associated object model for each the LLM from the Hypergraph and creates bindings, so that each interaction it passes through the Intermediary can be syntactically understood by the native Enterprise Web interface (tags to high-level Enterprise Web system concepts, types and policies). With those bindings in place, Enterprise Web is configured to deterministically translate LLM responses inbound from the Intermediary to bootstrap traversal of its ontology (as encoded in the Hypergraph).

With the required late-binding of federated components in place, the system begins to carry out the pattern to convert the user prompt into a trusted and contextually enriched output. The system first renders a Platform Service (PS 7: Orchestration Services) to pass the request to the LLM, so that a set of tags can be generated to act as input to the system. In other words, the system will now use the Intermediary to generate a set of tags it can use for traversing its ontology to identify a graph corresponding to the response which is grounded in the domain model of the system. Per the earlier description, the Intermediary is programmed by the system to carry out this conversion process. The Intermediary starts by opening a prompt to the LLM. It then adds the initial request as text. It then generates a set of vector embeddings (corresponding to concepts from the system ontology) for use in the LLM based on the text, which it also adds to the prompt. The prompt is then executed, the LLM results returned to the Intermediary. The vector embeddings returned from the LLM are converted by the Intermediary to tags corresponding to concepts from the system ontology, which are then returned to the system.

With the initial user prompt converted to a set of deterministic tags, the system proceeds to traverse the ontology to select a single matching response graph. To do this, the system first renders a Platform Service (PS 2: Domain/Entity Services) to correlate the set of tagged concepts returned to a set of all matching graphs containing all such sets of tags found in the Hypergraph, producing a set of candidate graphs. The system then renders a Platform Service (PS 3: Decision Services/Policy Mgt) to evaluate the candidate graphs and reduce the number to a result corresponding to the response to be returned.

If there are zero candidate graphs, the system renders a Platform Service (PS 8: Transformation Services) to fetch an error message from the hypergraph, which is returned to the user. The system then renders a Platform Service (PS13: Transaction Services) to close the associated transaction in the Hypergraph, which is then persisted in the underlying database.

If there is more than one candidate graph, the system uses the Intermediary to help determine the “best” amongst the options. To do this, the system renders a Platform Service (PS 6: Controller/Configuration Services) to send all candidate graphs (as sets of tags to related objects) to the Intermediary which it has programmed to reduce the set as follows. First, the Intermediary translates the tags sets to embeddings. Next it uses proximity search (or other such vector-related techniques) to score all candidate graphs, and cuts all graphs that fall below an established threshold. If more than one candidate graph remains at this point, the Intermediary is programmed to invoke the LLM again to help further reduce the set of graphs. To do this, the Intermediary opens a prompt to the LLM. It then adds the initial request as text again. It then adds a directive to evaluate the best option meeting the request to the prompt. It then adds as options each set of translated vectors (each set corresponding to one of the candidate graphs). The prompt is then executed, the LLM results returned to the Intermediary. At this point the set of candidate graphs has been reduced to one by the Intermediary (either via its own methods, or through a second prompt to the LLM as directed by the system), a reference (tag) to the matching graph is returned to the system.

At this point, either the set of candidate graphs within the system is 1 (either through its initial traversal of the ontology, or via a secondary reduction performed through the programmed Intermediary). Since the graph corresponds to a response to be returned by system, it now needs to be evaluated for completeness, to do this the system renders a Platform Service (PS 3: Decision Services/Policy Mgt)

If the response requires more user context (i.e., is ambiguous or has missing parameters that need to be specified by the user) the system renders a Platform Service (PS 8: Transformation Services) to fetch templates from the hypergraph related to the missing/additional context, which are then returned to the user as a set of “User Prompts”. The user will then supply the new/additional context which once again is translated to a set of tags for use by the system. As with the initial request, the system renders a Platform Service (PS 7: Orchestration Services) which is used to pass the new text to the Intermediary. This time, the Intermediary performs the vector to tag related mapping as it previously would have done when it was going to pass the request through the LLM, but in this case data is specific to the already established execution context (i.e., the identified response graph), so no further translation is required. The tag set is returned to the system, which renders a Platform Service (PS 2: Domain/Entity Services) which binds the additional context to the original response graph. Once again, the response graph needs to be checked to see if it is complete. To do this, the system renders a Platform Service (PS 3: Decision Services/Policy Mgt) to reevaluate the updated response graph. If still more user context is required, this process of fetching more context via interaction with the user is repeated. If sufficient/complete user context is present, the evaluation then checks to see if any additional environment context (i.e., system state) is required that it does not already have in the Hypergraph.

If additional environmental context (i.e., system state) is required, the system renders a Platform Service (PS 9: Integration Services) to fetch objects from the Hypergraph for “Other Federated Endpoint” where the context/state can be queried, and transform them to any required bindings (e.g.: generate a REST call, synthesize a set of CLI operations, etc.). The system will then render a Platform Service (PS 7: Orchestration Services) which will carry out the required call/operations on the “Other Federated Endpoint”, and renders a Platform Service (PS 2: Domain/Entity Services) which binds the additional returned context/state to the response graph. Once again, the response needs to be rechecked to see if it is complete. To do this, the system renders a Platform Service (PS 3: Decision Services/Policy Mgt) to reevaluate response graph. If still more environmental context/state is required, this process of fetching more environmental context/state is repeated.

Once all context (user and environmental) is sufficient/complete user context is present then the response graph is used to generate a final “output” from the LLM containing sum of all context collected, and concepts referenced in the response graph. To do this, the system renders a Platform Service (PS 7: Orchestration Services) to pass the response graph to the Intermediary, which opens a prompt to the LLM. It adds to the prompt the initial query, the response vectors and a command to assemble a new output containing all provided information. The output is then forwarded to the system which renders a Platform Service (PS 8: Transaction Services) to cache the generated output so that it can later be returned to the user once verified. To verify the output (i.e., ensure it is not a hallucination) the response vectors from the LLM are translated by the intermediary to a set of Tags per the processes above which are returned to the system. The system renders a Platform Service (PS 3: Decision Services/Policy Mgt) which checks that the vectors returned by the newly generated output match those in the originally determined response graph. If they do not match, a hallucination has occurred which cannot be filtered out by the domain model, and so the system renders a Platform Service (PS 3: Transformation Services) to fetch an error message from the hypergraph, which is returned to the user. If they match, the system returns the output to the user that verified, contextualized, and complete. After the final response is provided to the user, the system renders a Platform Service (PS13: Transaction Services) to close the associated transaction in the Hypergraph, which is then persisted in the underlying database. Completing the interaction.

### Use Case 1: Optimized Secure Multi-Access Edge

Use-case 1 (UC1) Optimized Secure Multi-Access Edge, is the deployment and assurance of an optimized 5G/RAN (Radio Access Network) with a secure Edge Gateway. Users on mobile devices use a “VPN” client to connect to a 5G edge node which provides optimized, private, secure traffic (SASE-Secure Access Service Edge). The end-to-end network is deployed and optimized as part of the use-case, and assured both in terms of performance (SLAs) and security.

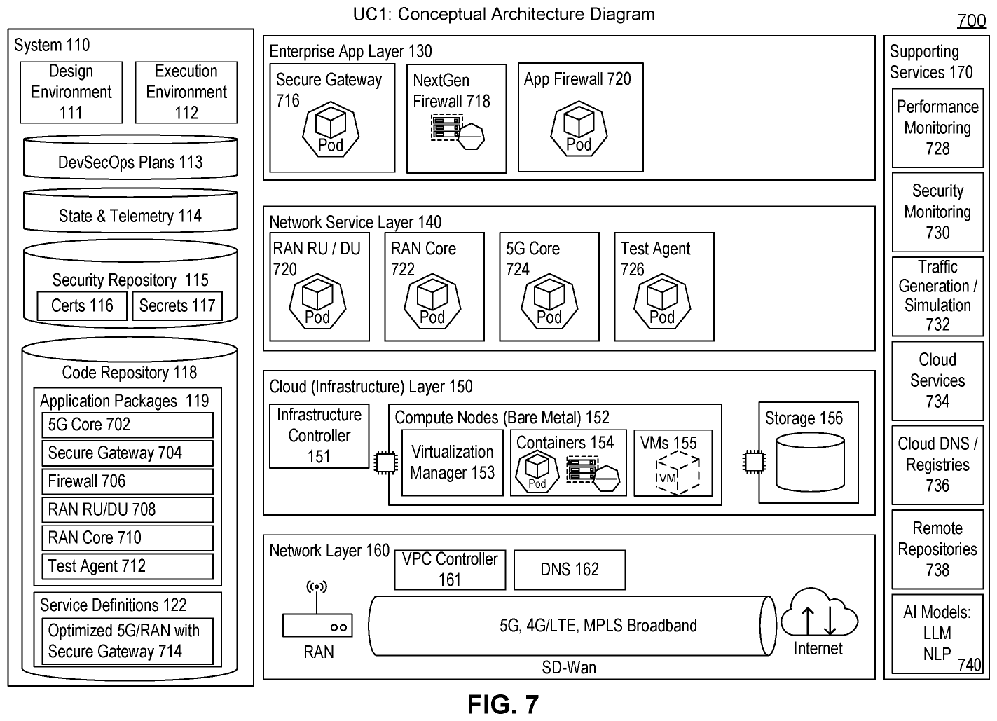

FIG. 7 is a block diagram of a conceptual architecture 700 for deploying and assuring an optimized 5G/RAN (Radio Access Network) with a secure Edge Gateway, according to some embodiments. Architecture 700 may include system 110, design environment 111, execution environment 112, DevOps plans 113, state and telemetry 114, security repository 115, certificates 116, secrets 117, code repository 118, application packages 119, 5G core 702, secure gateway 704, firewall 706, RAN RU/DU 708, RAN Core 710, test agent 712, service definitions 122, optimized 5G/RAN with secure gateway 714, enterprise application layer 130, secure gateway 716, NextGen firewall 718, App firewall 720, network service layer 140, RAN RU/DU 720, RAN core 722, 5G core 724, test agent 726, cloud layer 150, infrastructure controllers 151, compute nodes 152, virtualization manager 153, containers 154, virtual machines 155, storage 156, network layer 160, virtual private cloud (“VPC”) controller 161, domain name system (“DNS”) 162, supporting services 170, performance monitoring 728, security monitoring 730, traffic generation 732, cloud services 734, cloud DNS 736, remote repositories 738, AI models 740.

The core service for the use-case is “Optimized Secure Multi-Access Edge”, the Service Definition and associated Application Packages are found in the Code Repo within the System.

At the Network Layer an SD-WAN is implemented via a VPC Controller with a linked DNS.

At the Cloud (Infrastructure) Layer an Infrastructure Controller provides an interface to multiple Compute Nodes (Bare Metal servers) for each site involved in the use-case (Edge and Core) and to attached Storage. Compute Nodes have a Virtualization Manager present to support the execution of Container-based applications (containers/pods) and VM-based applications. Also, the Compute Nodes provide a programming interface for their hardware (NIC-Network Interface Controllers) so that they can be optimized for the applications running on them.

At the Network Service Layer the core-network service consists of a “RAN RU/DU” (Radio Access Network Radio Unit/Distributed Unit), a “RAN Core” (Radio Access Network Core), and a “5G Core” which together provide the end-to-end 5G connectivity for connected devices. A “Virtual Probe” is also deployed for monitoring. All components are running over containers on the Compute Nodes, and Application Packages for each are found in the Code Repository.

At the Enterprise App Layer a “Secure Gateway” is deployed as a container, an “App Firewall” is deployed as a container, and a NextGen (NG) Firewall is deployed as a VM over containers, in the Core. An “App Firewall” is also deployed on the Edge Compute node. Application Packages for each are found in the Code Repository.

Supporting Services for this use-case include centralized components for AI (NLP and LLM), Performance and Security Monitoring, a Traffic Generator, Cloud Services for service account creation, a Cloud DNS/Registry and Remote Repositories (for images).

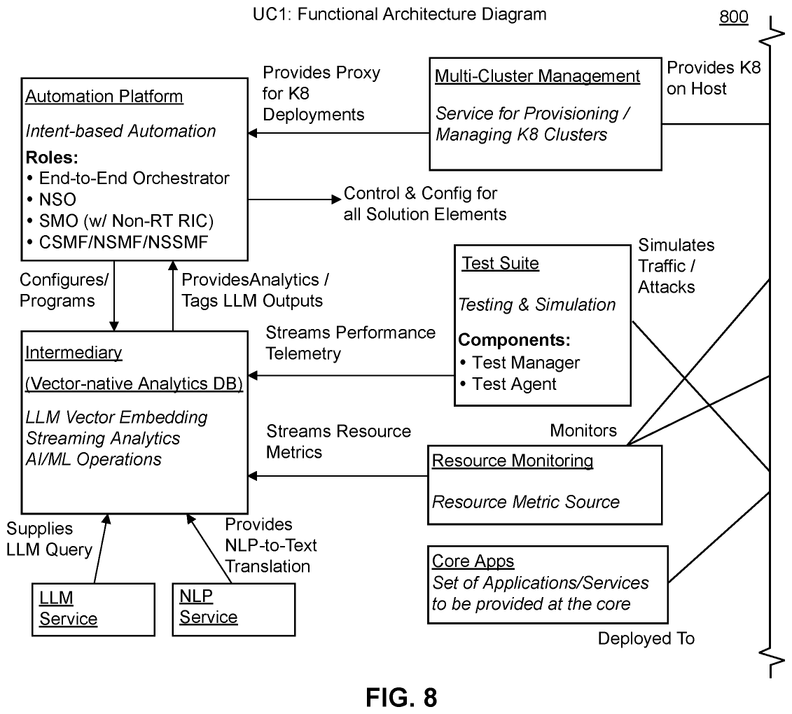

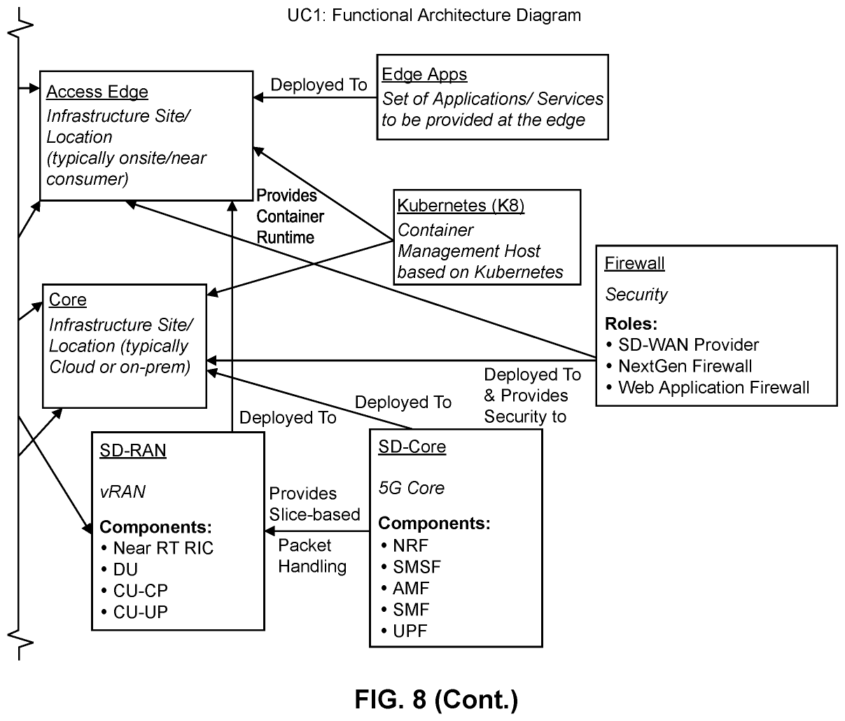

FIG. 8 is a block diagram of a functional architecture 800 for deploying and assuring an optimized 5G/RAN (Radio Access Network) with a secure Edge Gateway, according to some embodiments.

This diagram provides a high-level depiction of the main components found in the use-case solution, decomposed into main function description the main roles they play, components used to realize them, and the relationships between each.

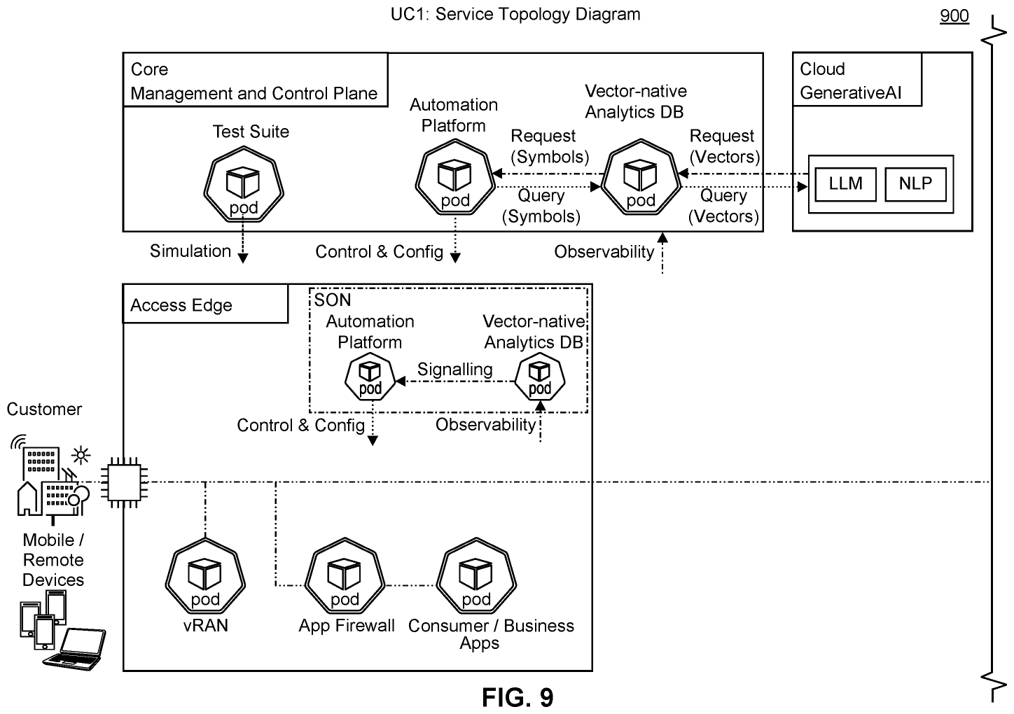

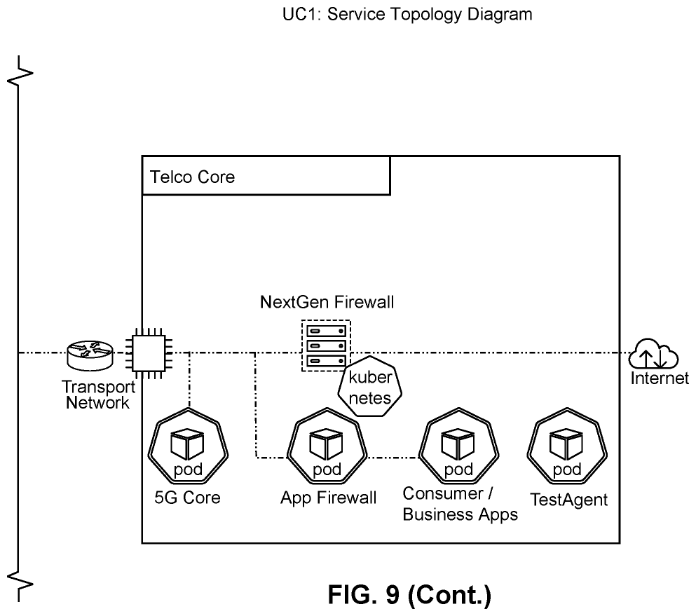

FIG. 9 is a block diagram of a service topology 900 for deploying and assuring an optimized 5G/RAN (Radio Access Network) with a secure Edge Gateway, according to some embodiments.

The use-case is implemented across two nodes (Edge and Core), connected via a VPC (SD-WAN) network and connected switches. The Edge Node is also connected to a RAN (Radio Access Network), and the Core Node is also connected to the Internet. The VPC is implemented by a standard set of overlay and underlay protocols.

The Edge Node has containers/pods for the 5G Core and Edge RAN Components, a VM over containers for the vFW (virtual Firewall) to deliver shared base functionality across all 5G slices; containers/pods per 5G slice for the Secure Gateway itself; containers/pods for probes that act as Resource and Security Monitors; and containers/pods for the Enterprise Web System deployed as an App Controller to execute the use-case. Optionally, other Business Apps could be deployed at the edge.

The Core Node has containers/pods for the Core RAN Components; and

containers/pods for probes that act as Resource and Security Monitors. Optionally, other Business Apps could be deployed at the core.

A Traffic Generator is connected independently via the VPC for testing purposes.

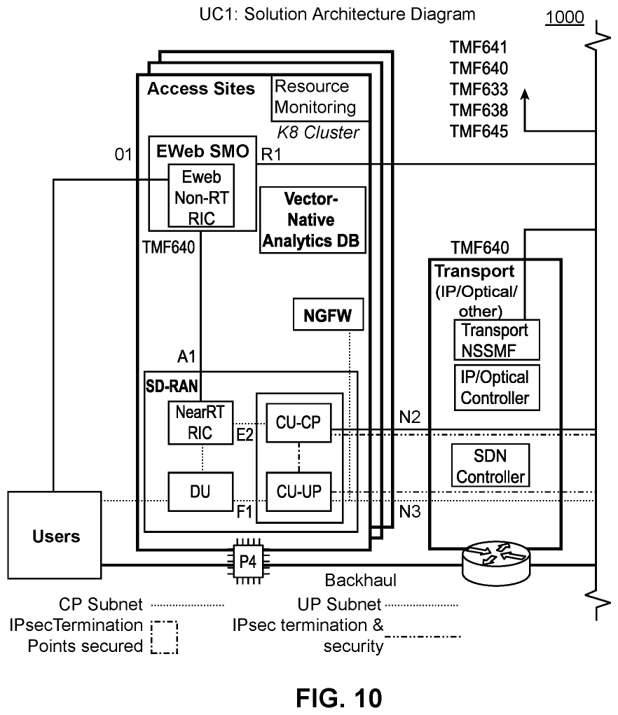

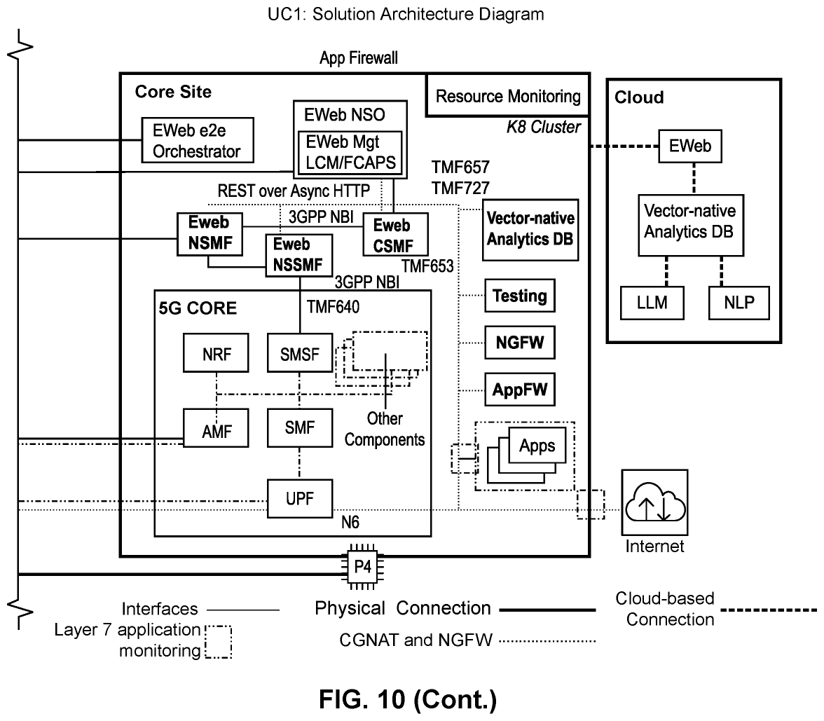

FIG. 10 is a block diagram of a solution architecture 1000 for deploying and assuring an optimized 5G/RAN (Radio Access Network) with a secure Edge Gateway, according to some embodiments.

This diagram provides a detailed view of the Service Topology (FIG. 9), showing concrete components, their sub-components, connections and the standards based interfaces they expose and consume.

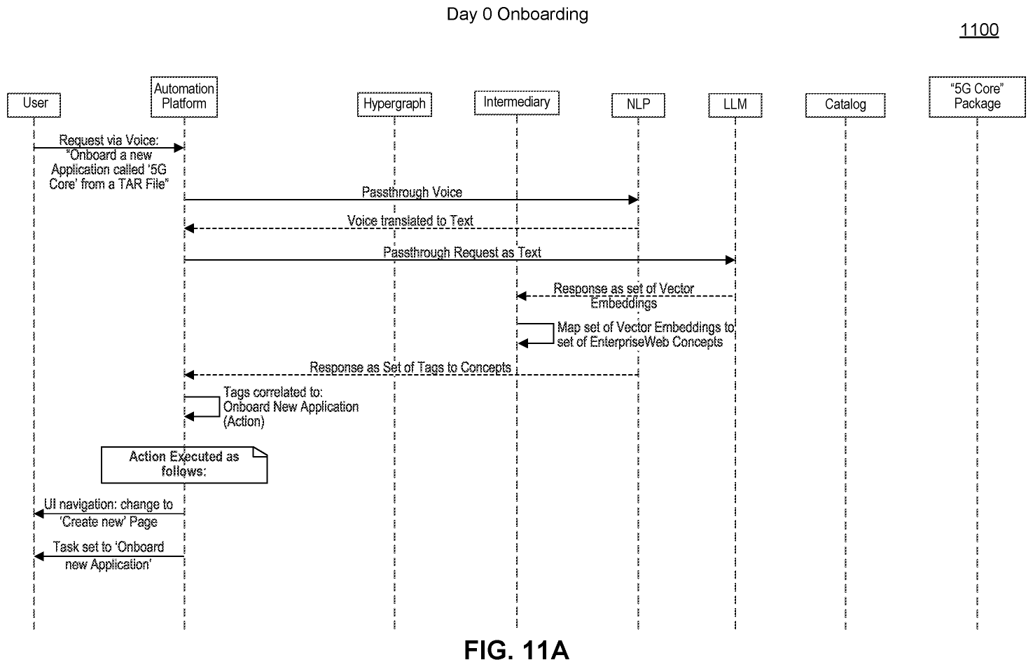

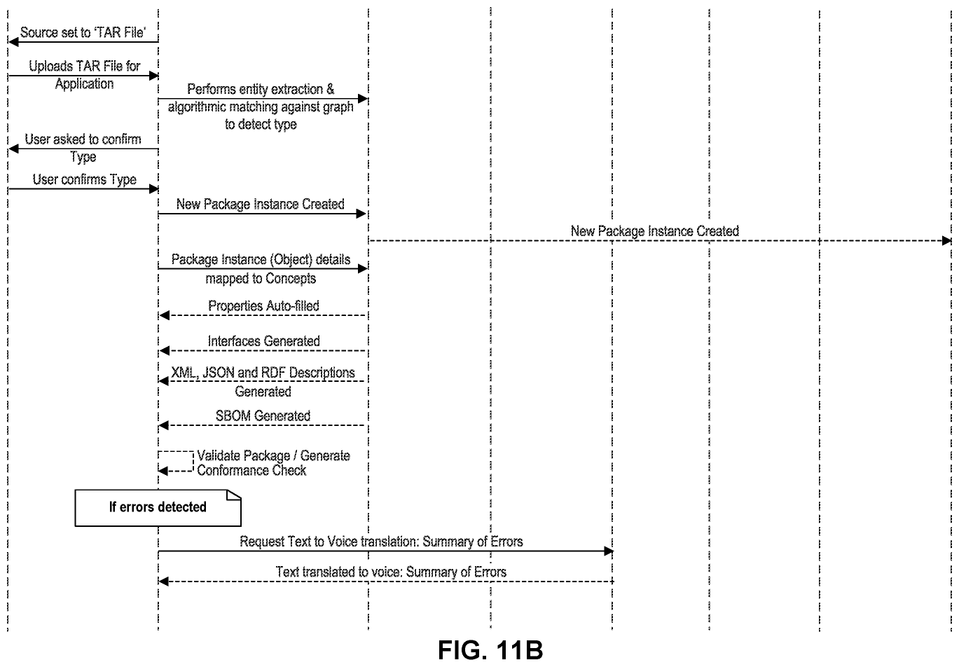

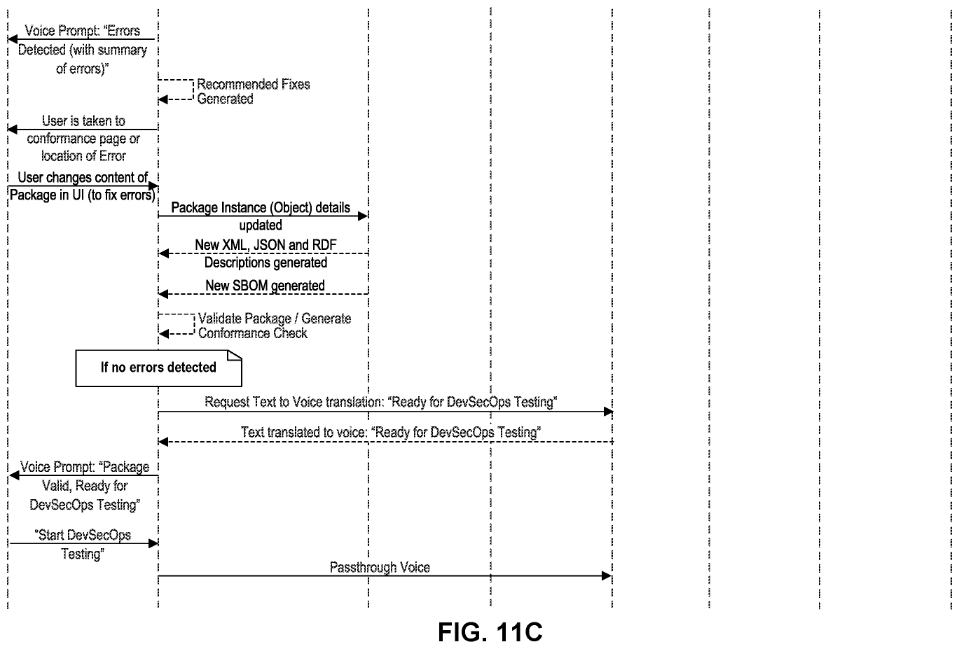

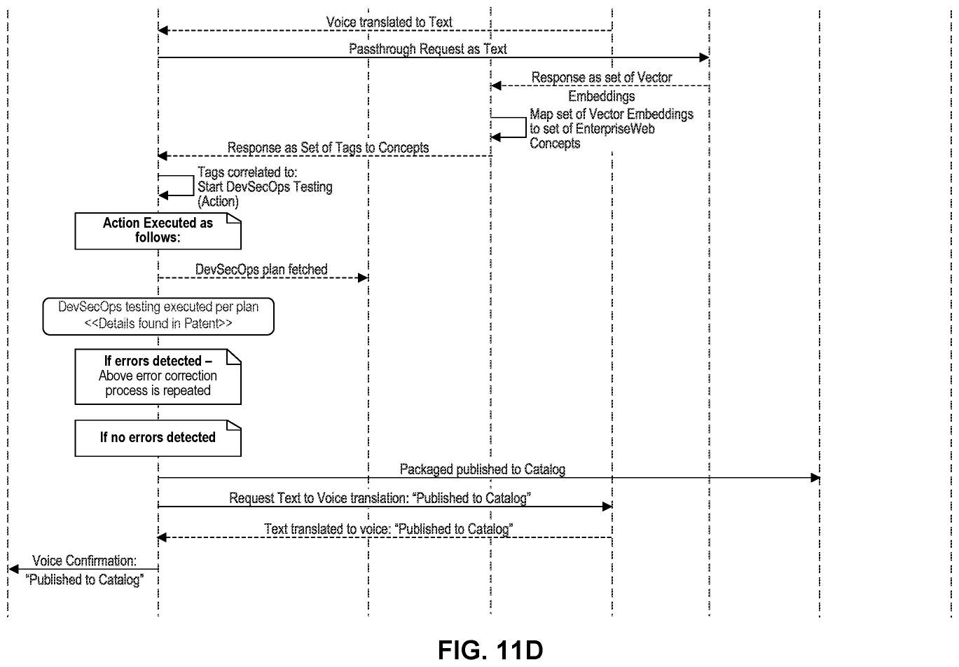

FIGS. 11A-11D illustrate method 1100 for performing Day 0 onboarding for an optimized 5G/RAN (Radio Access Network) with a secure Edge Gateway, according to some embodiments. Method 1100 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 11, as will be understood by a person of ordinary skill in the art(s).

Day 0 Onboarding involves an Application Developer/Engineer (or Service Designer) modeling Application Packages for each solution element to be deployed, integrated and configured in the implementation of the overall Network Service model. Note: this is not development of the application(s), this the creation of models for utilizing developed code compiled into a container/VM image, binary, scripts or some other set of artifacts which carry out the execution, which were developed outside the context of the system.

Onboarding starts with a voice command from the user, “Onboard a new Application called ‘5G Core’ from a TAR File”. The system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to EnterpriseWeb, which traverses its ontology to identify a corresponding graph, selecting an “Onboard New Application” action template from the Hypergraph. Per the canonical method, if additional context is required the system or some other interaction is required it would be handled at this point before the action is executed. Since the action is atomic and direct, it is executed immediately by the platform: UI navigation takes the User to the “Create new” page in their browser, the Task to be performed is set to “Onboard new Application”, and the type of source to import is set to “TAR File”. This is an example of the system performing RPA (Robotic Process Automation) in response to a user-command.

The user will then upload a TAR file containing application related artifacts (such as CNFD (Container Network Function Descriptors), YAML config files, etc.). The system performs entity extraction and algorithm matching against its Hypergraph to determine a type. The user is presented with a dialog to confirm the type. After confirming the type the system creates a new Package Instance in the Hypergraph for the “5G Core”, maps instance (object) details to the Concepts in the Ontology, and then uses the mapping to auto-fill properties, generated standards based interfaces, generate XML, JSON and RDF descriptors and an SBOM file (collectively, a set of supporting artifacts that may be directly useful to a developer).

From here the system proceeds to guide the user through a conformance/error correction process. First, the system validates the package. If errors are detected, the system generates a set of error message, which it then passes through the Intermediary to the NLP, where the message is converted to voice which is then relayed (spoken) to the user. At the same time, the system generates a set of recommended fixes, and uses an RPA process to direct the user to the conformance page or location of the errors they need to correct.

As the user makes changes to the Application Package model in the UI, package contents are updated in the hypergraph, supporting artifacts (XML, JSON and RDF descriptors and an SBOM file) are regenerated, and the package is once again conformance checked. If errors remain, or new errors are introduced, the same guided conformance/error correction loop is repeated until the Application Package model is complete and valid.

Once valid, the system sends a message, “Ready for DevSecOps Testing” through the Intermediary to the NLP, where the message is converted to voice which is then relayed (spoken) to the user.

The user can then say “Start DevSecOpsTesting” (or initiate via the UI). Which system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by EnterpriseWeb, to convert the request to vector embeddings, prompt the LLM for an interpretation, and then convert the LLM output to a set of tags (corresponding to EnterpriseWeb concepts) which can then act as mediated/deterministic inputs to the platform. The Intermediary returns these tags to Enterprise Web, which traverses its ontology to identify a corresponding graph, selecting the “Start DevSecOps Testing” action template from the Hypergraph. Per the canonical method, if additional context is required the system or some other interaction is required it would be handled at this point before the action is executed. Since the action is atomic and direct, it is executed immediately by the platform. First, the platform fetches the associated DevSecOps pipeline process model from the Hypergraph. It then performs the process. If errors are detected, the earlier guided conformance/error correction loop is repeated, and the Application Package is retested until no errors remain.

Once the Application Package passes DevSecOps testing, the system sends a message, “Published to Catalog” through the Intermediary to the NLP, where the message is converted to voice which is then relayed (spoken) to the user. The Application Package state is updated in the Hypergraph and added to the System Catalog.

The above process is repeated for all solution elements required by the service, and once all the solution elements are present in the catalog, and the network service can be composed.

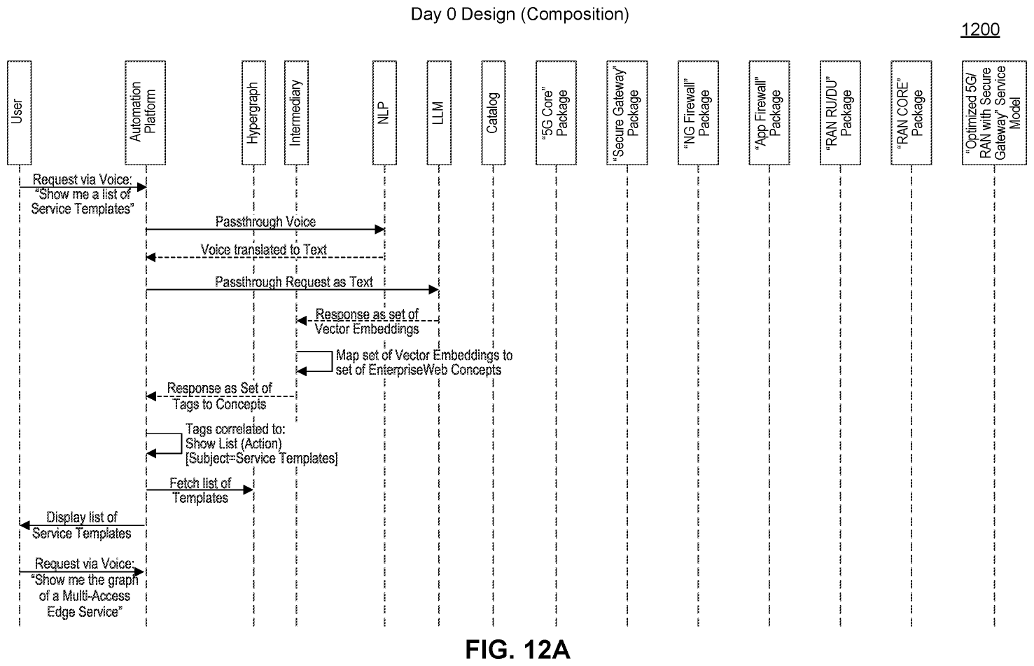

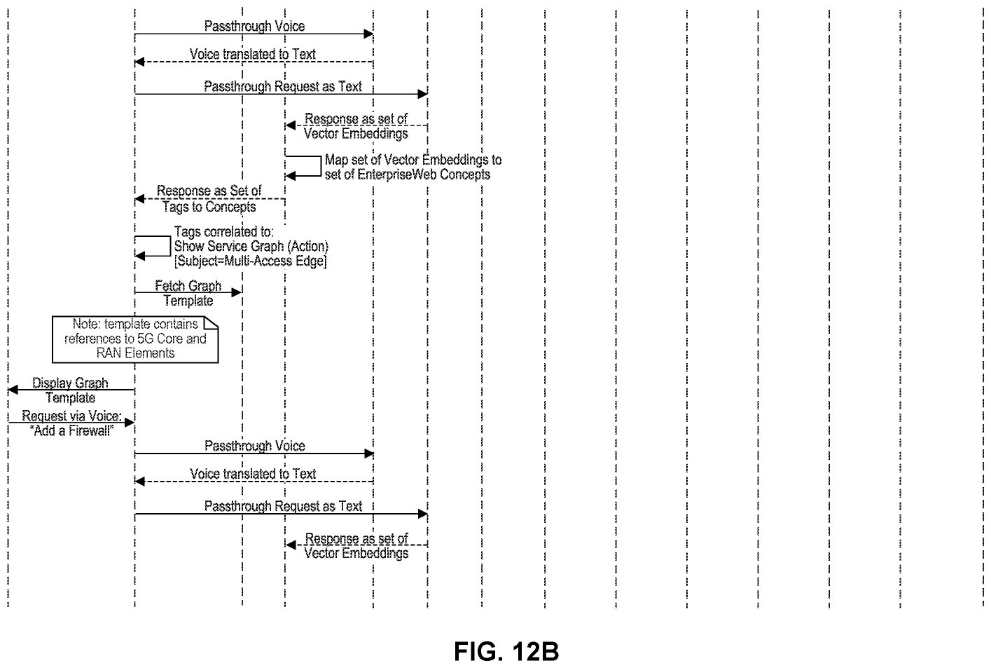

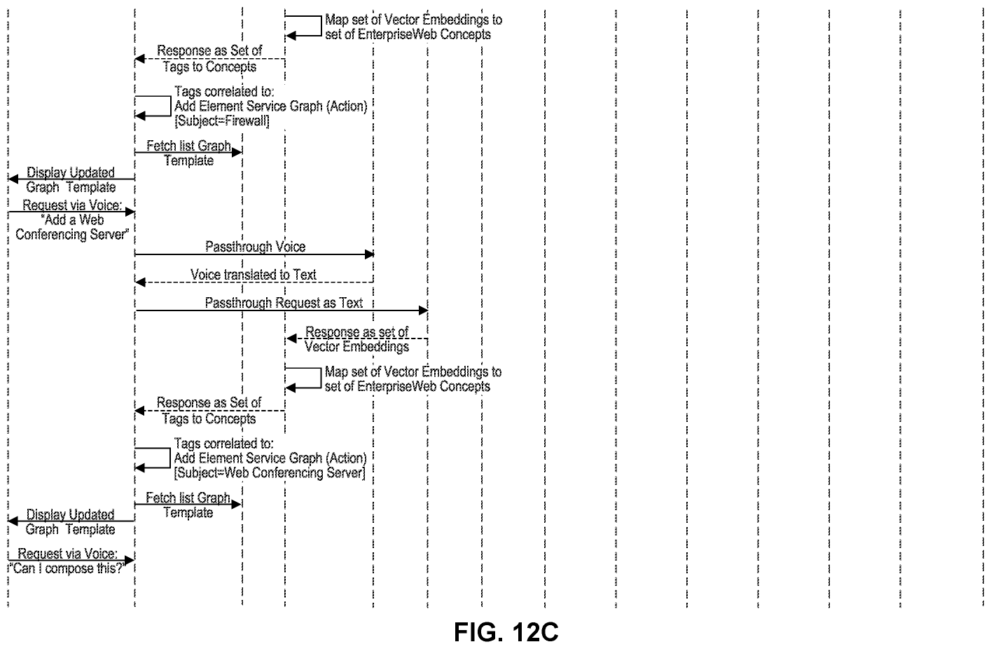

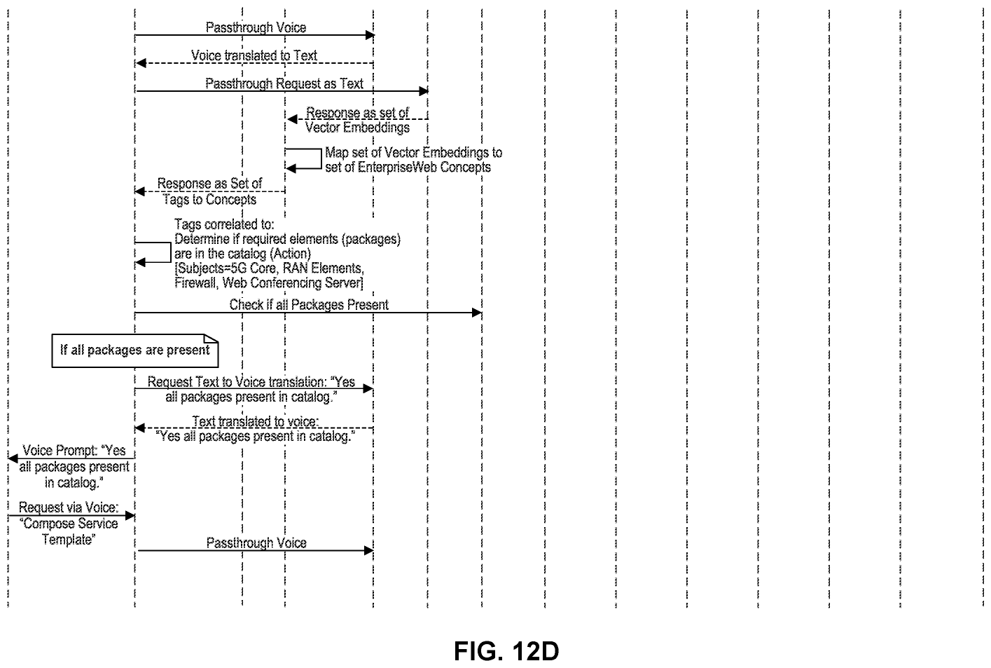

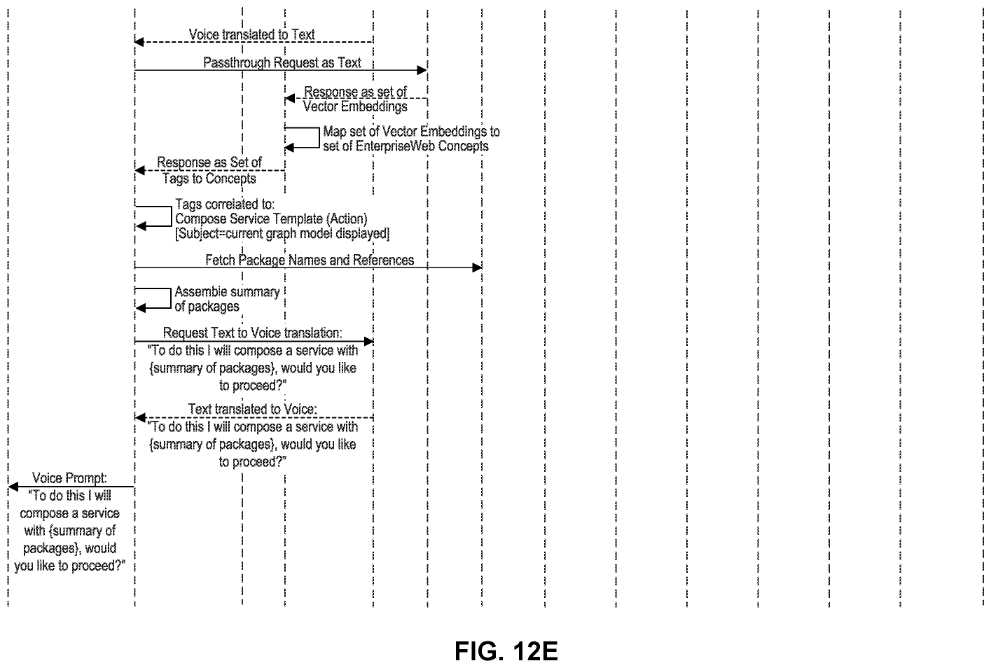

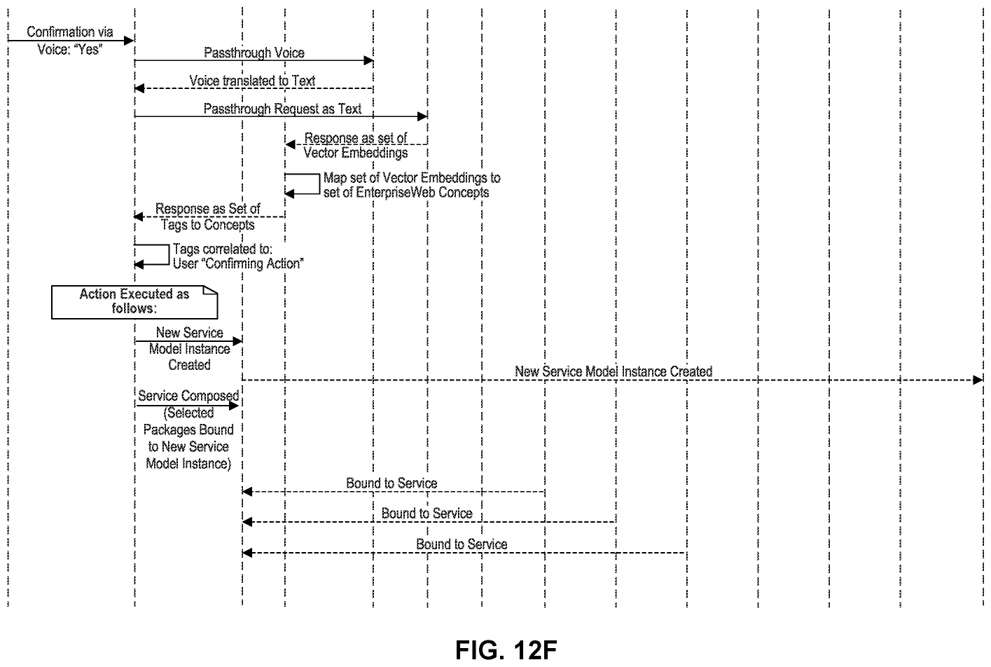

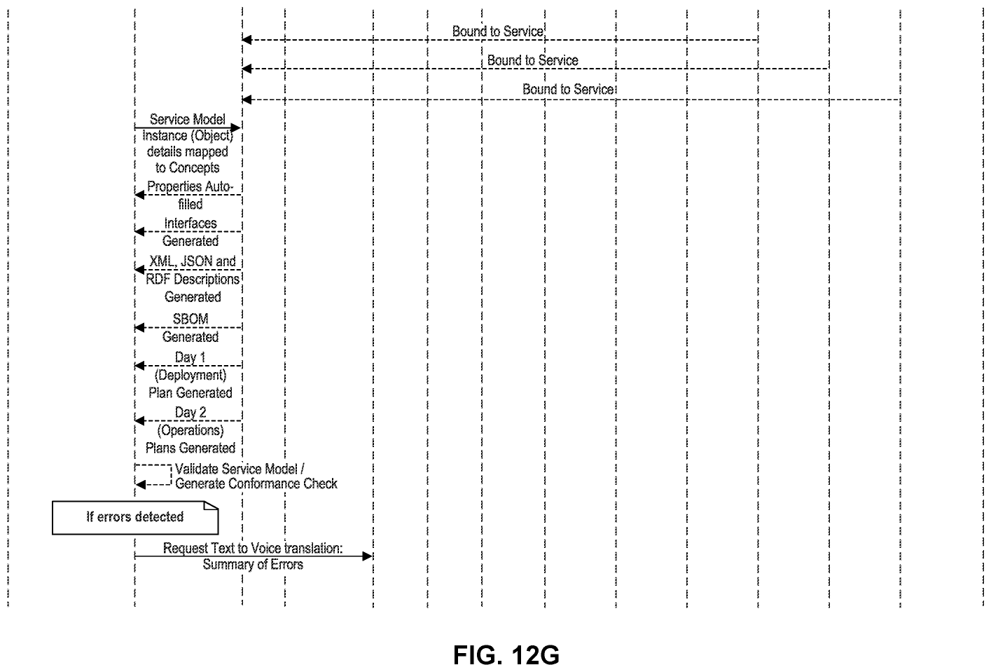

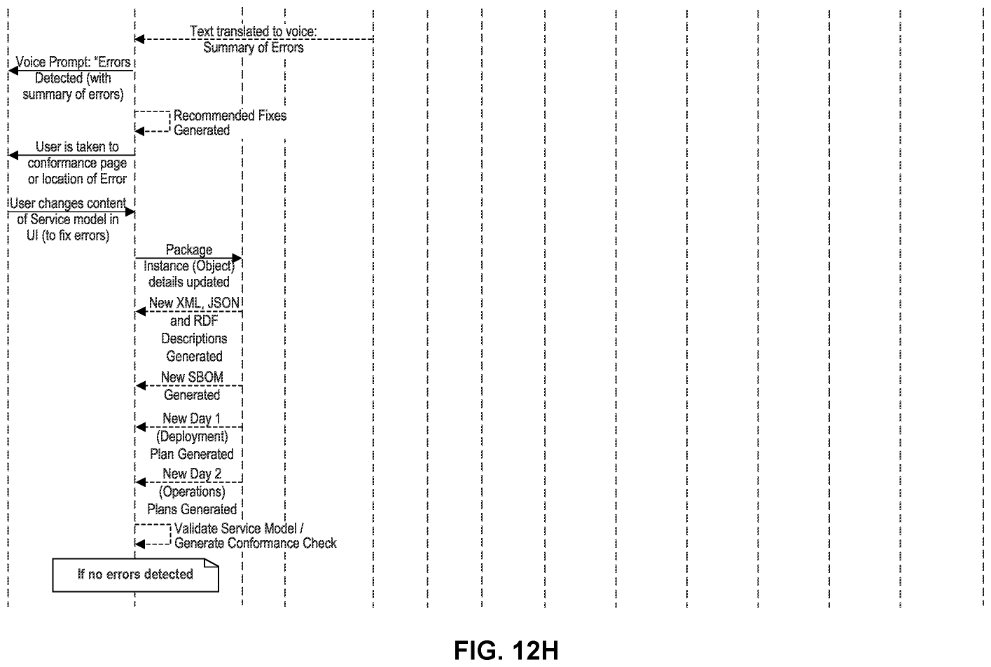

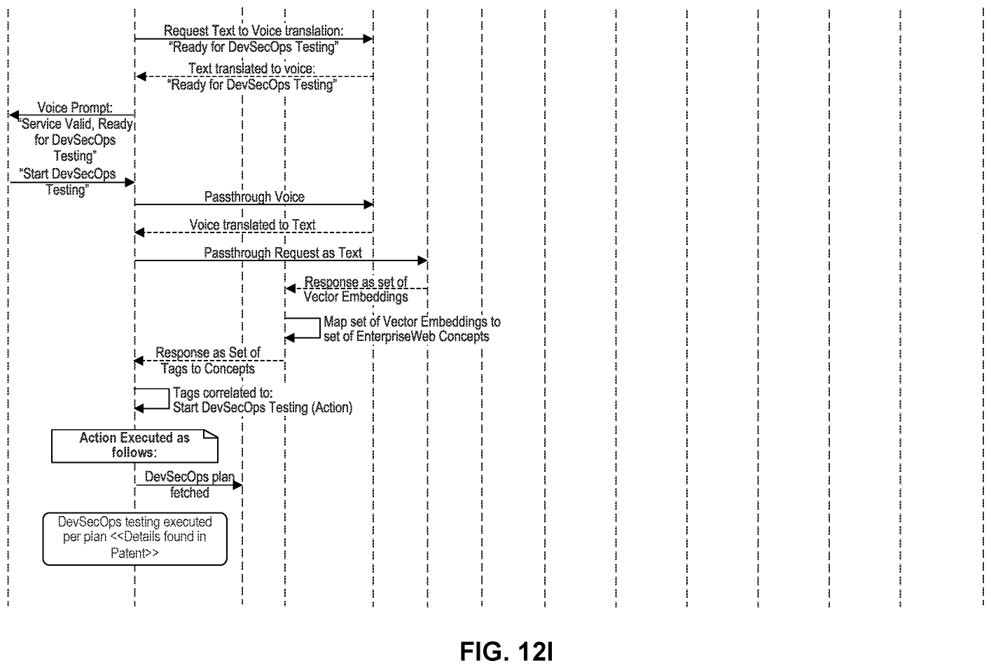

FIGS. 12A-12J illustrate method 1200 for performing Day 0 design for an optimized 5G/RAN (Radio Access Network) with a secure Edge Gateway, according to some embodiments. Method 1200 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 12, as will be understood by a person of ordinary skill in the art(s).

Day 0 Design is a composition activity, it involves a Service Designer selecting Application Packages from the catalog, and specifying the connections between those and any supporting services to implement the overall Network Service model to be Deployed, Integrated and Configured on Day 1, and managed during Day 2 ongoing operations.

Composition starts with a voice command from the user, “Show me a list of Service Templates”. The system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by EnterpriseWeb, to convert the request to vector embeddings, prompt the LLM for an interpretation, and then convert the LLM output to a set of tags (corresponding to EnterpriseWeb concepts) which can then act as mediated/deterministic inputs to the platform. The Intermediary returns these tags to EnterpriseWeb, which traverses its ontology to identify a corresponding graph, selecting a “Show List” action template from the Hypergraph. Further, context from the request (Subject=“Service Templates”) is injected into the action. Per the canonical method, if additional context is required the system or some other interaction is required it would be handled at this point before the action is executed. Since the action is atomic and direct, it is executed immediately by the platform: a dialog is rendered in the browser showing a list of all Service Templates available inside the Hypergraph. This is an example of the system performing RPA (Robotic Process Automation) in response to a user-command.

The user then identifies the templates they want to use as a starting point, and issues another voice command, “Show me the graph of a Multi-Access Edge Service”. The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to Enterprise Web, which traverses its ontology to identify a corresponding graph, selecting an “Show Service Graph” action template from the Hypergraph. Further, context from the request (Subject=“Multi-Access Edge Service”) is injected into the action. Per the canonical method, if additional context is required the system or some other interaction is required it would be handled at this point before the action is executed. Since the action is atomic and direct, it is executed immediately by the platform: a dialog is rendered in the browser showing a network (connection) graph for the service (including 5G Core and RAN elements) as fetched from the Hypergraph. This is another example of the system performing RPA (Robotic Process Automation) in response to a user-command.

The user examines the rendered graph for the service, and notices they need to add additional components. They issue another voice command, “Add a Firewall”. The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to EnterpriseWeb, which traverses its ontology to identify a corresponding graph, selecting an “Add Element to Service Graph” action template from the Hypergraph. Further, context from the request (Subject=“Firewall”) is injected into the action. Per the canonical method, if additional context is required the system or some other interaction is required it would be handled at this point before the action is executed. Since the action is atomic and direct, it is executed immediately by the platform: the graph is updated with the Firewall element fetched from the Hypergraph, and the rendering in the browser showing the network (connection) graph is update. This is another example of the system performing RPA (Robotic Process Automation) in response to a user-command.

Once more, the user examines the rendered graph for the service, and notices they need to add another additional component. They issue another voice command, “Add a Web Conferencing Server”. The voice command is passed through an NLP model, by way of an Intermediary, to convert it to text. The textual representation of the request is then passed to the Intermediary, which is programmed by EnterpriseWeb, to convert the request to vector embeddings, prompt the LLM for an interpretation, and then convert the LLM output to a set of tags (corresponding to EnterpriseWeb concepts) which can then act as mediated/deterministic inputs to the platform. The Intermediary returns these tags to EnterpriseWeb, which traverses its ontology to identify a corresponding graph, selecting an “Add Element to Service Graph” action template from the Hypergraph. Further, context from the request (Subject=“Web Conferencing Server”) is injected into the action. Per the canonical method, if additional context is required the system or some other interaction is required it would be handled at this point before the action is executed. Since the action is atomic and direct, it is executed immediately by the platform: the graph is updated with the Firewall element fetched from the Hypergraph, and the rendering in the browser showing the network (connection) graph is update. This is another example of the system performing RPA (Robotic Process Automation) in response to a user-command.

Once more, the user examines the rendered graph for the service, this time they notice the graph is complete. They query the system via voice, “Can I compose this?”. The voice based query is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to Enterprise Web, which traverses its ontology to identify a corresponding graph, selecting an “Determine if required elements (packages) are in the catalog” action template from the Hypergraph. Further, context from the request (Subject=<<The elements displayed in the graph on the screen=5G Core, RAN, Firewall, Web Conferencing Server>>) is injected into the action. Per the canonical method, if additional context is required the system or some other interaction is required it would be handled at this point before the action is executed. Since the action is atomic and direct, it is executed immediately by the platform: system Catalog (by way of the Hypergraph) is examined to see if there are Published Application Packages for each required element. This is an example of a complex, context driven query. The system finds all required packages, so the system sends a message, “Yes all packages present in the catalog” through the Intermediary to the NLP, where the message is converted to voice which is then relayed (spoken) to the user.

In response to the query, the user decides to go ahead with building the service, and issues the following command to the system via voice, “Compose Service Template”. The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to EnterpriseWeb, which traverses its ontology to identify a corresponding graph, selecting an “Compose Service Template” action template from the Hypergraph. Further, context from the request (Subject=<<the graph on the screen, Type=Multi-Access Edge Service, Elements=5G Core, RAN, Firewall, Web Conferencing Server>>) is injected into the action. Per the canonical method, if additional context is required the system or some other interaction is required it would be handled at this point before the action is executed. Even if no additional user context is required, an interaction with the user still needs to take place, since this operation will update system state (i.e., by creating a composing service template per the user's command) it needs to be confirmed. To do this, the system needs to summary the command, so the system fetches the names and details of each related Application Package from the catalog. If more than one are available at this point, the user would be presented with options that help them make the selection. In this case, we assume each element has a one-to-one mapping with Application Packages in the Catalog. Those names and details are assembled into a summary of the Service Template to be composed, it sends that summary through the Intermediary to the NLP, where the message is converted to voice which is then relayed (spoken) to the user, along with a request for the confirmation (i.e., “Would you like to proceed?”).

The user responds by voice, “Yes”. The response is decoded and confirmed via the Intermediary NLP and LLM interactions as described above. Once the operation is confirmed, the previously identified action “Compose Service Template” is executed by the system. First it creates a new Service Template Instance in the Hypergraph, then binds each selected Application Package to the model completing the initial composition. The system then maps instance (object) details to the Concepts in the Ontology, and then uses the mapping to auto-fill properties, generated standards based interfaces, generate XML, JSON and RDF descriptors and an SBOM file (collectively, a set of supporting artifacts that may be directly useful to a developer), and a Day 1 Deployment plan and associated Day 2 Operation plans are generated.

From here the system proceeds to guide the user through a conformance/error correction process. First, the system validates the Service Template model. If errors are detected, the system generates a set of error message, which it then passes through the Intermediary to the NLP, where the message is converted to voice which is then relayed (spoken) to the user. At the same time, the system generates a set of recommended fixes, and uses an RPA process to direct the user to the conformance page or location of the errors they need to correct.

As the user makes changes to the Service Template model in the UI, service details are updated in the hypergraph, supporting artifacts (XML, JSON and RDF descriptors and an SBOM file) are regenerated, the Day 1 Deployment plan and any Day 2 Operation plans are regenerated, and the Service Template model is once again conformance checked. If errors remain, or new errors are introduced, the same guided conformance/error correction loop is repeated until the Service Template model is complete and valid.

Once valid, the system sends a message, “Ready for DevSecOps Testing” through the Intermediary to the NLP, where the message is converted to voice which is then relayed (spoken) to the user.

The user can then say “Start DevSecOpsTesting” (or initiate via the UI). Which system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by EnterpriseWeb, to convert the request to vector embeddings, prompt the LLM for an interpretation, and then convert the LLM output to a set of tags (corresponding to EnterpriseWeb concepts) which can then act as mediated/deterministic inputs to the platform. The Intermediary returns these tags to EnterpriseWeb, which traverses its ontology to identify a corresponding graph, selecting the “Start DevSecOps Testing” action template from the Hypergraph. Per the canonical method, if additional context is required the system or some other interaction is required it would be handled at this point before the action is executed. Since the action is atomic and direct, it is executed immediately by the platform. First, the platform fetches the associated DevSecOps pipeline process model from the Hypergraph. It then performs the process. If errors are detected, the earlier guided conformance/error correction loop is repeated, and the Service Template is retested until no errors remain.

Once the Service Template passes DevSecOps testing, the system sends a message, “Published to Catalog” through the Intermediary to the NLP, where the message is converted to voice which is then relayed (spoken) to the user. The Service Template state is updated in the Hypergraph and added to the System Catalog.

Once the Service Template is added to the catalog, it is available for instantiation (Day 1 Deployment).

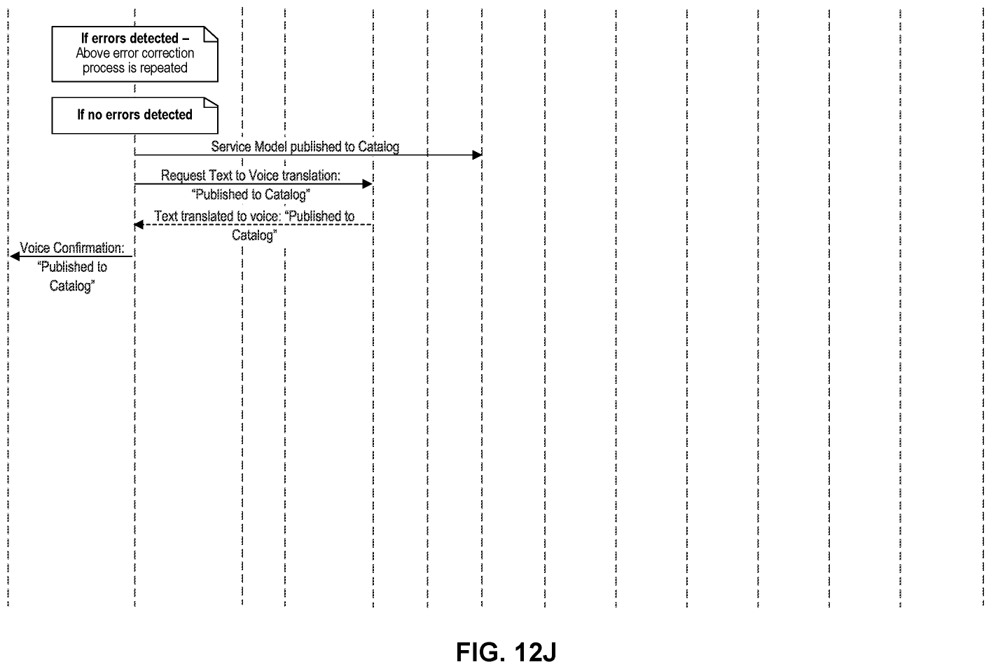

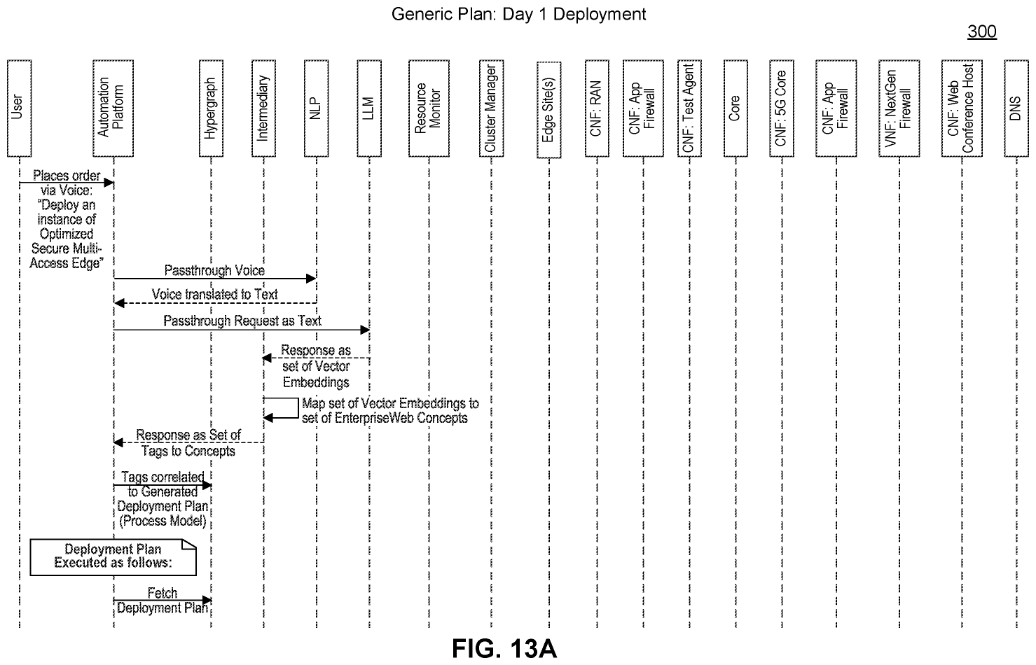

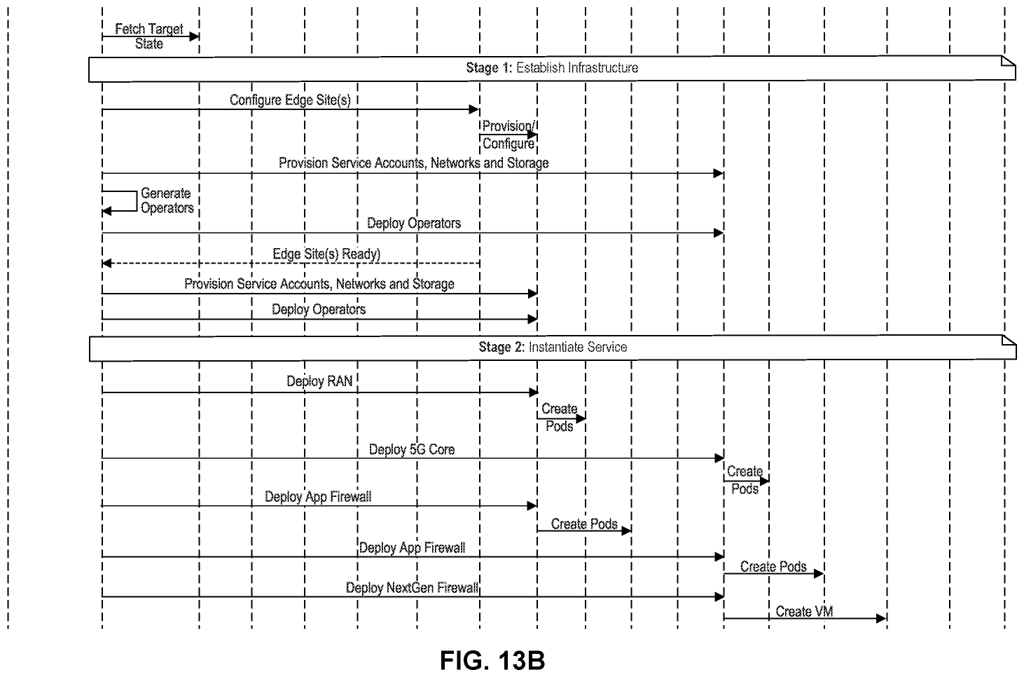

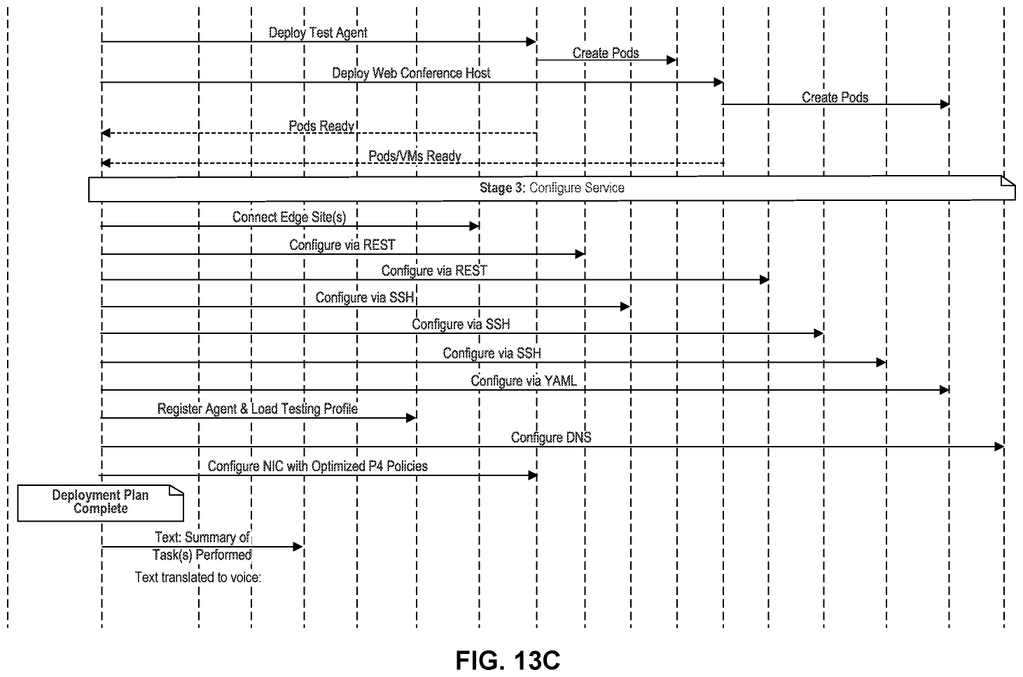

FIGS. 13A-13C illustrate method 1300 for performing day-one deployment for an optimized 5G/RAN (Radio Access Network) with a secure Edge Gateway, according to some embodiments. Method 1300 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 13, as will be understood by a person of ordinary skill in the art(s).

Day 1 Deployment starts with a voice command from the user, “Deploy an instance of the Optimized Secure Multi-Access Edge Service”. The system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to EnterpriseWeb concepts) which can then act as mediated/deterministic inputs to the platform. The Intermediary returns these tags to Enterprise Web, which traverses its ontology to identify a corresponding graph, selecting a “Day 1 Deployment Plan” template from the Hypergraph. Per the canonical method, if additional context is required the system or some other interaction is required it will be handled at this point before the Day 1 Process is executed.

Once the user intent is confirmed, the Day 1 process will be carried out in a series of 3 automated stages by the system.

First the system executes Stage 1: “Establish Infrastructure”. It uses a Cluster Manager as a controller to provision Edge Site(s). It then provisions service accounts, networks and storage in the Core site via available infrastructure controllers on that host. Next it generates Operators (software bundles) for the basic LCM operations involved in each Application Package to be deployed as part of the service. It then deploys a set of those operators to the Core Network for any elements which will be deployed there. When Edge Site(s) are ready, it then provisions service accounts, networks and storage in those Edge Site(s) via available infrastructure controllers on those hosts, and deploys the associated Operators for elements which will run in the Edge Site(s).

Once the infrastructure is established, the system moves to Stage 2: “Initiate Services”. The system issues commands to deploy RAN, App Firewall and Test Agent elements as pods on the Edge Site(s), to deploy 5G Core, App Firewall and Web Conferencing Server elements as pods on the Core, and to deploy a NextGen Firewall as a VM on the Core. Edge and Core infrastructure controllers will then spin up required pods and VMs, and signal the system when complete.

Once the services are initiated, the system moves to Stage 3: “Configure Services”. The system issues a command to the Cluster Manager to connect the Edge Site(s) and Core. It then configures the deployed RAN elements via a REST interface, the 5G Core elements via a REST interface, all three firewalls using SSH interfaces, and the Web Conferencing Host via a YAML file. The system then registers the deployed Test Agent and loads a test plan using REST APIs exposed by the resource monitoring component, so that it can measure performance of the deployed service. Finally the system updates related DNS entries and programs the NICs (network controls) found in the Edge Site hardware for optimized networking.

At this point, the service is deployed and active. A summary of tasks performed is sent through the Intermediary to the NLP which converts it to voice. The voice is then relayed (spoken) to the user to confirm completion of the task they requested (to deploy the service).

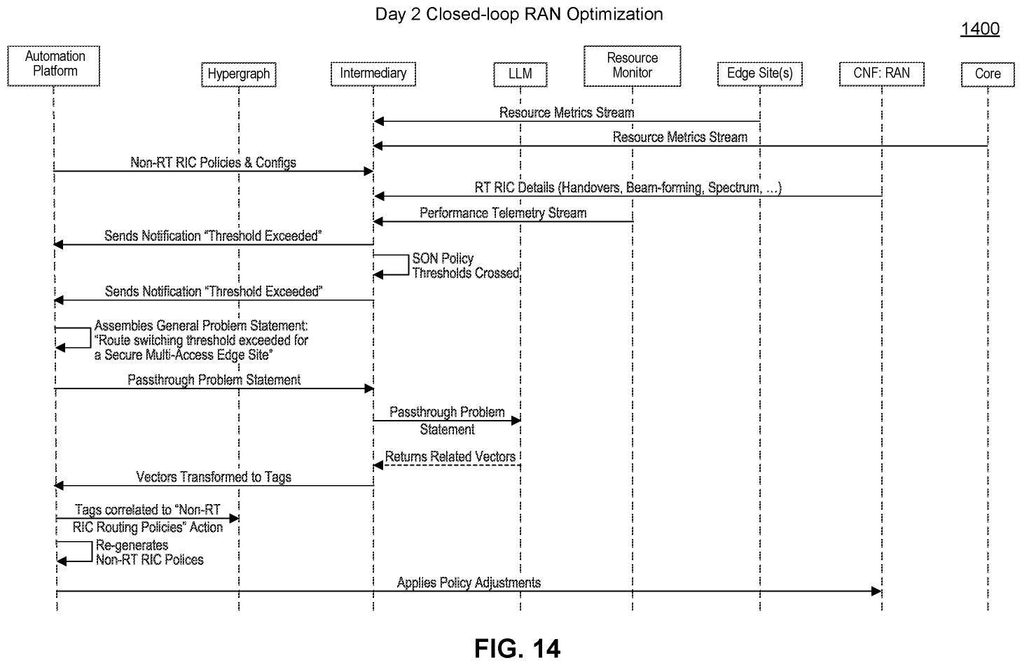

FIG. 14 illustrates method 1400 for performing day-two closed-loop RAN optimization for an optimized 5G/RAN (Radio Access Network) with a secure Edge Gateway, according to some embodiments. Method 1400 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 14, as will be understood by a person of ordinary skill in the art(s).

This Day 2 operation is a closed-loop process which runs continuously to optimize the operation of RAN (radio) related component by continuously adjusting configurations to adapt to changing network state/conditions. It minimizes power and resource consumption, which maximizing performance (e.g., minimizing latency).

In the context of this operation, the Intermediary component plays the role of both an intermediary for LLM interaction, and as an AI component (a streaming analytics monitor raising alerts to EnterpriseWeb based on programmed thresholds).

Prior to this operation, Day 1 operations will have completed, the service is operating and configured such that A) Resource Metrics are streamed to the Intermediary from the Edge and Core Sites; B) Real-time RIC Details (handover, bean-forming, spectrum data) will be streamed to the Intermediary; C) Independent Monitoring components stream performance telemetry to the Intermediary; and Enterprise Web (near Real-time RIC) forwards all Policies and configs to the Intermediary as they are updated.

The Intermediary continuously monitors changes in these sources (as they stream) and when performance (latency) exceeds any programmed thresholds a “Threshold Exceeded” notification is send to Enterprise Web along with associated data points (metrics, telemetry, RIC details).

EnterpriseWeb synthesizes a problem statement (for example: “Route switching threshold exceed for a Secure Multi-Access Edge Site”) which it then passes through the Intermediary to the LLM along with a prompt for possible corrective measures/actions. Per the canonical LLM interaction methods established earlier, the response from the LLM is converted to a set of tags related to concepts from the Enterprise Web Ontology (Hypergraph). Those tags are used to match one (or more) actions found in the Hypergraph, in this case a process to adjust “Non-RT RIC Routing Policies”. That process is carried out using the current state of the system, EnterpriseWeb adjusts the associated policies in the RAN (via it's non Real-time RIC controller), closing the loop.

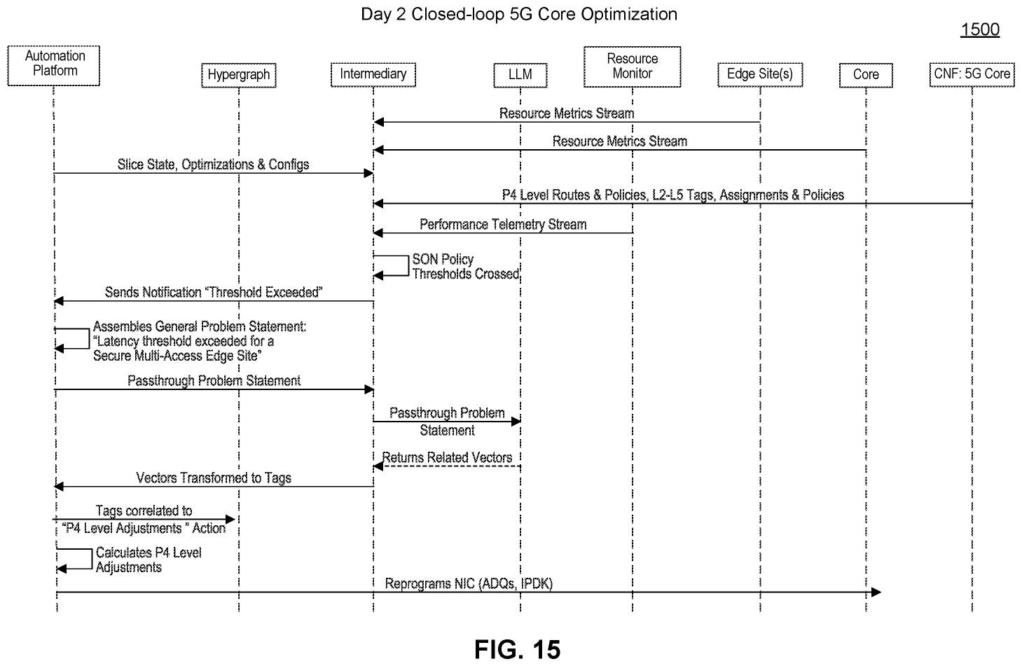

FIG. 15 illustrates method 1500 for performing day-two closed-loop 5G core optimization for an optimized 5G/RAN (Radio Access Network) with a secure Edge Gateway, according to some embodiments. Method 1500 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 15, as will be understood by a person of ordinary skill in the art(s).

This Day 2 operation is a closed-loop process which runs continuously to optimize the operation of 5G Core related component by continuously adjusting configurations to adapt to changing network state/conditions. It minimizes power and resource consumption, while maximizing performance (e.g., using shortest packet paths).

In the context of this operation, the Intermediary component plays the role of both an intermediary for LLM interaction, and as an AI component (a streaming analytics monitor raising alerts to EnterpriseWeb based on programmed thresholds).

Prior to this operation, Day 1 operations will have completed, the service is operating and configured such that A) Resource Metrics are streamed to the Intermediary from the Edge and Core Sites; B) Core Details (P4 Level Routes & Policies, L2-L5 Tags, Assignments & Policies) will be streamed to the Intermediary; C) Independent Monitoring components stream performance telemetry to the Intermediary; and Enterprise Web forwards all slice state, optimizations and configs to the Intermediary as they are updated.

The Intermediary continuously monitors changes in these sources (as they stream) and when performance (e.g., packet latency) exceeds any programmed thresholds a “Threshold Exceeded” notification is send to EnterpriseWeb along with associated data points (metrics, telemetry, slice details).

EnterpriseWeb synthesizes a problem statement (for example: “Latency threshold exceeded for a Secure Multi-Access Edge Site”) which it then passes through the Intermediary to the LLM along with a prompt for possible corrective measures/actions. Per the canonical LLM interaction methods established earlier, the response from the LLM is converted to a set of tags related to concepts from the Enterprise Web Ontology (Hypergraph). Those tags are used to match one (or more) actions found in the Hypergraph, in this case a process to make “P4 Level Adjustments” based on the context of the service. That process is carried out using the current state of the system, Enterprise Web reprograms the NIC, making ADQs (Application Dedicated Queue) adjustments, closing the loop.

### Use Case 2: Code Support

Use-case 2 (UC2) is a code support use-case wherein static and dynamic analysis of an application being developed by a programmer is performed continuously, and feedback is provided to the user on a real-time basis using Generative AI. It includes methods used to tune an underlying private LLM as part of a ModelOps process.

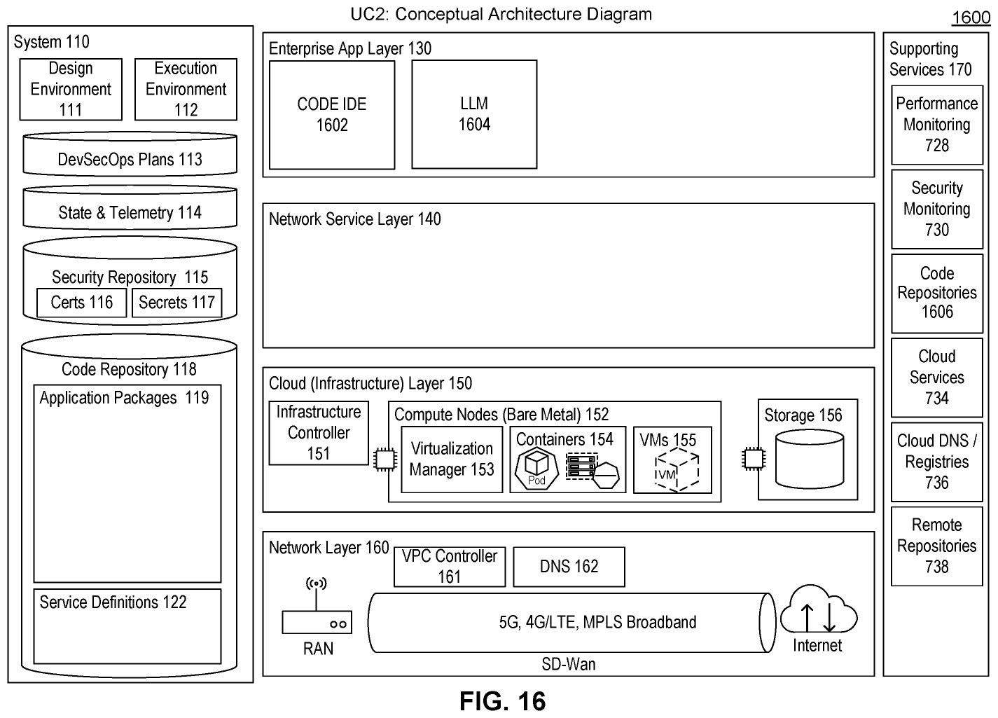

FIG. 16 is a block diagram of a conceptual architecture 1600 for code support where static and dynamic analysis of an application is continually performed and feedback is provided to the programmer on a real-time basis using generative AI, according to some embodiments. Architecture 1600 may include system 110, design environment 111, execution environment 112, DevOps plans 113, state and telemetry 114, security repository 115, certificates 116, secrets 117, code repository 118, application packages 119, service definitions 122, enterprise application layer 130, code IDE 1602, LLM 1604, network service layer 140, cloud layer 150, infrastructure controllers 151, compute nodes 152, virtualization manager 153, containers 154, virtual machines 155, storage 156, network layer 160, virtual private cloud (“VPC”) controller 161, domain name system (“DNS”) 162, supporting services 170, performance monitoring 728, security monitoring 730, code repositories 1606, cloud services 734, cloud DNS 736, and remote repositories 738.

At the Network Layer an SD-WAN is implemented via a VPC Controller with a linked DNS to provide basic connectivity between the EnterpriseWeb platform and the user (“Code IDE”) and any cloud-based code-repositories they may connect to. In practice this could be any connection.

At the Cloud (Infrastructure) Layer an Infrastructure Controller provides an interface to multiple Compute Nodes (Bare Metal servers) for each site involved in the use-case (Edge and Core) and to attached Storage. Compute Nodes have a Virtualization Manager present to support the execution of Container-based applications (containers/pods) and VM-based applications. Also, the Compute Nodes provide a programming interface for their hardware (NIC-Network Interface Controllers) so that they can be optimized for the applications running on them. At the Network Service Layer there are no components, as this use-case is App Layer (7) only.

At the Enterprise App Layer are a “Code IDE” hosted either as a “Cloud IDE” (i.e., running in a container in a cloud host) or locally on a user's computer; and a hosted private LLM.

Supporting Services for this use-case include centralized components for Performance and Security Monitoring, a Traffic Generator, Cloud Services for service account creation, a Cloud DNS/Registry and Remote Repositories (for code (i.e., a Git Repo) or images).

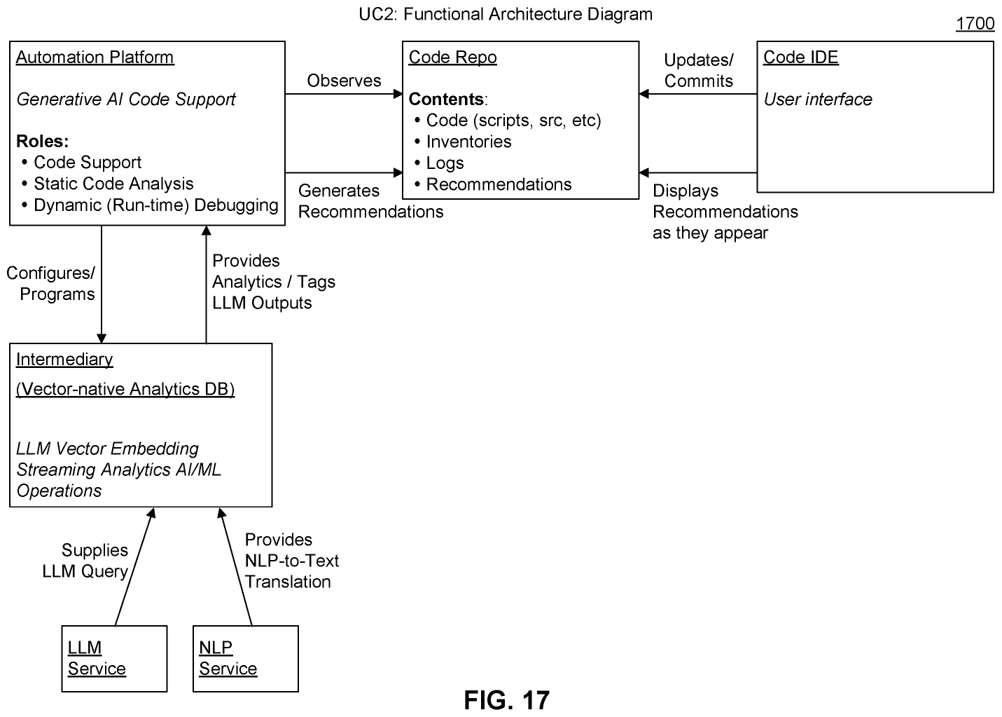

FIG. 17 is a block diagram of a functional architecture 1700 for code support where static and dynamic analysis of an application is continually performed and feedback is provided to the programmer on a real-time basis using generative AI, according to some embodiments.

This diagram provides a high-level depiction of the main components found in the use-case solution, decomposed into main function description the main roles they play, components used to realize them, and the relationships between each.

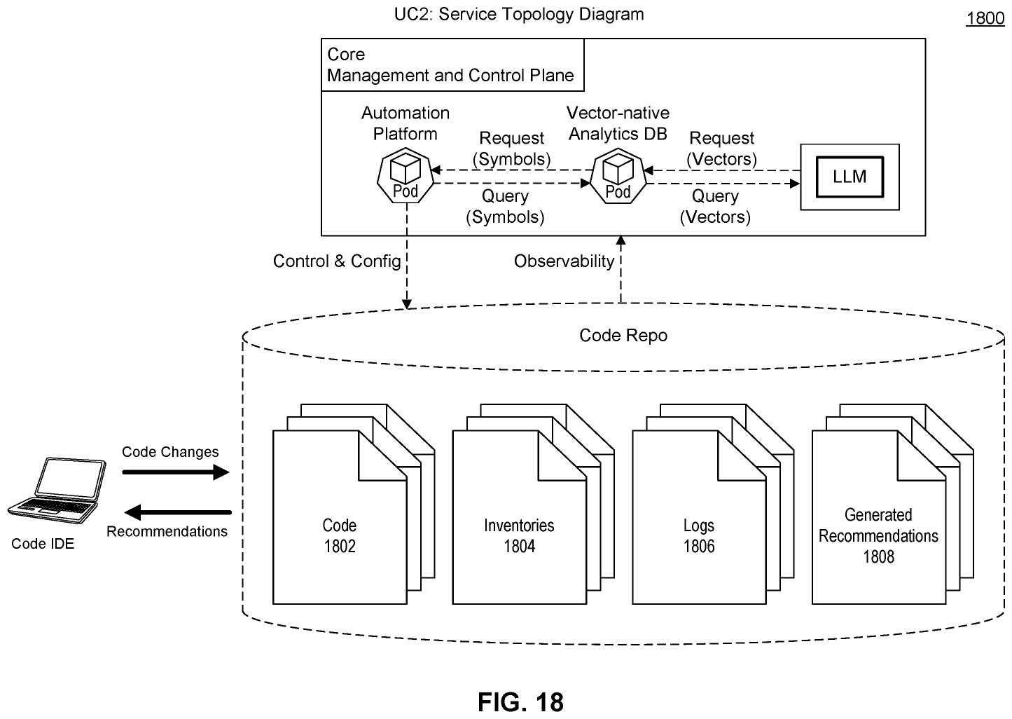

FIG. 18 is a block diagram of a service topology 1800 for code support where static and dynamic analysis of an application is continually performed and feedback is provided to the programmer on a real-time basis using generative AI, according to some embodiments. Service topology 1800 may include ode 1802, inventories 1804, logs 1806, and generated recommendations 1808.

The use-case is implemented at “arms-length”, where the EnterpriseWeb instance interacts directly with a code repository (e.g., a GIT or similar repo either offered as a service or hosted within the machine of the developer). The code repository contains the code being worked on (e.g., Python Code), Inventories (e.g., JSON-based lists of related application images), Logs (associated with the various runtimes executing the code), and will host recommendations generated via Generative AI to be displayed to the user.

Enterprise Web observes changes in this code repository (for example, a GIT commit initiated in the IDE upon saving code), analyses the state of various artifacts in the code repository, and pushes back generated recommendations.

A user, in a Code IDE, interacts indirectly with EnterpriseWeb through the code repository in this example, but could just as easily interact with the service rendered directly via APIs.

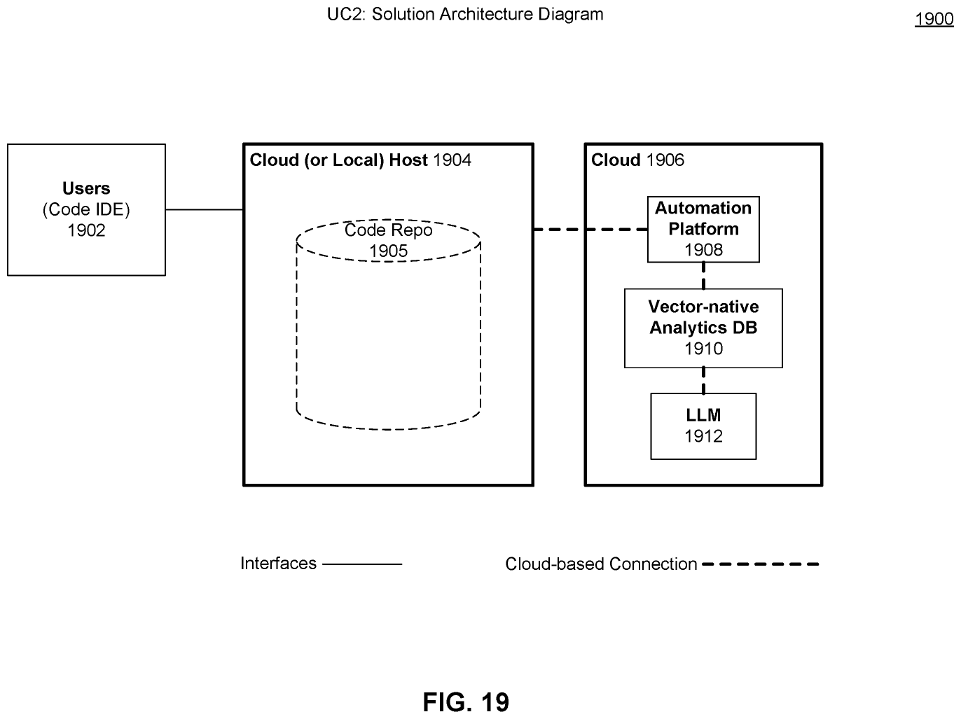

FIG. 19 is a block diagram of a solution architecture 1900 for code support where static and dynamic analysis of an application is continually performed and feedback is provided to the programmer on a real-time basis using generative AI, according to some embodiments. Architecture 1900 may include users 1902, host 1904, code repository 1905, cloud 1906, Automation Platform 1908, analytics database 1910, and LLM 1912.

This diagram provides a detailed view of the Service Topology in FIG. 18, showing concrete components, their sub-components, connections and the standards based interfaces they expose and consume.

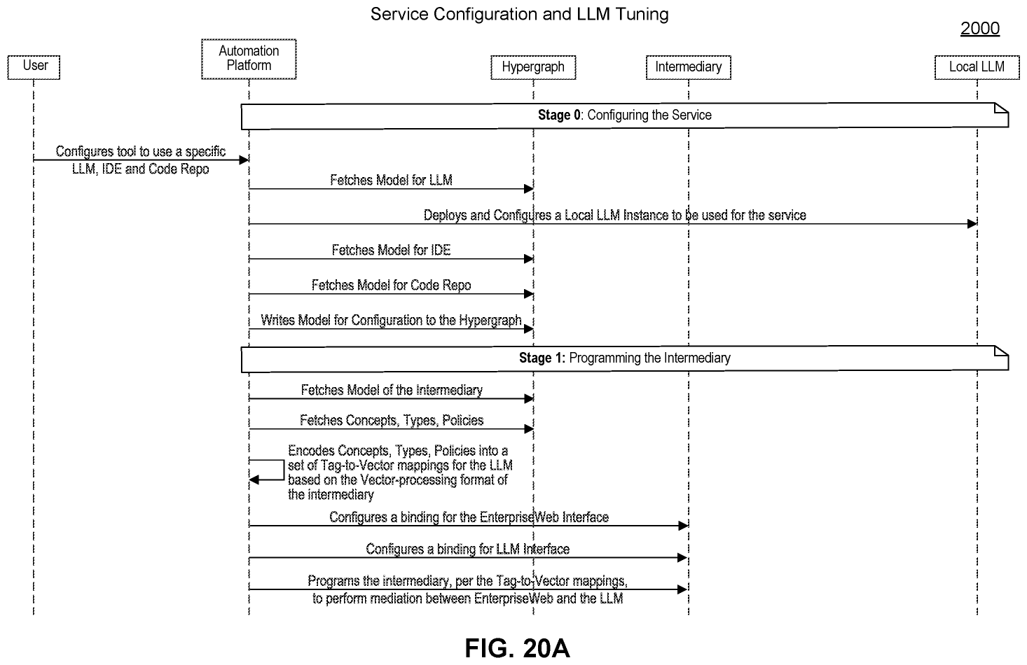

FIGS. 20A-20B illustrate method 2000 for performing service configuration and LLM tuning, according to some embodiments. Method 2000 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 20, as will be understood by a person of ordinary skill in the art(s).

Service Configuration and LLM Tuning is a 3-stage process for preparing the platform to perform the Code Support service for a specific LLM, Code Repo, and IDE combination (note: like all federated elements in any Enterprise Web use-case, each is substitutable).

The process starts with a user requesting a configuration of the tool a specific LLM, IDE and Code Repo. This kicks off Stage 0: “Configuring the Service”, wherein the system proceeds to fetch a model for the requested LLM from the Hypergraph, and based on that, to deploy and configure a local/private instance (details of similar processes are found elsewhere in the patent). Once deployed the system fetches models for the selected IDE and Code Repo, and generates a “Service Configuration” which is stored in the Hypergraph, leaving the system configured to start working as part of the Developer's toolchain with the LLM of their choice.

The process then moves to Stage 1: “Programming the Intermediary”. The system first fetches a model of the Intermediary from the Hypergraph (note: like all federated elements in any EnterpriseWeb use-case, this is also substitutable). Per the canonical methods described earlier, the Intermediary is always bound with each interaction, but at this point in the process, the model of its interactions are required so that it can be “programmed” by the system, so its full model if fetched. The system then fetches Concepts, Types, Policies from the domain which the LLM is going to be applied to (in this case, the Enterprise Web Upper Ontology which contains general programming concepts). The system then encodes the Concepts, Types, Policies into a set of Tag-to-Vector mappings for the LLM based on the Vector-processing format of the Intermediary. The system then configures a binding for the Enterprise Web Interface (to perform an “intermediary” function), and then programs the intermediary per the Tag-to-Vector mappings to perform mediation between EnterpriseWeb and the LLM (to perform a “gateway” function).

Once programmed, the process moves to Stage 2: “LLM Tuning”, which typically will take place as part of this overall “service initialization” process, but can also be run again later, of often as required, to further refine the recommendations generated by the local LLM. Tuning proceeds by the user submitting either code samples (for static/design-time support) or code samples with associated logs (for dynamic/run-time support). The system forwards the artifacts submitted to the Intermediary, which encodes the samples (and logs when submitted) as Vectors corresponding to Enterprise Web Tags per its program (Stage 1). The Intermediary then tunes the local LLM with these samples along with the vectors. As stated above, this submission process is repeated as much as necessary to tune the LLM, and can be automated to pull these artifacts from a Code Repo or similar depending on the use-case requirements.

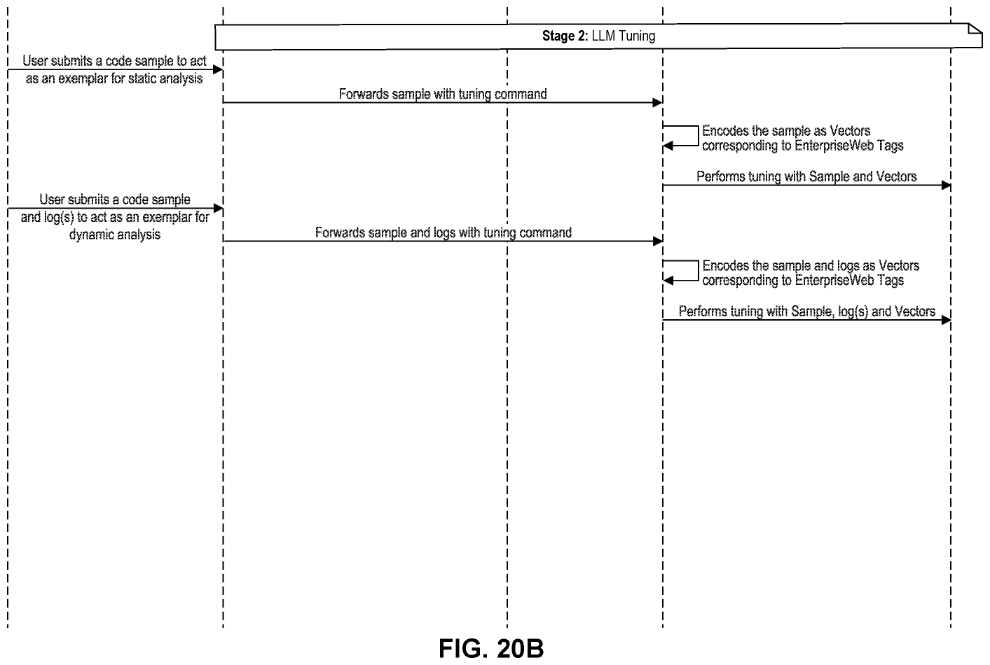

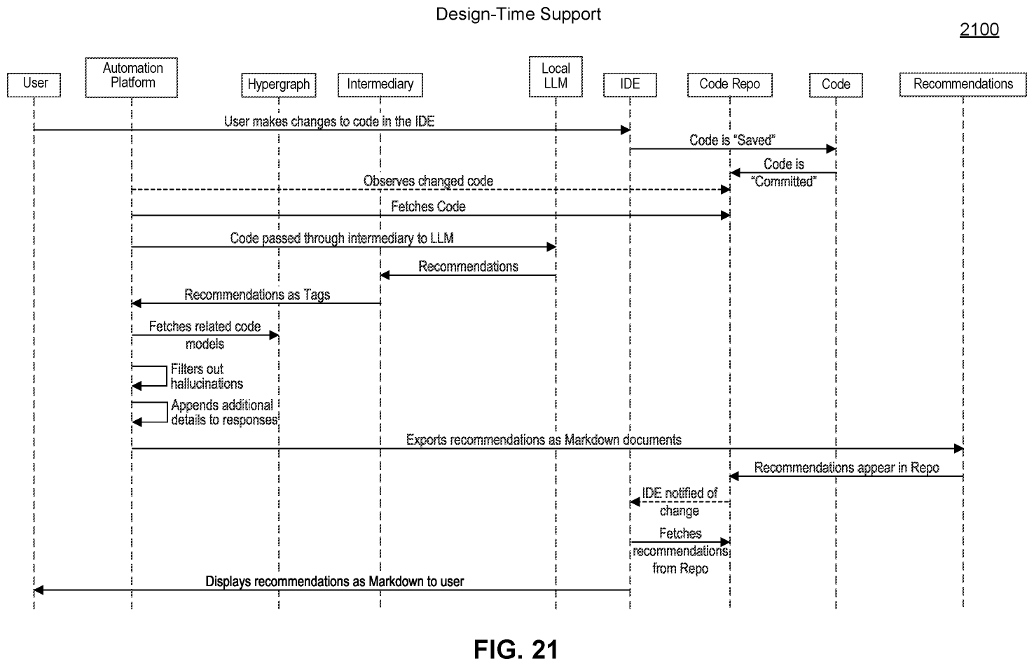

FIG. 21 illustrates method 2100 for performing design-time support, according to some embodiments. Method 2100 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 21, as will be understood by a person of ordinary skill in the art(s).

Design-time support (static analysis) is performed automatically by the service in response to a user updating source (“code”) files.

When the user changes code in the IDE and saves it, they either explicitly commit it to the Code Repo (e.g.: a GIT instance) or it is committed on their behalf by the IDE. The platform is configured to observe/monitor the code repository, and when it observes the new or updated source file being committed it proceeds to fetched all related artifacts. The system then passes them (via the Intermediary) to the local LLM, which produces a set of recommendations. Vectors related to the recommendation are transformed by the Intermediary to a set of Enterprise Web Tags, the tags and the recommendation itself are then passed by the Intermediary to Enterprise Web. Enterprise Web fetched related code models (corresponding to the Tags) from its Hypergraph. It then uses those models to A) filter out any hallucinations; and B) append any additional details to the response. Enterprise Web then transforms the recommendation to a Markdown (a common format used in development) file, which it then pushes into the Code Repo. The IDE is notified of the new recommendation added to the Code Repo, which it then fetches and displays as Markdown to the user-alerting them of recommendations related to the code they have just saved.

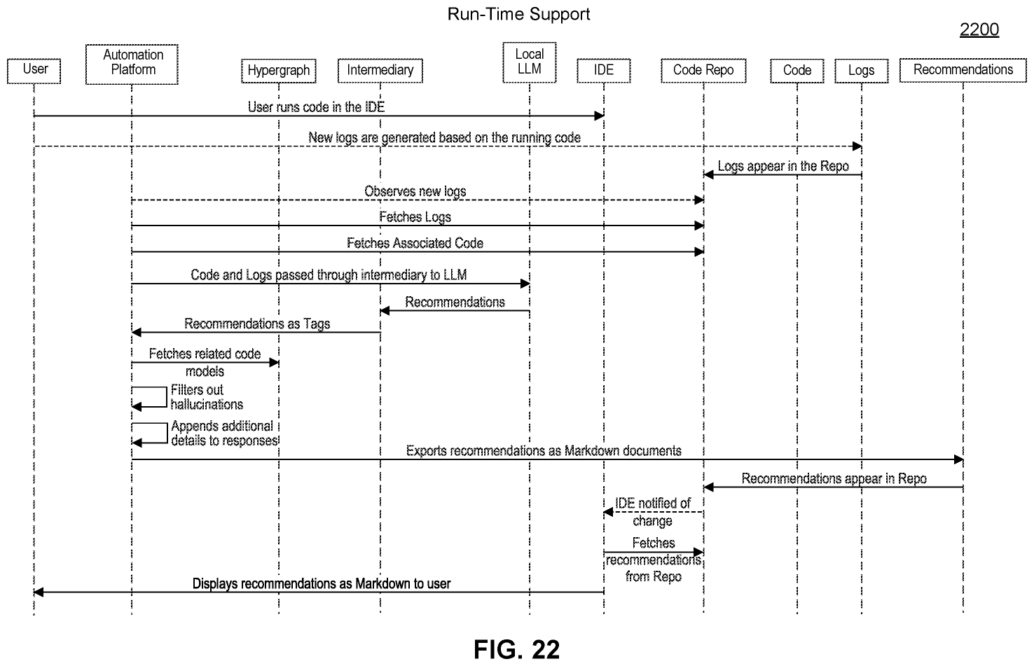

FIG. 22 illustrate method 2200 for performing run-time support, according to some embodiments. Method 2200 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 22, as will be understood by a person of ordinary skill in the art(s).

Run-time support (dynamic analysis) is performed automatically by the service in response to a user running their code.

When the user runs (“executes”) code via a connected runtime (e.g., when a Python runtime is invoked to execute the source code being developed in the IDE), logs are generated and added to the Code Repo. The platform is configured to observe/monitor the code repository, and when it observes the new logs it proceeds to fetch all related artifacts (log and source code used to generate it). The system then passes them (via the Intermediary) to the local LLM, which produces a set of recommendations. Vectors related to the recommendation are transformed by the Intermediary to a set of Enterprise Web Tags, the tags and the recommendation itself are then passed by the Intermediary to Enterprise Web. Enterprise Web fetched related code models (corresponding to the Tags) from its Hypergraph. It then uses those models to A) filter out any hallucinations; and B) append any additional details to the response. Enterprise Web then transforms the recommendation to a Markdown (a common format used in development) file, which it then pushes into the Code Repo. The IDE is notified of the new recommendation added to the Code Repo, which it then fetches and displays as Markdown to the user-alerting them of recommendations related to the code they have just run.

### Use Case 3: Fibre Network Provisioning

Use-case 3 (UC3) Fiber Network Provisioning, is an example of Generative AI being used to design and order a physical Fibre Network.

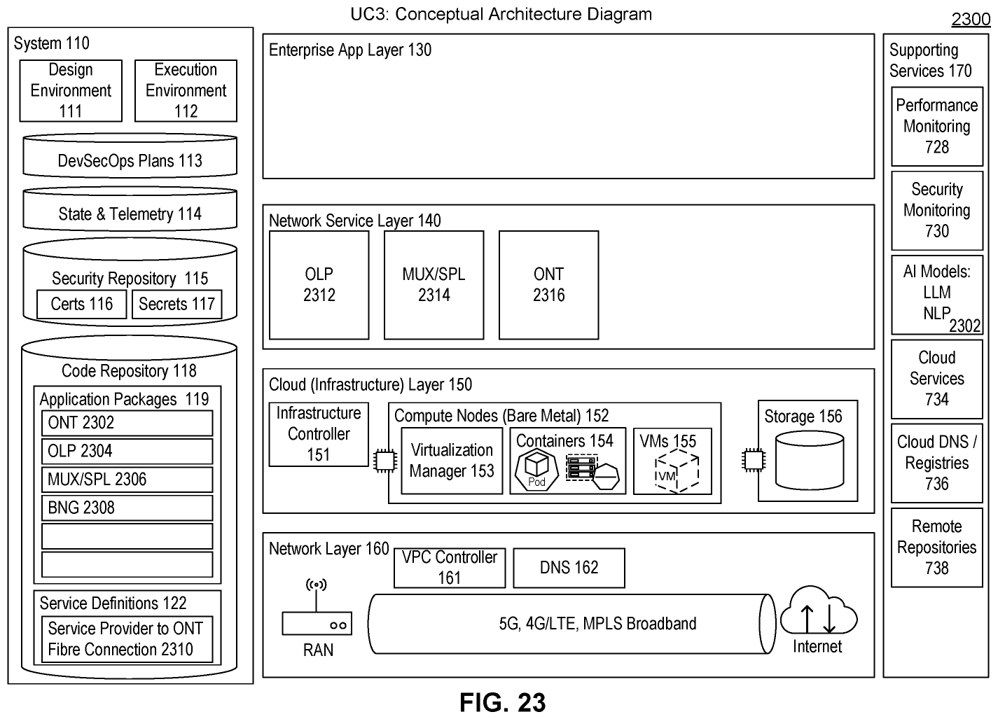

FIG. 23 is a block diagram of a conceptual architecture 2300 for using generative AI to design and order a physical Fibre Network, according to some embodiments. Architecture 2300 may include system 110, design environment 111, execution environment 112, DevOps plans 113, state and telemetry 114, security repository 115, certificates 116, secrets 117, code repository 118, application packages 119, ONT 2302, OLP 2304, MUX/SPL 2306, BNG 2308, service definitions 122, ONT connection 2310, service definition models 123, artifacts related to the service definitions 124, enterprise application layer 130, network service layer 140, OLP 2312, MUX/SPL 2314, ONT 2316, cloud layer 150, network layer 160, supporting services 170, performance monitoring 728, security monitoring 730, AI models 2302, cloud services 734, cloud DNS registries 736, and remote repositories 378.

The core service for the use-case is “Service Provider to ONT Fibre Connection”, the Service Definition and associated Application Packages are found in the Code Repo within the System.

At the Network Layer a Fibre channel is physically installed and exposes a VPC-like Controller with a linked DNS.

At the Cloud (Infrastructure) Layer an Infrastructure Controller provides an interface to multiple Compute Nodes (Bare Metal servers) for each site involved in the use-case (Edge and Core) and to attached Storage. Compute Nodes have a Virtualization Manager present to support the execution of Container-based applications (containers/pods) and VM-based applications. Also, the Compute Nodes provide a programming interface for their hardware (NIC-Network Interface Controllers) so that they can be optimized for the applications running on them.

At the Network Service Layer are fixed (physical) functions for ONT (Optical Network Terminal), MUX/SPL (Optical Multiplexer) and OLT (Optical Line Terminal) optical network components.

At the Enterprise App Layer there are no components, as this service operates at the transport level (i.e., “below the cluster”).

Supporting Services for this use-case include centralized components for AI (NLP and LLM), Performance and Security Monitoring, a Traffic Generator, Cloud Services for service account creation, a Cloud DNS/Registry and Remote Repositories (for images).

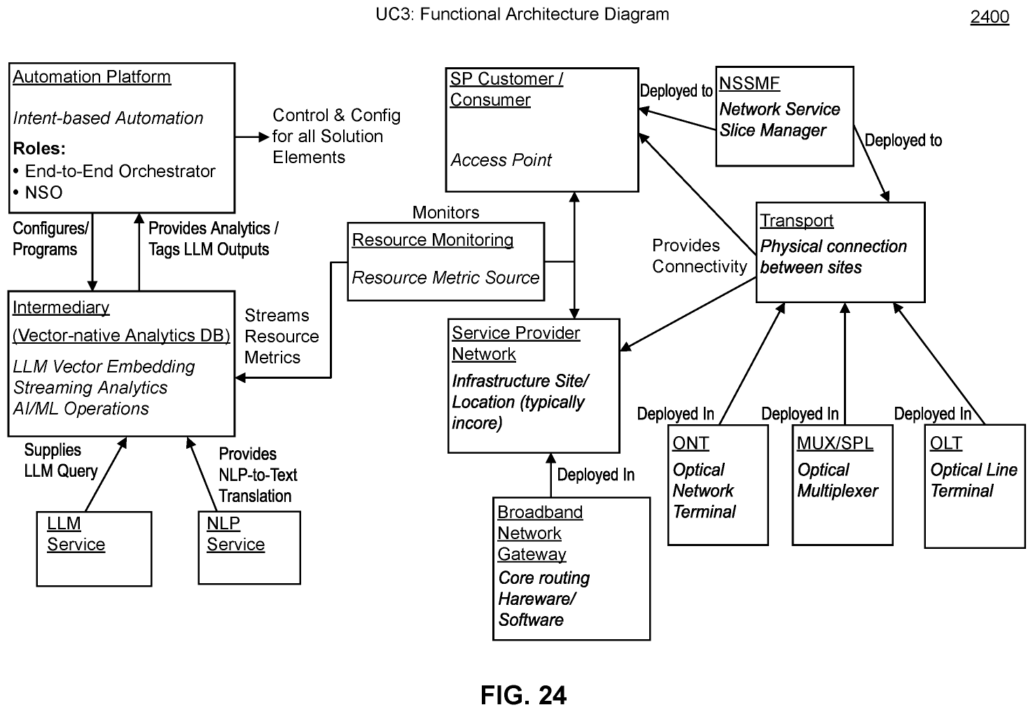

FIG. 24 is a block diagram of a functional architecture 2400 for using generative AI to design and order a physical Fibre Network, according to some embodiments. This diagram provides a high-level depiction of the main components found in the use-case solution, decomposed into main function description the main roles they play, components used to realize them, and the relationships between each.

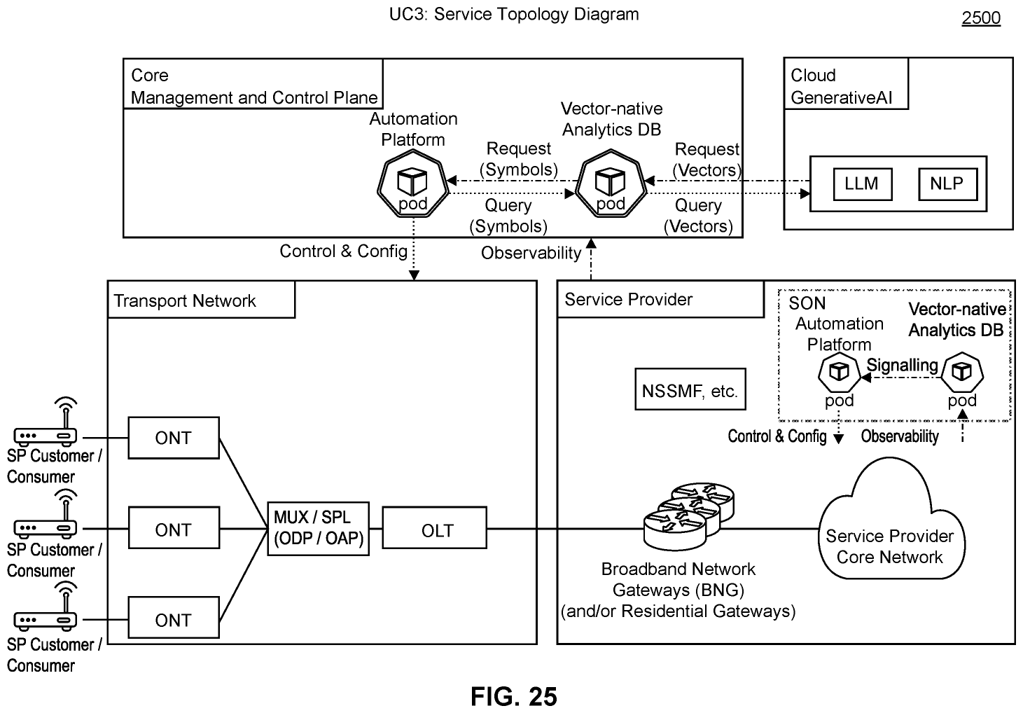

FIG. 25 is a block diagram of a service topology 2500 for using generative AI to design and order a physical Fibre Network, according to some embodiments.

The use-case is implemented across two locations (a Transport Network and a Service Provider), connected via a physical Fiber line. Each location exposes North Bound Interfaces for their configuration/control.

The Service Provider hosts Broadband Network Gateways (BNGs) the expose the Service Provider Core Network via Fibre. Optionally, it may also host an Enterprise Web-based SON for local optimization, and components such as NSSMFs to manage 5G slicing if it is to be exposed from the customer site.

The Transport Network consists of an OLT element (a physical Fibre receiving component connected to the BNG endpoint at the Service Provider), a MUX/SPL element (a physical Fibre splitting component to partition the Fibre channel) and one or more ONT elements (physical Fibre components to provide the “last mile” connection to each customer) connected to Customers/Consumer (i.e., businesses or home based connections).

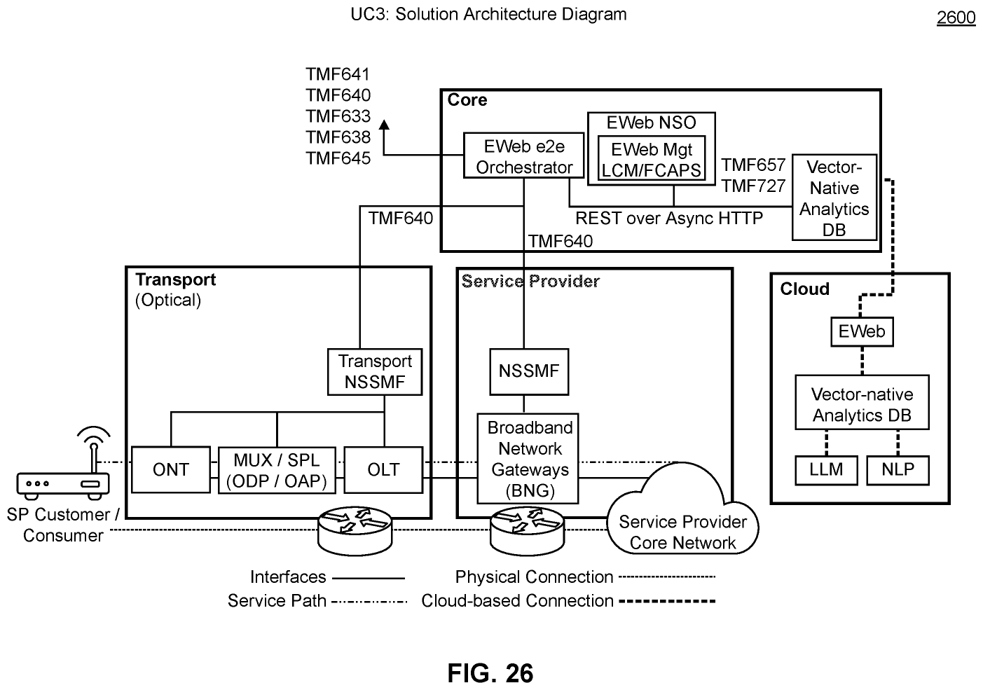

FIG. 26 is a block diagram of a solution architecture 2600 for using generative AI to design and order a physical Fibre Network, according to some embodiments. This diagram provides a detailed view of the Service Topology (FIG. 25), showing concrete components, their sub-components, connections and the standards based interfaces they expose and consume.

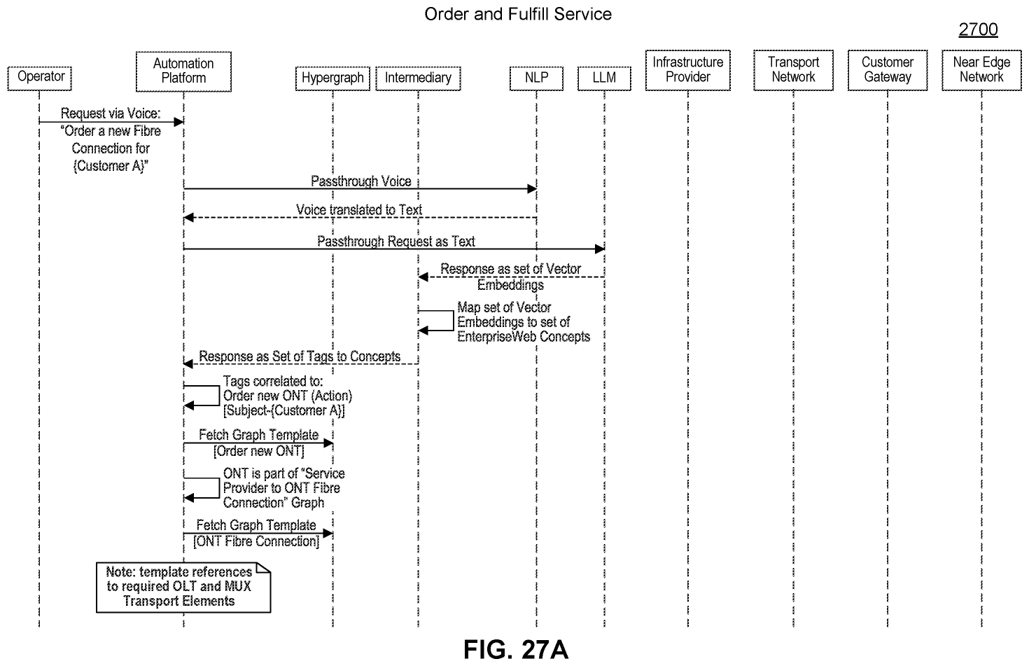

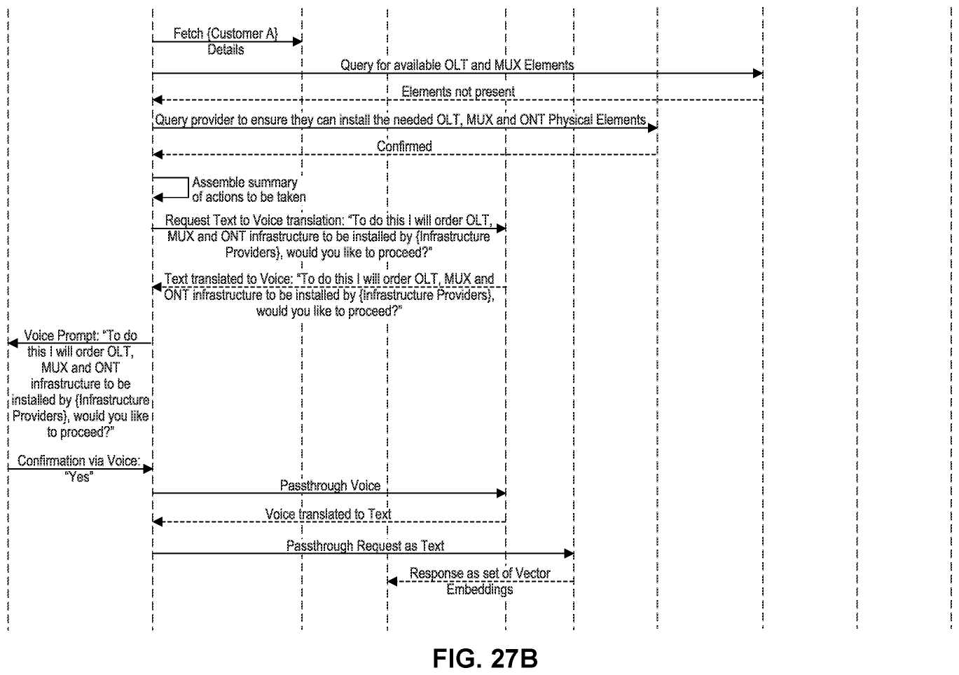

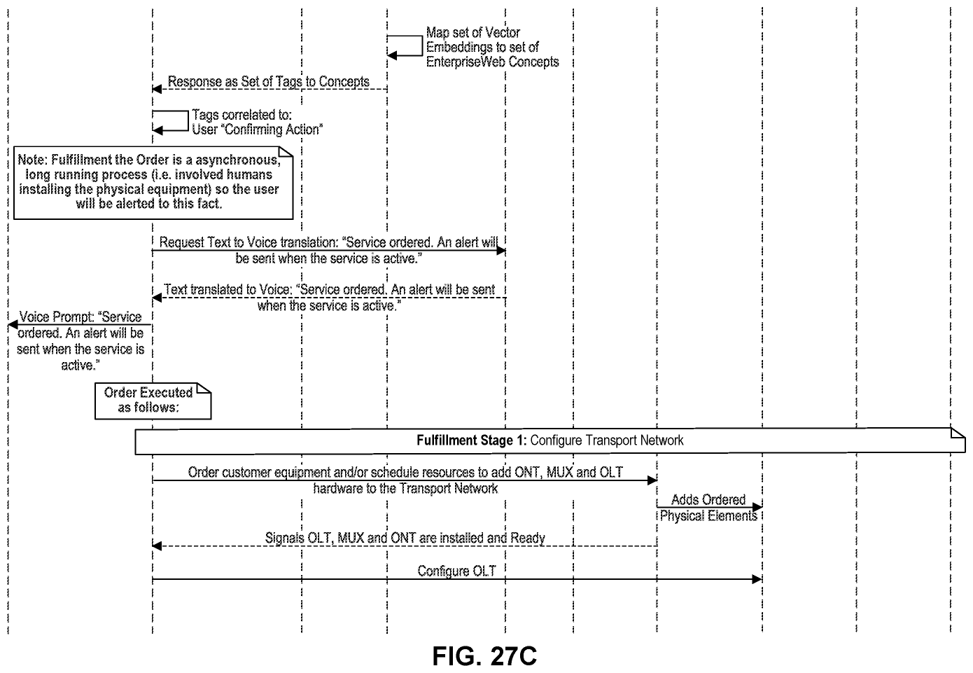

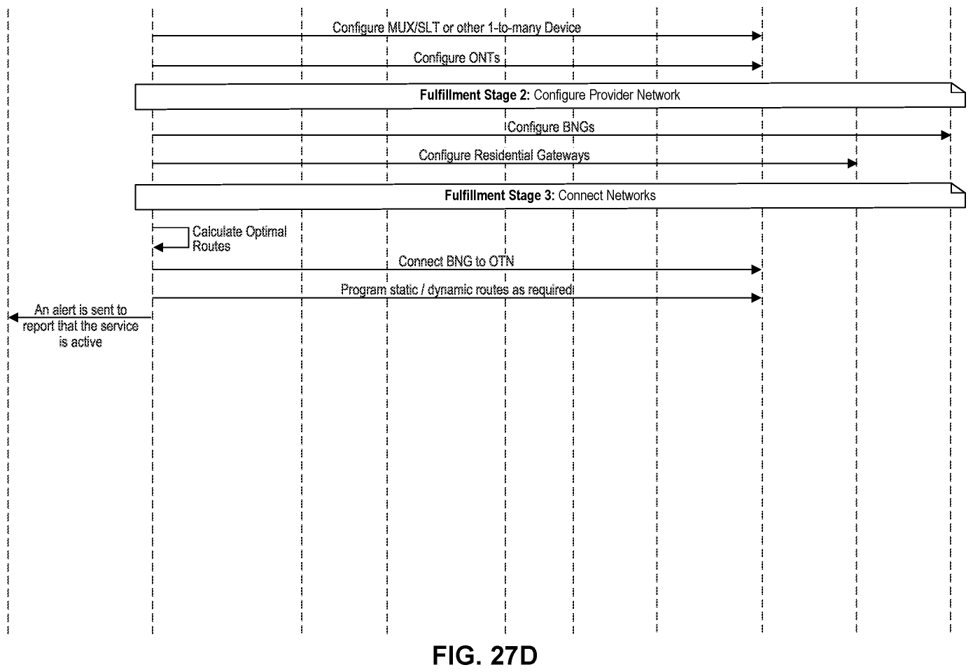

FIGS. 27A-27D illustrate method 2700 for performing an order and fulfil service, according to some embodiments. Method 2700 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 27, as will be understood by a person of ordinary skill in the art(s).

This activity involves a user, working for an Operator, ordering a new Fibre connection for a Customer (business or consumer). In response, the system determines the required optical physical network element required to establish the service, confirms with the user, orders all missing and required elements from an infrastructure provider, completes configuration of the service and sends a notification to the user.

Ordering starts with a voice command from the user, “Order a new Fibre Connection for {Customer A}”. The system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to EnterpriseWeb, which traverses its ontology to identify a corresponding graph, selecting a “Order new ONT” action template from the Hypergraph. Further, context from the request (Subject=“{Customer A}”) is injected into the action. Per the canonical method, if additional context is required the system or some other interaction is required it would be handled at this point before the action is executed. In this case, ONTs are determined to be part of a larger service connection graph (a “Service Provider to ONT Fibre Connection”), so that graph is also fetched from the Hypergraph. The ONT Fibre Graph requires additional elements (OLT and MUX). Enterprise Web fetches {Customer A} details from the Hypergraph to determine if additional context is needed. There is no record of such components existing, so Enterprise Web queries the Transport Network (i.e., external environment) for this additional system state, and finds the elements are not present and so much also be ordered. The original ordering action requires physical elements to installed by an Infrastructure Provider, so they are queried by Enterprise Web to see if they can install the required elements. When they confirm the order, all the information (context and state) required to respond to the user is present, so the system sends a message, “To do this I will order OLT, MUX and ONT infrastructure to be installed by {Infrastructure Providers}, would you like to proceed?” through the Intermediary to the NLP, where the message is converted to voice which is then relayed (spoken) to the user as a prompt.

The user responds by voice, “Yes”. The response is decoded and confirmed via the Intermediary NLP and LLM interactions as described above. Once the operation is confirmed, the previously identified “Order New ONT” process will be carried out in a series of 3 automated stages by the system.

First, the system executes Fulfillment Stage 1: “Configure Transport Network”. It sends an order to the Infrastructure Provider for the customer equipment and/or to schedule resources to add an ONT, MUX and OLT to the transport network. The Infrastructure performs the work required on the Transport Network and signals the system when complete (note: this is a long running, asynchronous process, so may take days). At the point or receiving confirmation the physical work is complete, the system resumes Stage 1 and Configures the OLT, MUX and ONT to provide the service.

Next, the system executes Fulfillment Stage 2: “Configure Provider Network”. It sends commands to the Service Provider's Near Edge Network to configure any related BNGs, and commands to the Service Provider's Customer Gateway to configure any related residential gateways.

Finally, the system executes Fulfillment Stage 3: “Connect Network”. It first calculates optimal routes through the transport. Next it issues a command to the Transport Network to connect the BNG in the Service Provider's Near Edge Network to the OTN. And finally, it programs the Transport Network, via its exposed interfaces, with the calculated static and dynamic routes to complete all required connections.

At this point, the service is established and a notification is sent by the system to the original user that the optical connection at the OLT is now available and ready.

### Use Case 4: Computer Vision Security

Use-case 4 (UC4) Computer Vision Security over a 5G Network, is the development and deployment an Industrial IoT App, for computer vision-based security. A set of physical cameras connect to a secure 5G slice, where they transmit video streams to a centralized application. As objects are detected in the feeds resources are scaled/optimized to handle the changing state of the IoT devices.

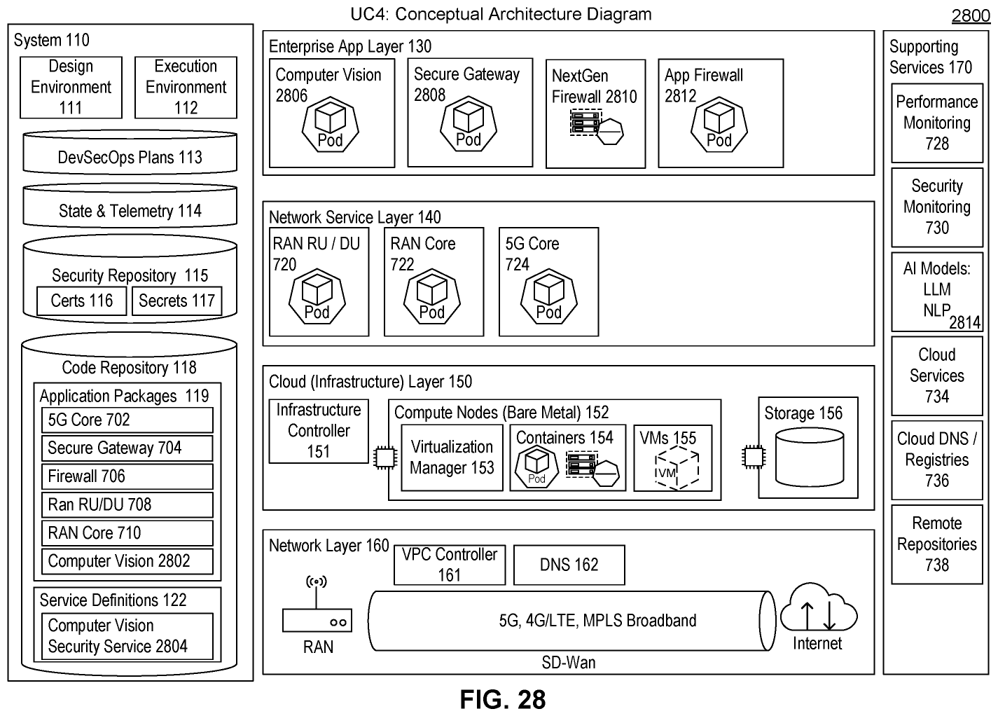

FIG. 28 is a block diagram of a conceptual architecture 2800 for developing and deploying an industrial IoT application for computer-vision-based security, according to some embodiments. Architecture 2800 may include system 110, design environment 111, execution environment 112, DevOps plans 113, state and telemetry 114, security repository 115, certificates 116, secrets 117, code repository 118, application packages 119, 5G core 702, secure gateway 704, firewall 706, RAN RU/DU 708, RAN core 710, computer vision 2802, service definitions 122, computer vision security service 2804, enterprise application layer 130, computer vision 2806, secure gateway 2808, NextGen firewall 2810, application firewall 2812, network service layer 140, RAN RU/DU 720, RAN core 722, 5G core 724, cloud layer 150, network layer 160, supporting services 170, performance monitoring 728, security monitoring 730, AI models 2812, cloud services 734, cloud DNS registries 736, and remote repositories 738.

The core service for the use-case is “Computer Vision Security”, the Service Definition and associated Application Packages are found in the Code Repo within the System.

At the Network Layer an SD-WAN is implemented via a VPC Controller with a linked DNS.

At the Cloud (Infrastructure) Layer an Infrastructure Controller provides an interface to multiple Compute Nodes (Bare Metal servers) for each site involved in the use-case (Edge and Core) and to attached Storage. Compute Nodes have a Virtualization Manager present to support the execution of Container-based applications (containers/pods) and VM-based applications. Also, the Compute Nodes provide a programming interface for their hardware (NIC-Network Interface Controllers) so that they can be optimized for the applications running on them.

At the Network Service Layer the core-network service consists of a “RAN RU/DU” (Radio Access Network Radio Unit/Distributed Unit), a “RAN Core” (Radio Access Network Core), and a “5G Core” which together provide the end-to-end 5G connectivity for connected devices. A “Virtual Probe” is also deployed for monitoring. All components are running over containers on the Compute Nodes, and Application Packages for each are found in the Code Repository.

At the Enterprise App Layer a “Computer Vision” application is deployed as a container, a “Secure Gateway” is deployed as a container, an “App Firewall” is deployed as a container, and a NextGen (NG) Firewall is deployed as a VM over containers, all on the Edge Compute node. Application Packages for each are found in the Code Repository.

Supporting Services for this use-case include centralized components for AI (NLP and LLM), Performance and Security Monitoring, a Traffic Generator, Cloud Services for service account creation, a Cloud DNS/Registry and Remote Repositories (for images).

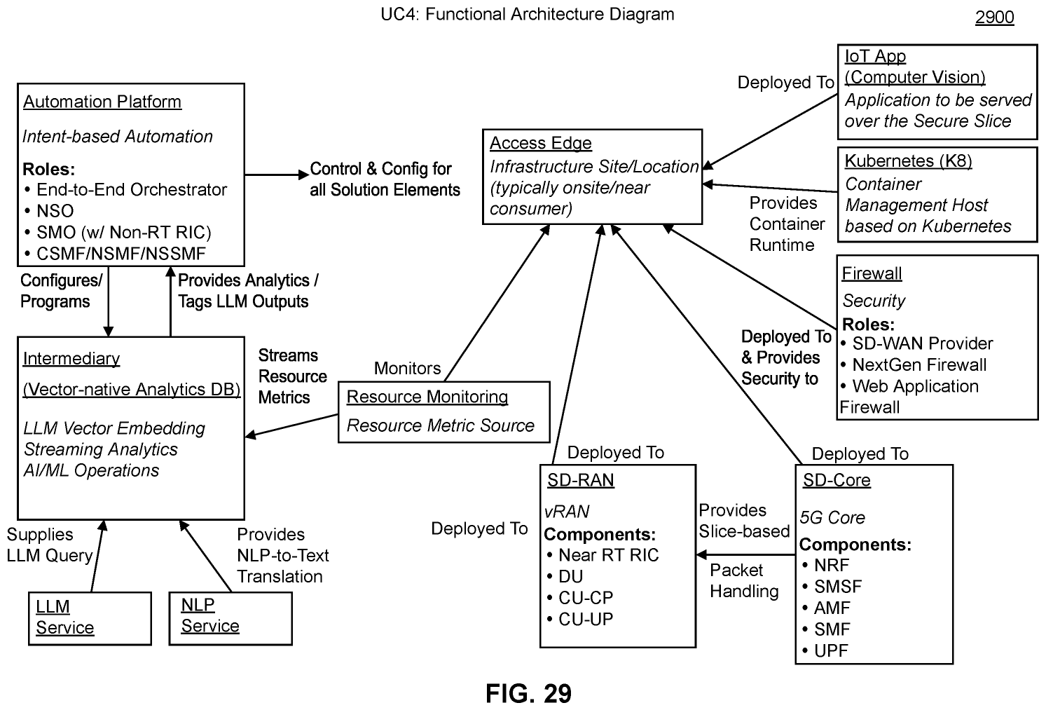

FIG. 29 is a block diagram of a functional architecture 2900 for developing and deploying an industrial IoT application for computer-vision-based security, according to some embodiments.

This diagram provides a high-level depiction of the main components found in the use-case solution, decomposed into main function description the main roles they play, components used to realize them, and the relationships between each.

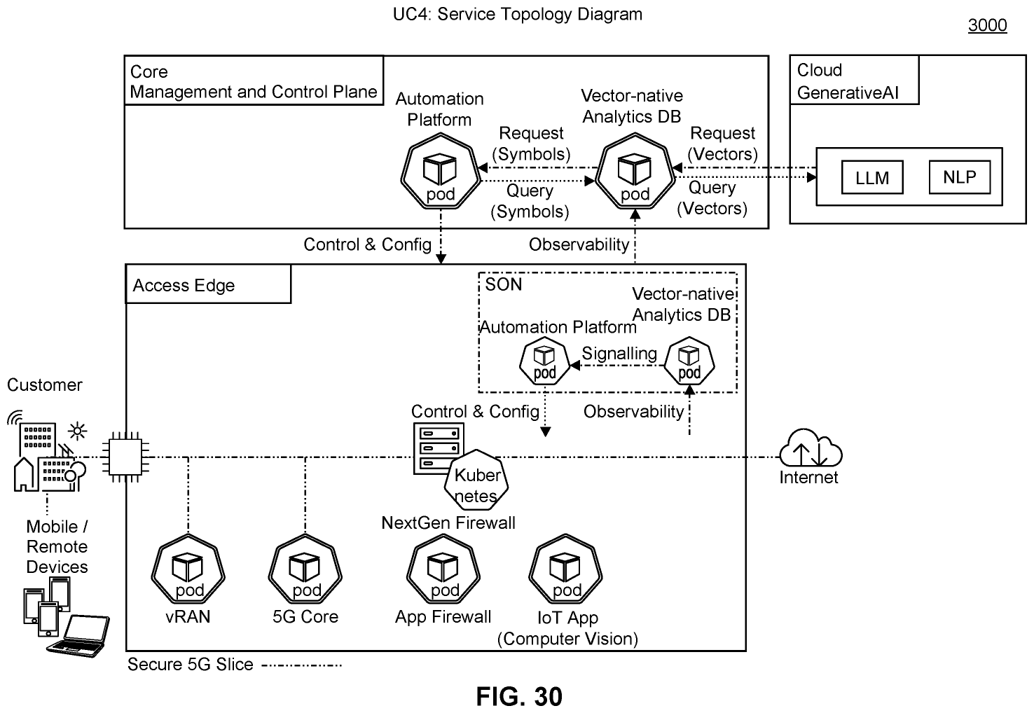

FIG. 30 is a block diagram of a service topology 3000 for developing and deploying an industrial IoT application for computer-vision-based security, according to some embodiments.

The use-case is implemented in an Edge Node connected to a RAN (Radio Access Network), and also connected to the Internet.

The Edge Node has containers/pods for the 5G Core and RAN Components, a VM over containers for the vFW (virtual Firewall) to deliver shared base functionality across all 5G slices; containers/pods per 5G slice for the Secure Gateway itself; containers/pods for probes that act as Resource and Security Monitors; and containers/pods for the Enterprise Web System deployed as an App Controller to execute the use-case. Finally, the code IoT App (Computer Vision) is deployed over containers/pods. Optionally, other Business Apps could also be deployed at the edge.

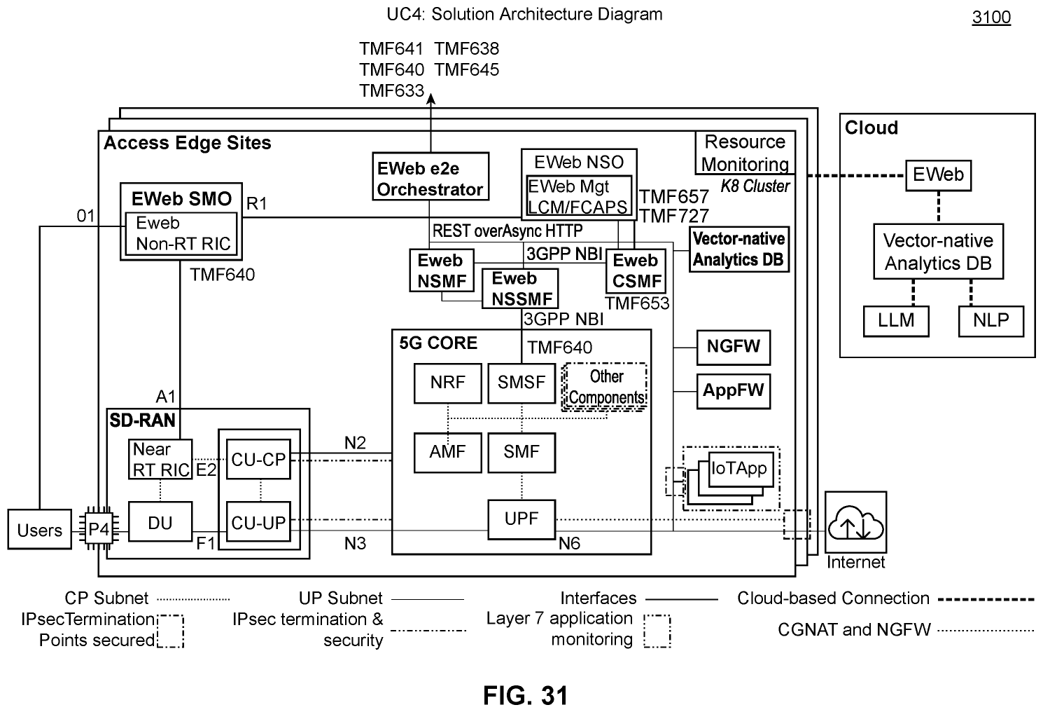

FIG. 31 is a block diagram of a solution architecture 3100 for developing and deploying an industrial IoT application for computer-vision-based security, according to some embodiments.

This diagram provides a detailed view of the Service Topology (FIG. 30), showing concrete components, their sub-components, connections and the standards based interfaces they expose and consume.

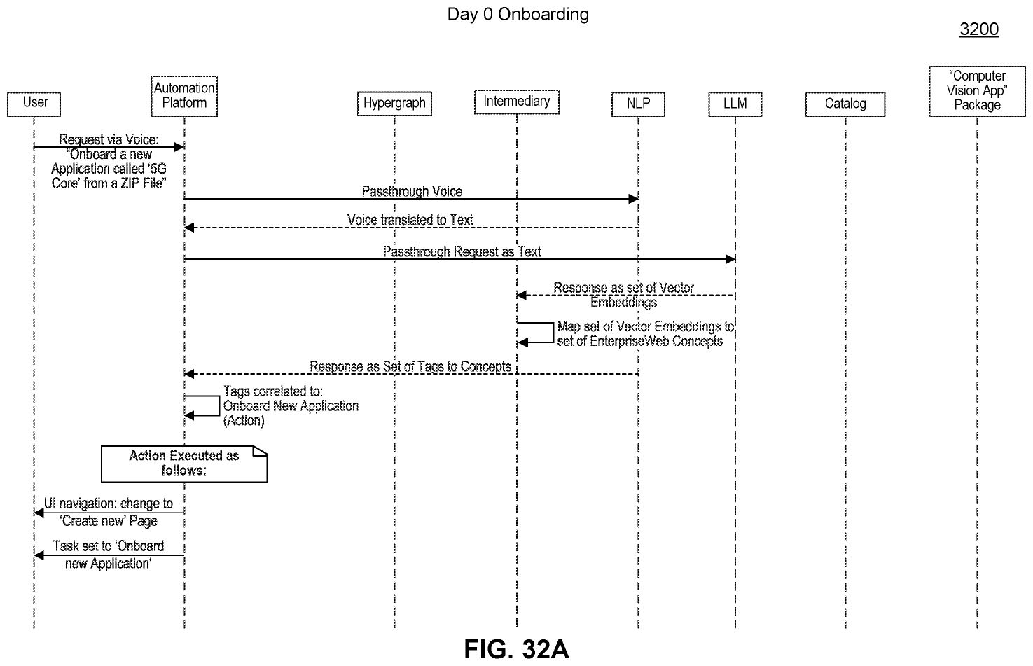

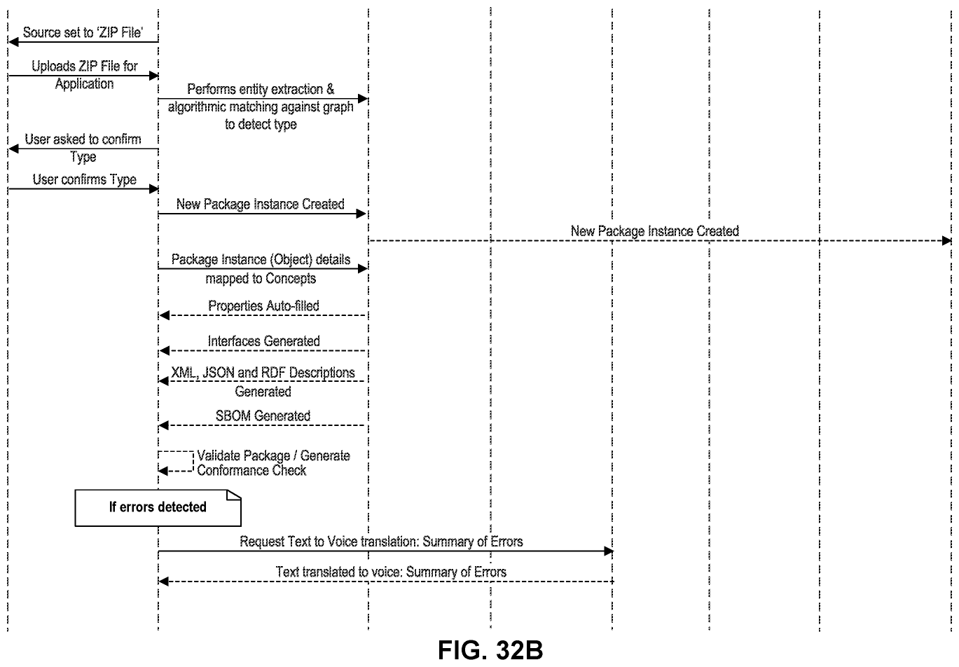

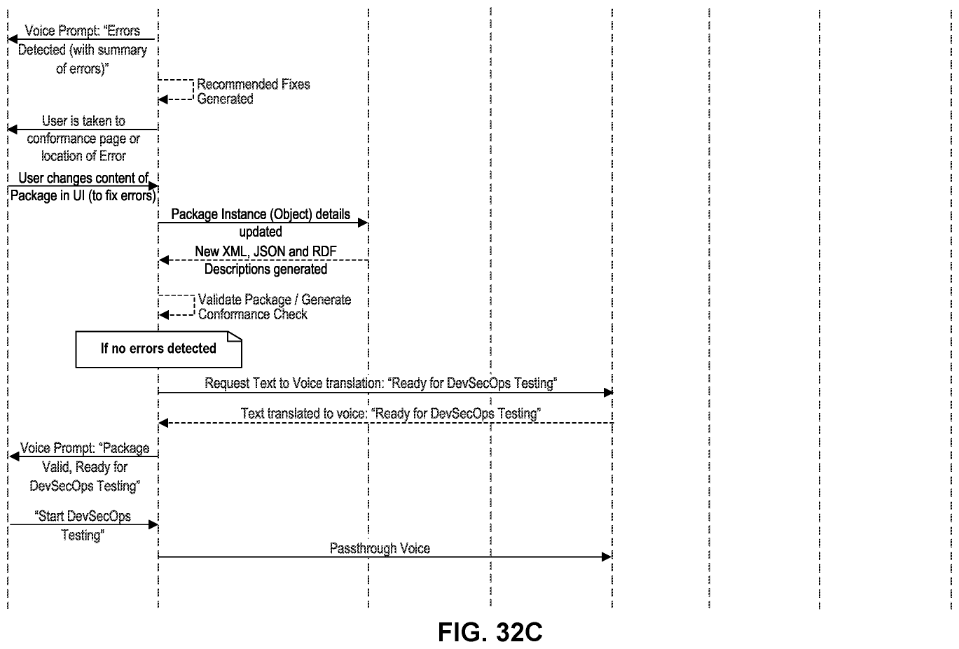

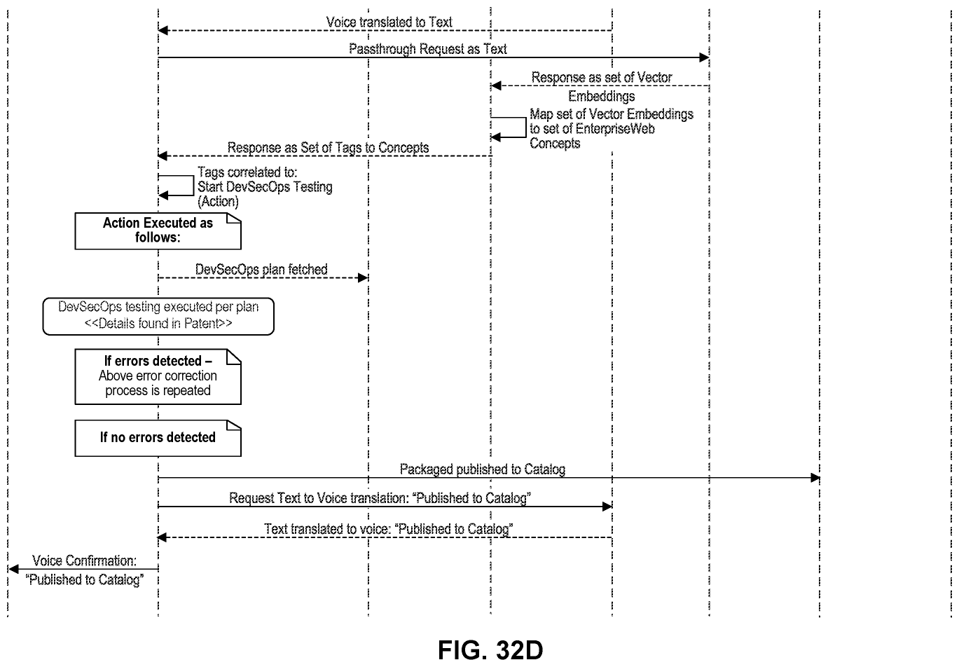

FIGS. 32A-32D illustrate method 3200 for performing Day 0 onboarding for developing and deploying an industrial IoT application for computer-vision-based security, according to some embodiments. Method 3200 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 32, as will be understood by a person of ordinary skill in the art(s).

Day 0 Onboarding involves an Application Developer/Engineer (or Service Designer) modeling Application Packages for each solution element to be deployed, integrated and configured in the implementation of the overall Network Service model. Note: this is not development of the application(s), this the creation of models for utilizing developed code compiled into a container/VM image, binary, scripts or some other set of artifacts which carry out the execution, which were developed outside the context of the system.

Onboarding starts with a voice command from the user, “Onboard a new Application called ‘Computer Vision App’ from a ZIP File”. The system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to Enterprise Web, which traverses its ontology to identify a corresponding graph, selecting an “Onboard New Application” action template from the Hypergraph. Per the canonical method, if additional context is required the system or some other interaction is required it would be handled at this point before the action is executed. Since the action is atomic and direct, it is executed immediately by the platform: UI navigation takes the User to the “Create new” page in their browser, the Task to be performed is set to “Onboard new Application”, and the type of source to import is set to “ZIP File”. This is an example of the system performing RPA (Robotic Process Automation) in response to a user-command.

The user will then upload a ZIP file containing application related artifacts (such as CNFD (Container Network Function Descriptors), YAML config files, etc.). The system performs entity extraction and algorithm matching against its Hypergraph to determine a type. The user is presented with a dialog to confirm the type. After confirming the type the system creates a new Package Instance in the Hypergraph for the “Computer Vision App”, maps instance (object) details to the Concepts in the Ontology, and then uses the mapping to auto-fill properties, generated standards based interfaces, generate XML, JSON and RDF descriptors and an SBOM file (collectively, a set of supporting artifacts that may be directly useful to a developer).

From here the system proceeds to guide the user through a conformance/error correction process. First, the system validates the package. If errors are detected, the system generates a set of error message, which it then passes through the Intermediary to the NLP, where the message is converted to voice which is then relayed (spoken) to the user. At the same time, the system generates a set of recommended fixes, and uses an RPA process to direct the user to the conformance page or location of the errors they need to correct.

As the user makes changes to the Application Package model in the UI, package contents are updated in the hypergraph, supporting artifacts (XML, JSON and RDF descriptors and an SBOM file) are regenerated, and the package is once again conformance checked. If errors remain, or new errors are introduced, the same guided conformance/error correction loop is repeated until the Application Package model is complete and valid.

Once valid, the system sends a message, “Ready for DevSecOps Testing” through the Intermediary to the NLP, where the message is converted to voice which is then relayed (spoken) to the user.

The user can then say “Start DevSecOpsTesting” (or initiate via the UI). Which system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by EnterpriseWeb, to convert the request to vector embeddings, prompt the LLM for an interpretation, and then convert the LLM output to a set of tags (corresponding to EnterpriseWeb concepts) which can then act as mediated/deterministic inputs to the platform. The Intermediary returns these tags to Enterprise Web, which traverses its ontology to identify a corresponding graph, selecting the “Start DevSecOps Testing” action template from the Hypergraph. Per the canonical method, if additional context is required the system or some other interaction is required it would be handled at this point before the action is executed. Since the action is atomic and direct, it is executed immediately by the platform. First, the platform fetches the associated DevSecOps pipeline process model from the Hypergraph. It then performs the process. If errors are detected, the earlier guided conformance/error correction loop is repeated, and the Application Package is retested until no errors remain.

Once the Application Package passes DevSecOps testing, the system sends a message, “Published to Catalog” through the Intermediary to the NLP, where the message is converted to voice which is then relayed (spoken) to the user. The Application Package state is updated in the Hypergraph and added to the System Catalog.

The above process is repeated for all solution elements required by the service, and once all the solution elements are present in the catalog, and the network service can be composed.

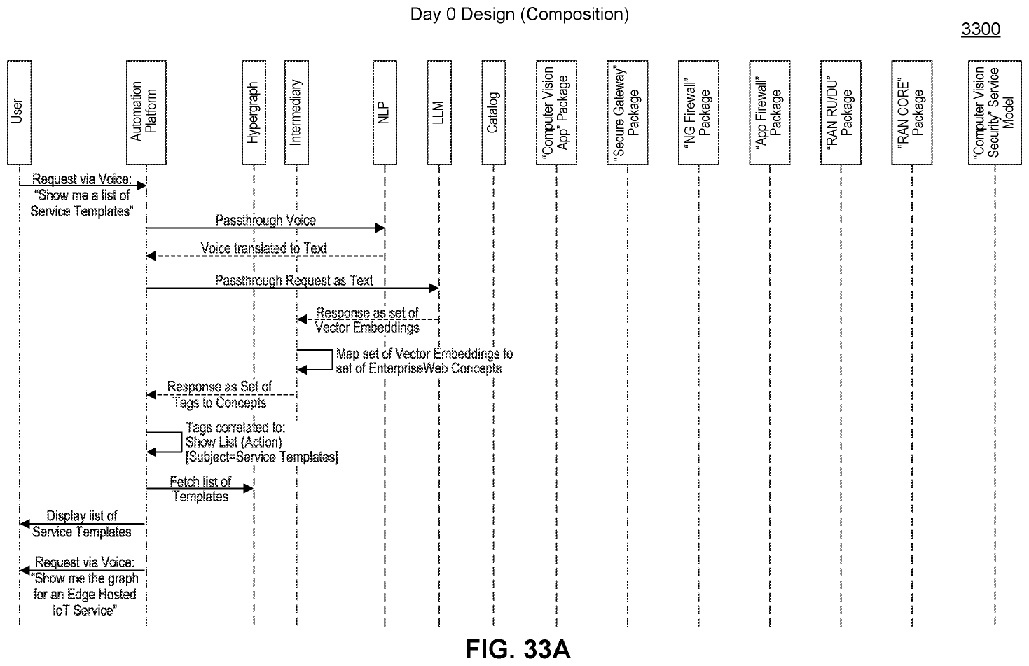

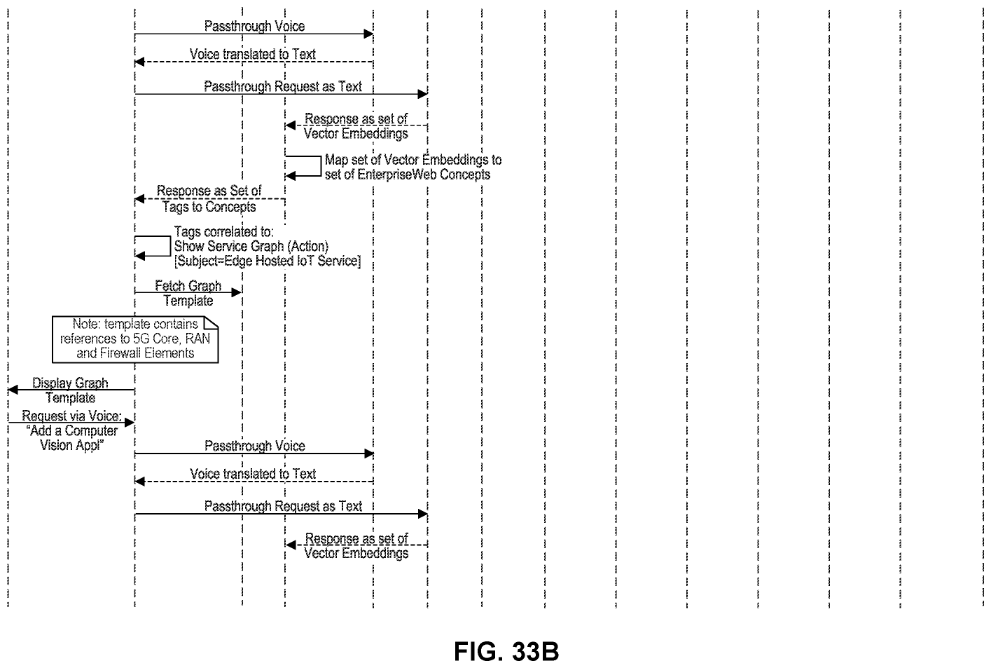

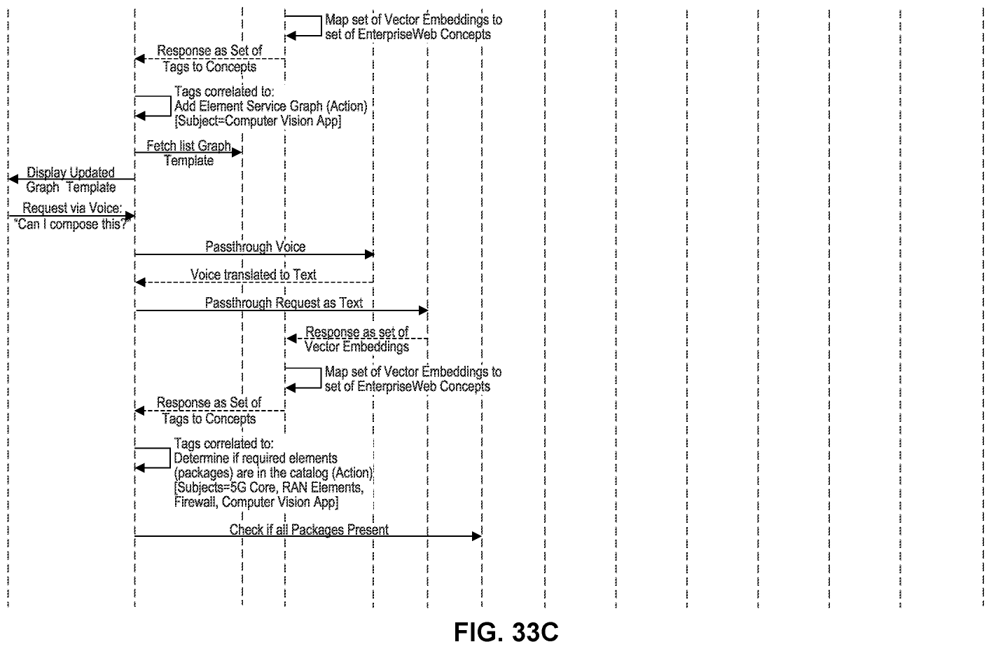

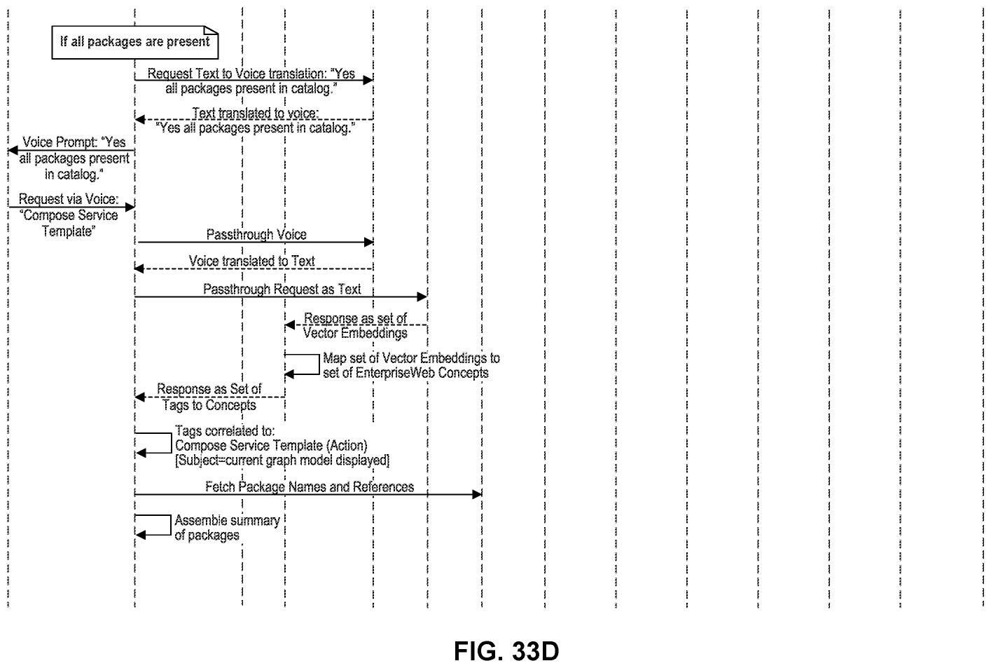

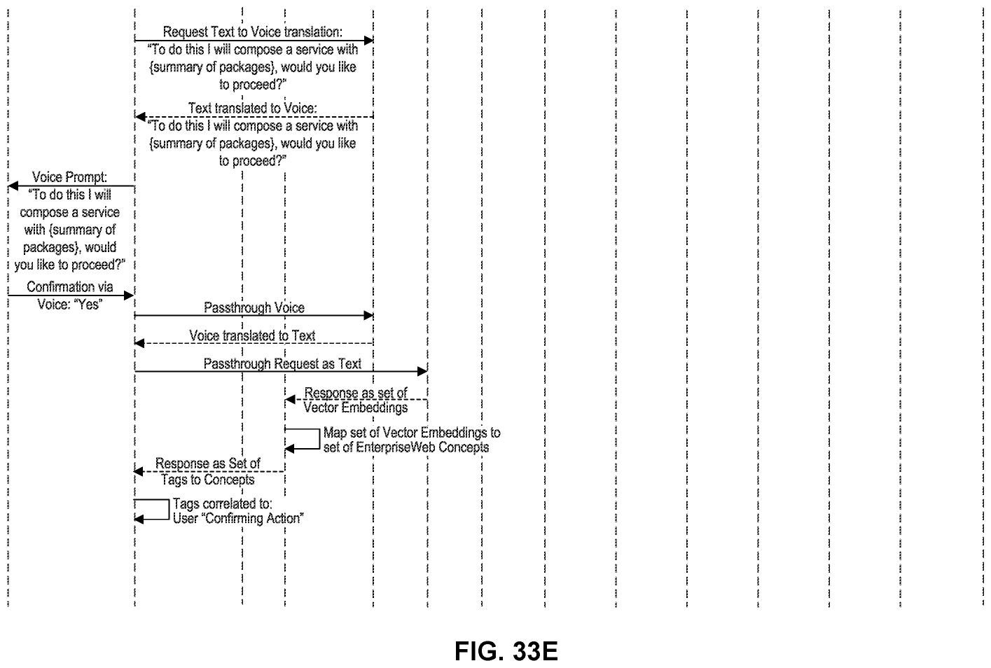

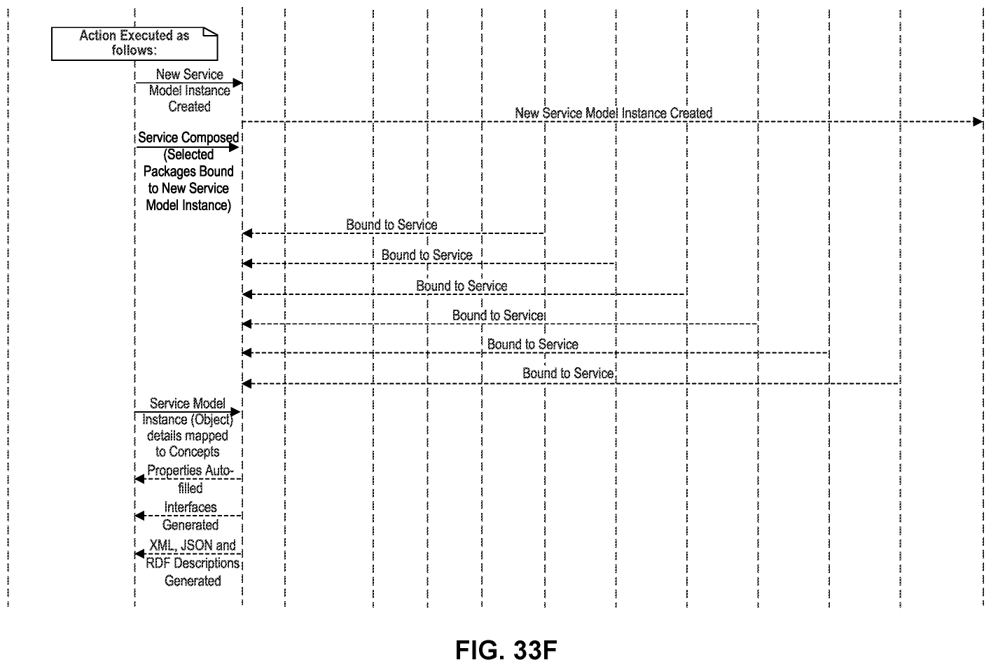

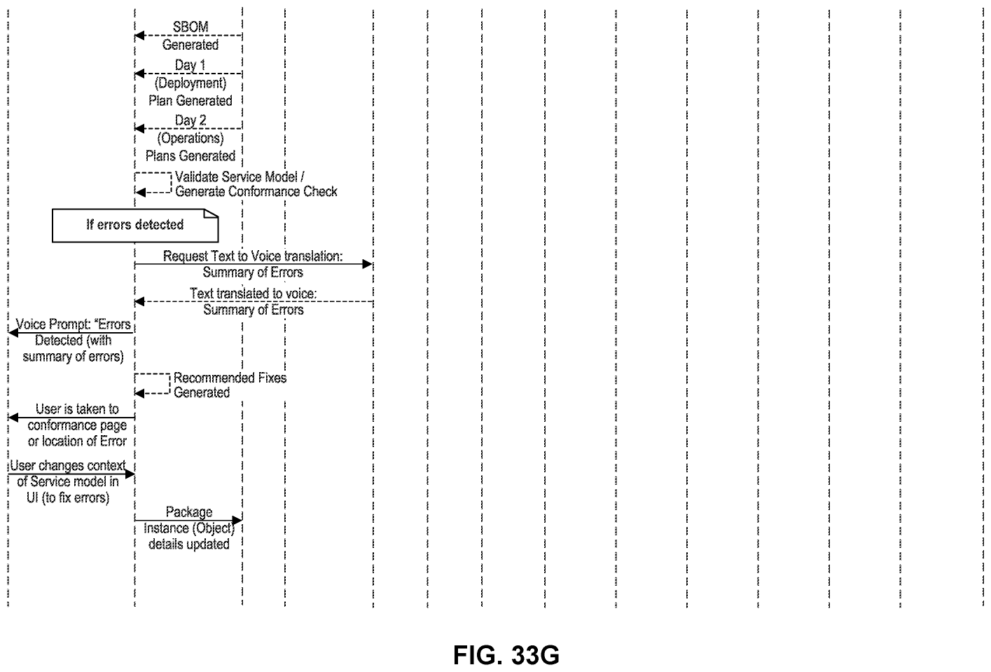

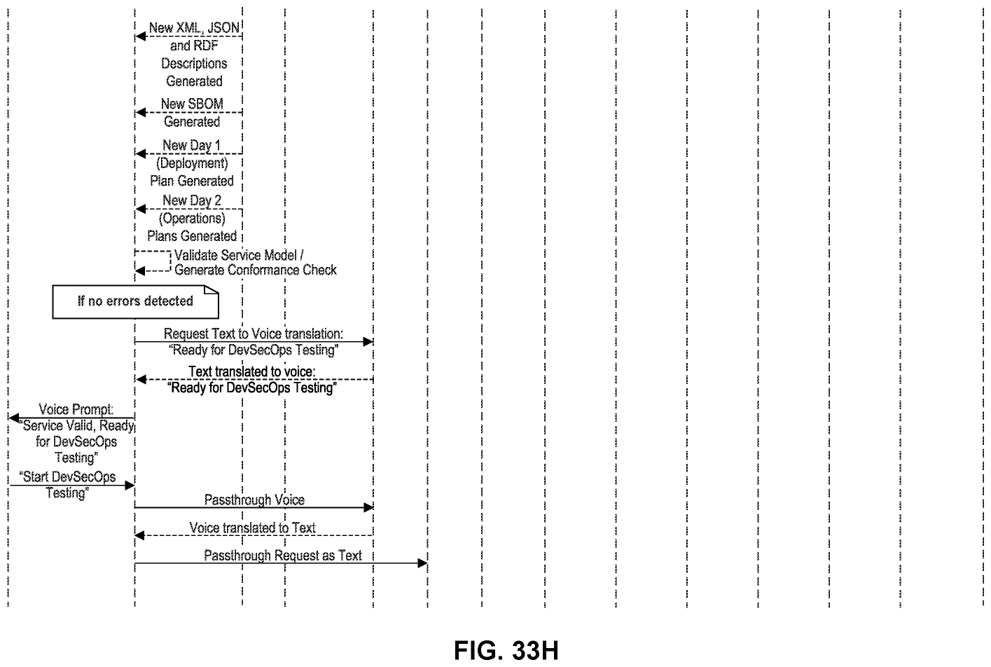

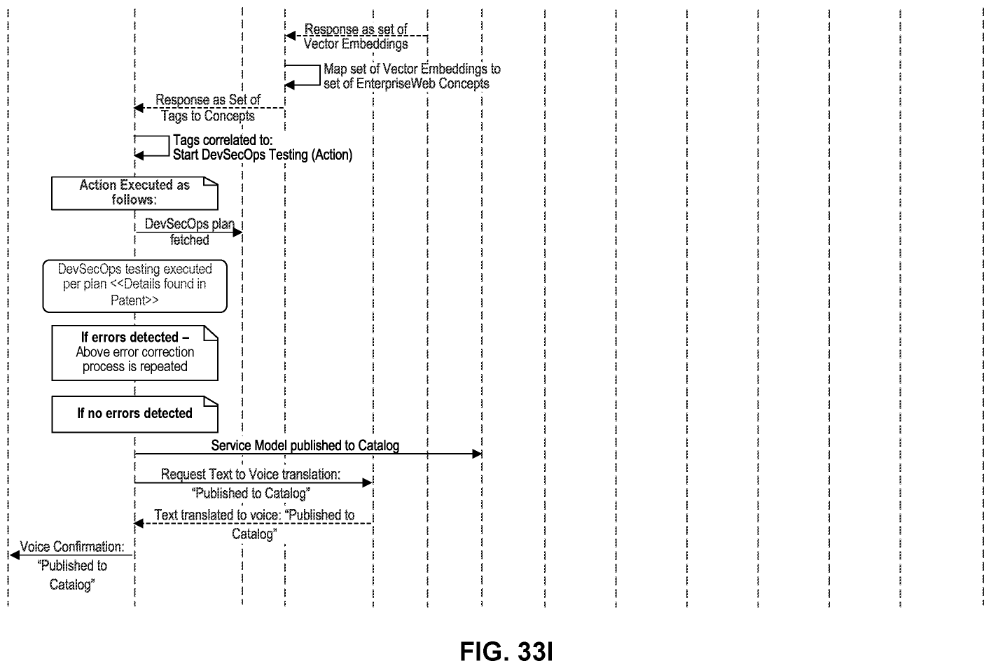

FIGS. 33A-33I illustrate method 3300 for performing Day 0 design for developing and deploying an industrial IoT application for computer-vision-based security, according to some embodiments. Method 3300 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 33, as will be understood by a person of ordinary skill in the art(s).

Day 0 Design is a composition activity, it involves a Service Designer selecting Application Packages from the catalog, and specifying the connections between those and any supporting services to implement the overall Network Service model to be Deployed, Integrated and Configured on Day 1, and managed during Day 2 ongoing operations.

Composition starts with a voice command from the user, “Show me a list of Service Templates”. The system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by EnterpriseWeb, to convert the request to vector embeddings, prompt the LLM for an interpretation, and then convert the LLM output to a set of tags (corresponding to EnterpriseWeb concepts) which can then act as mediated/deterministic inputs to the platform. The Intermediary returns these tags to Enterprise Web, which traverses its ontology to identify a corresponding graph, selecting a “Show List” action template from the Hypergraph. Further, context from the request (Subject=“Service Templates”) is injected into the action. Per the canonical method, if additional context is required the system or some other interaction is required it would be handled at this point before the action is executed. Since the action is atomic and direct, it is executed immediately by the platform: a dialog is rendered in the browser showing a list of all Service Templates available inside the Hypergraph. This is an example of the system performing RPA (Robotic Process Automation) in response to a user-command.

The user then identifies the templates they want to use as a starting point, and issues another voice command, “Show me the graph for an Edge Hosted IoT Service”. The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to EnterpriseWeb, which traverses its ontology to identify a corresponding graph, selecting an “Show Service Graph” action template from the Hypergraph. Further, context from the request (Subject=“Edge Hosted IoT Service”) is injected into the action. Per the canonical method, if additional context is required the system or some other interaction is required it would be handled at this point before the action is executed. Since the action is atomic and direct, it is executed immediately by the platform: a dialog is rendered in the browser showing a network (connection) graph for the service (including 5G Core, RAN and Firewall elements) as fetched from the Hypergraph. This is another example of the system performing RPA (Robotic Process Automation) in response to a user-command.

The user examines the rendered graph for the service, and notices they need to add additional components. They issue another voice command, “Add a Computer Vision App”. The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to Enterprise Web, which traverses its ontology to identify a corresponding graph, selecting an “Add Element to Service Graph” action template from the Hypergraph. Further, context from the request (Subject=“Firewall”) is injected into the action. Per the canonical method, if additional context is required the system or some other interaction is required it would be handled at this point before the action is executed. Since the action is atomic and direct, it is executed immediately by the platform: the graph is updated with the Firewall element fetched from the Hypergraph, and the rendering in the browser showing the network (connection) graph is update. This is another example of the system performing RPA (Robotic Process Automation) in response to a user-command.

Once more, the user examines the rendered graph for the service, this time they notice the graph is complete. They query the system via voice, “Can I compose this?”. The voice based query is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to Enterprise Web, which traverses its ontology to identify a corresponding graph, selecting an “Determine if required elements (packages) are in the catalog” action template from the Hypergraph. Further, context from the request (Subject=<<The elements displayed in the graph on the screen=5G Core, RAN, Firewall, Computer Vision App>>) is injected into the action. Per the canonical method, if additional context is required the system or some other interaction is required it would be handled at this point before the action is executed. Since the action is atomic and direct, it is executed immediately by the platform: system Catalog (by way of the Hypergraph) is examined to see if there are Published Application Packages for each required element. This is an example of a complex, context driven query. The system finds all required packages, so the system sends a message, “Yes all packages present in the catalog” through the Intermediary to the NLP, where the message is converted to voice which is then relayed (spoken) to the user.

In response to the query, the user decides to go ahead with building the service, and issues the following command to the system via voice, “Compose Service Template”. The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to EnterpriseWeb concepts) which can then act as mediated/deterministic inputs to the platform. The Intermediary returns these tags to Enterprise Web, which traverses its ontology to identify a corresponding graph, selecting an “Compose Service Template” action template from the Hypergraph. Further, context from the request (Subject=<<the graph on the screen, Type=Edge Hosted IoT Service, Elements=5G Core, RAN, Firewall, Computer Vision App>>) is injected into the action. Per the canonical method, if additional context is required the system or some other interaction is required it would be handled at this point before the action is executed. Even if no additional user context is required, an interaction with the user still needs to take place, since this operation will update system state (i.e., by creating a composing service template per the user's command) it needs to be confirmed. To do this, the system needs to summary the command, so the system fetches the names and details of each related Application Package from the catalog. If more than one are available at this point, the user would be presented with options that help them make the selection. In this case, we assume each element has a one-to-one mapping with Application Packages in the Catalog. Those names and details are assembled into a summary of the Service Template to be composed, it sends that summary through the Intermediary to the NLP, where the message is converted to voice which is then relayed (spoken) to the user, along with a request for the confirmation (i.e., “Would you like to proceed?”).

The user responds by voice, “Yes”. The response is decoded and confirmed via the Intermediary NLP and LLM interactions as described above. Once the operation is confirmed, the previously identified action “Compose Service Template” is executed by the system. First it creates a new Service Template Instance in the Hypergraph, then binds each selected Application Package to the model completing the initial composition. The system then maps instance (object) details to the Concepts in the Ontology, and then uses the mapping to auto-fill properties, generated standards based interfaces, generate XML, JSON and RDF descriptors and an SBOM file (collectively, a set of supporting artifacts that may be directly useful to a developer), and a Day 1 Deployment plan and associated Day 2 Operation plans are generated.

From here the system proceeds to guide the user through a conformance/error correction process. First, the system validates the Service Template model. If errors are detected, the system generates a set of error message, which it then passes through the Intermediary to the NLP, where the message is converted to voice which is then relayed (spoken) to the user. At the same time, the system generates a set of recommended fixes, and uses an RPA process to direct the user to the conformance page or location of the errors they need to correct.

As the user makes changes to the Service Template model in the UI, service details are updated in the hypergraph, supporting artifacts (XML, JSON and RDF descriptors and an SBOM file) are regenerated, the Day 1 Deployment plan and any Day 2 Operation plans are regenerated, and the Service Template model is once again conformance checked. If errors remain, or new errors are introduced, the same guided conformance/error correction loop is repeated until the Service Template model is complete and valid.

Once valid, the system sends a message, “Ready for DevSecOps Testing” through the Intermediary to the NLP, where the message is converted to voice which is then relayed (spoken) to the user.

The user can then say “Start DevSecOpsTesting” (or initiate via the UI). Which system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by EnterpriseWeb, to convert the request to vector embeddings, prompt the LLM for an interpretation, and then convert the LLM output to a set of tags (corresponding to Enterprise Web concepts) which can then act as mediated/deterministic inputs to the platform. The Intermediary returns these tags to Enterprise Web, which traverses its ontology to identify a corresponding graph, selecting the “Start DevSecOps Testing” action template from the Hypergraph. Per the canonical method, if additional context is required the system or some other interaction is required it would be handled at this point before the action is executed. Since the action is atomic and direct, it is executed immediately by the platform. First, the platform fetches the associated DevSecOps pipeline process model from the Hypergraph. It then performs the process. If errors are detected, the earlier guided conformance/error correction loop is repeated, and the Service Template is retested until no errors remain.

Once the Service Template passes DevSecOps testing, the system sends a message, “Published to Catalog” through the Intermediary to the NLP, where the message is converted to voice which is then relayed (spoken) to the user. The Service Template state is updated in the Hypergraph and added to the System Catalog.

Once the Service Template is added to the catalog, it is available for instantiation (Day 1 Deployment).

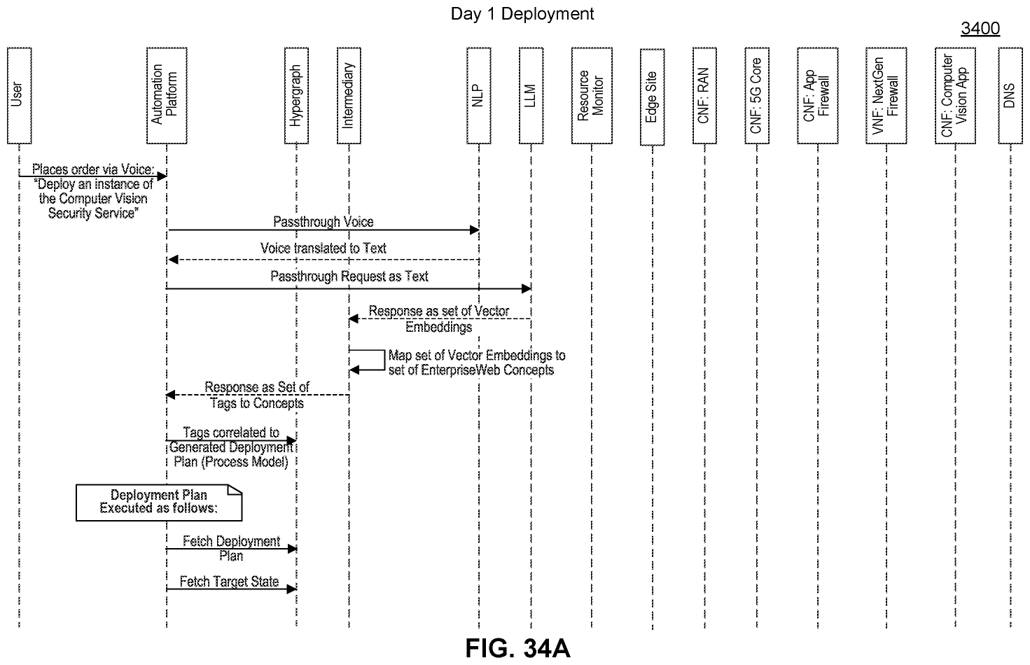

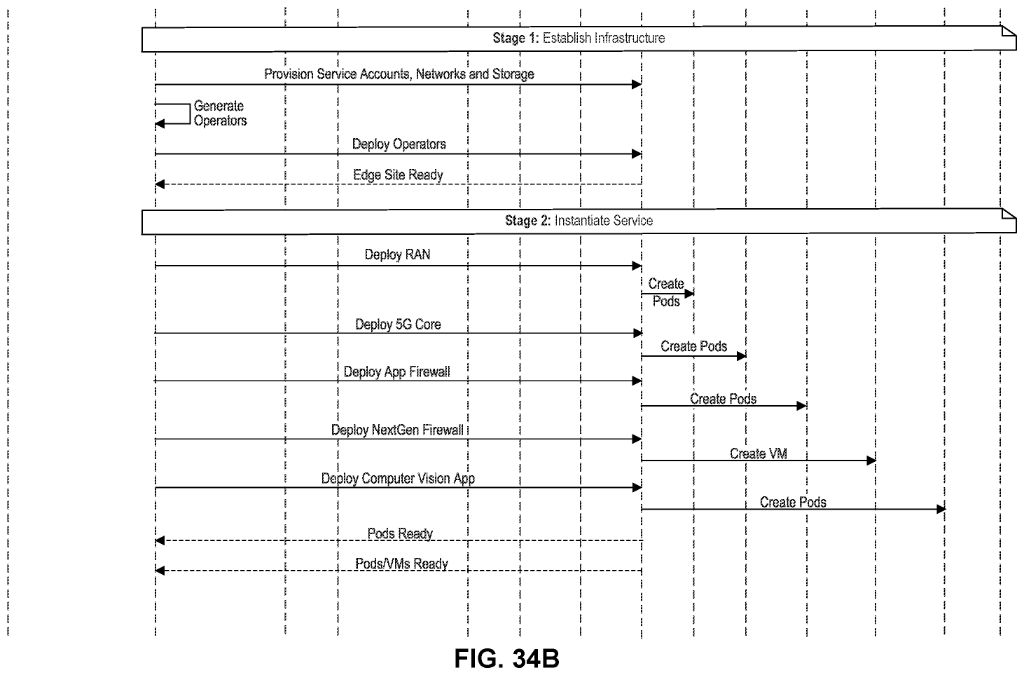

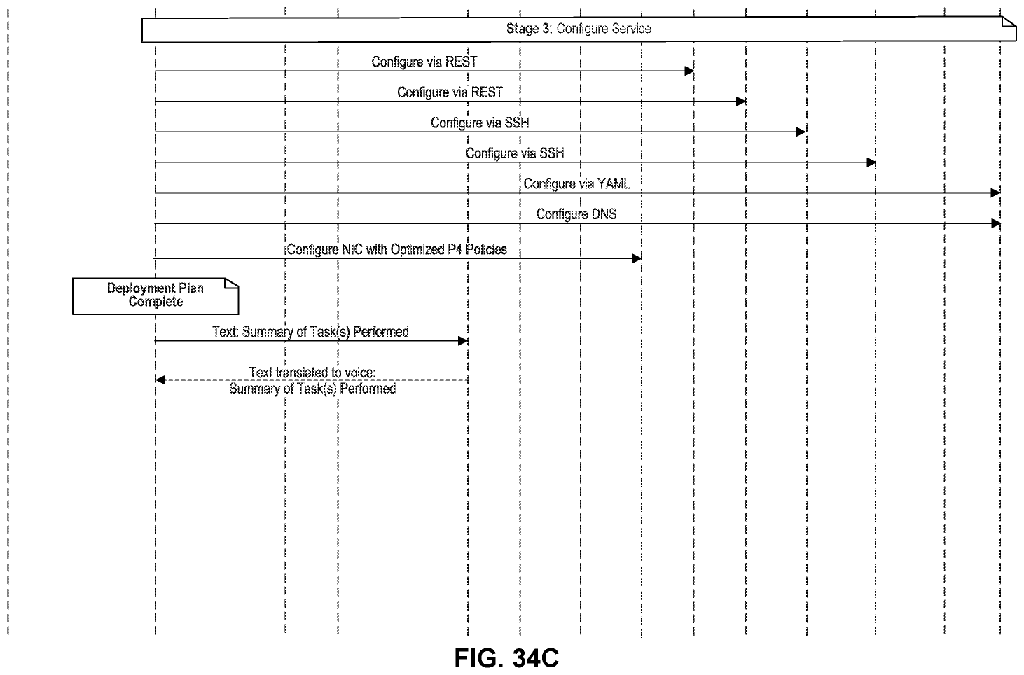

FIGS. 34A-34C illustrate method 3400 for performing day-one deployment for developing and deploying an industrial IoT application for computer-vision-based security, according to some embodiments. Method 3400 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 34, as will be understood by a person of ordinary skill in the art(s).

Day 1 Deployment starts with a voice command from the user, “Deploy an instance of the Computer Vision Security Service”. The system proceeds to interpret the request per the “EnterpriseWeb Canonical Method (applied to Voice-based GenAI Requests). The voice command is passed through an NLP model, by way of an Intermediary, to convert it to text. The textual representation of the request is then passed to the Intermediary, which is programmed by Enterprise Web, to convert the request to vector embeddings, prompt the LLM for an interpretation, and then convert the LLM output to a set of tags (corresponding to EnterpriseWeb concepts) which can then act as mediated/deterministic inputs to the platform. The Intermediary returns these tags to EnterpriseWeb, which traverses its ontology to identify a corresponding graph, selecting a “Day 1 Deployment Plan” template from the Hypergraph. Per the canonical method, if additional context is required the system or some other interaction is required it will be handled at this point before the Day 1 Process is executed.

Once the user intent is confirmed, the Day 1 process will be carried out in a series of 3 automated stages by the system.

First the system executes Stage 1: “Establish Infrastructure”. It first provisions service accounts, networks and storage in the Edge Site via available infrastructure controllers on that host. Next it generates Operators (software bundles) for the basic LCM operations involved in each Application Package to be deployed as part of the service. It then deploys the set of operators to the Edge Site.

Once the infrastructure is established, the system moves to Stage 2: “Initiate Services”. The system issues commands to deploy RAN, deploy 5G Core, App Firewall and Computer Vision App elements as pods, and to deploy a NextGen Firewall as a VM, on the Edge Site. Edge infrastructure controllers will then spin up required pods and VMs, and signal the system when complete.

Once the services are initiated, the system moves to Stage 3: “Configure Services”. The system configures the deployed RAN elements via a REST interface, the 5G Core elements via a REST interface, both firewalls using SSH interfaces, and the Computer Vision App via a YAML file. Finally the system updates related DNS entries and programs the NICs (network controls) found in the Edge Site hardware for optimized networking.

At this point, the service is deployed and active. A summary of tasks performed is sent through the Intermediary to the NLP which converts it to voice. The voice is then relayed (spoken) to the user to confirm completion of the task they requested (to deploy the service).

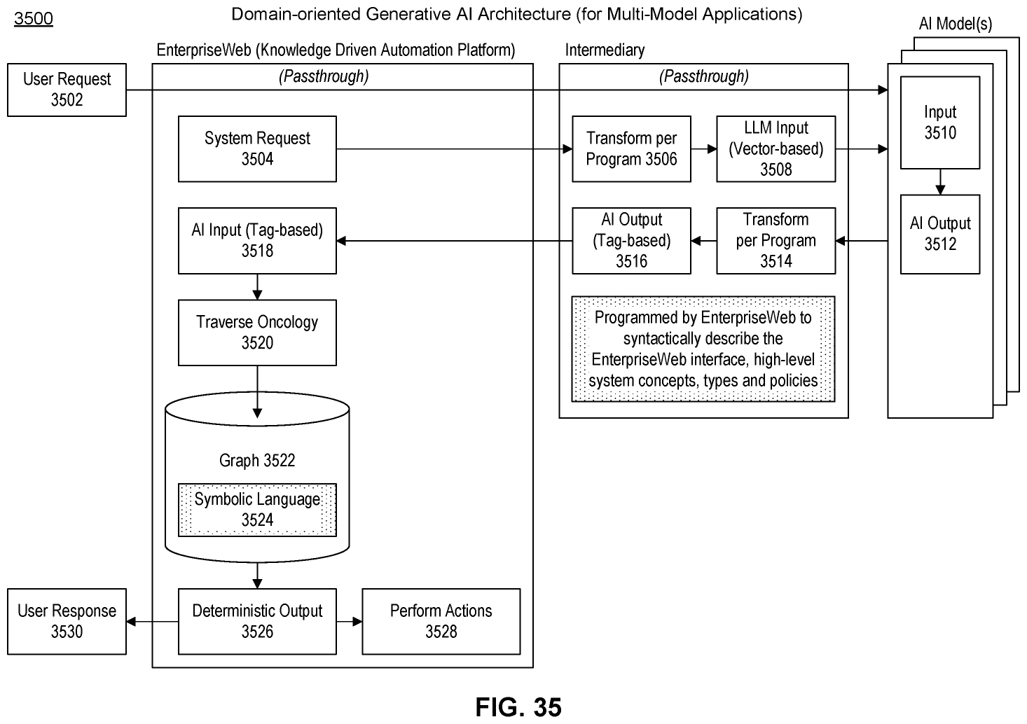

FIG. 35 is a block diagram of a domain-oriented generative AI architecture 3500 for multi-model applications, according to some embodiments.

This diagram depicts a high-level flow from request (User or System based) through one or more AI models, and how the architecture allows Enterprise Web to translate the output of the AI models based processes to deterministic results.

The architecture uses a vector-native database with a time-series analytics capability as an intermediary between each AI model and the knowledge-driven automation platform, providing a separation of concerns that isolates and contains the use of each AI model so that they never directly communicate with the automation system.

Enterprise Web programs the intermediary to translate between the language of the AI model and the symbolic language of its knowledge-based automation platform. The program syntactically describes EnterpriseWeb's interface, high-level system concepts, types and policies, which get flattened to embeddings or a similar vector-based (or probability-based) representation native to the AI, so the intermediary can mediate communications between each AI model and EnterpriseWeb. In addition, EnterpriseWeb's program semantically describes high-level domain concepts, types and policies so the intermediary can tag outbound Enterprise Web embeddings and prompts and inbound AI outputs.

Enterprise Web uses the tags on AI outputs inbound from the intermediary to bootstrap traversal of an ontology. The tags provide mappings back to EnterpriseWeb's graph; the mappings to the domain concepts, types and policies allow EnterpriseWeb to efficiently and deterministically translate LLM outputs. Determinism ensures accurate, consistent, explainable system responses that in turn support safe, contextual actions with strong IT governance.

The flow starts with either a “User Request” or a “System Request”. In the case of a “User Request” the data is passed through EnterpriseWeb and the Intermediary to the AI model directly. In the case of a “System Request”, since it will consist of Symbolic Terms from the Enterprise Web ontology, it will be transformed by the Intermediary into a vector-based or probability-based Input which is added to the AI request. In all cases, the AI Output, which is probabilistic in nature, will be passed to the Intermediary which translates it to a tag-based form, which can be syntactically understood by the platform. The intermediary then passes this result as a Tagged-based “AI Input” to the platform, which uses the tags to traverse its ontology. This traversal contextualizes the response and converts it to one, and only one, deterministic output. That output is then returned as a “User Response” or used to perform subsequent actions by the platform.

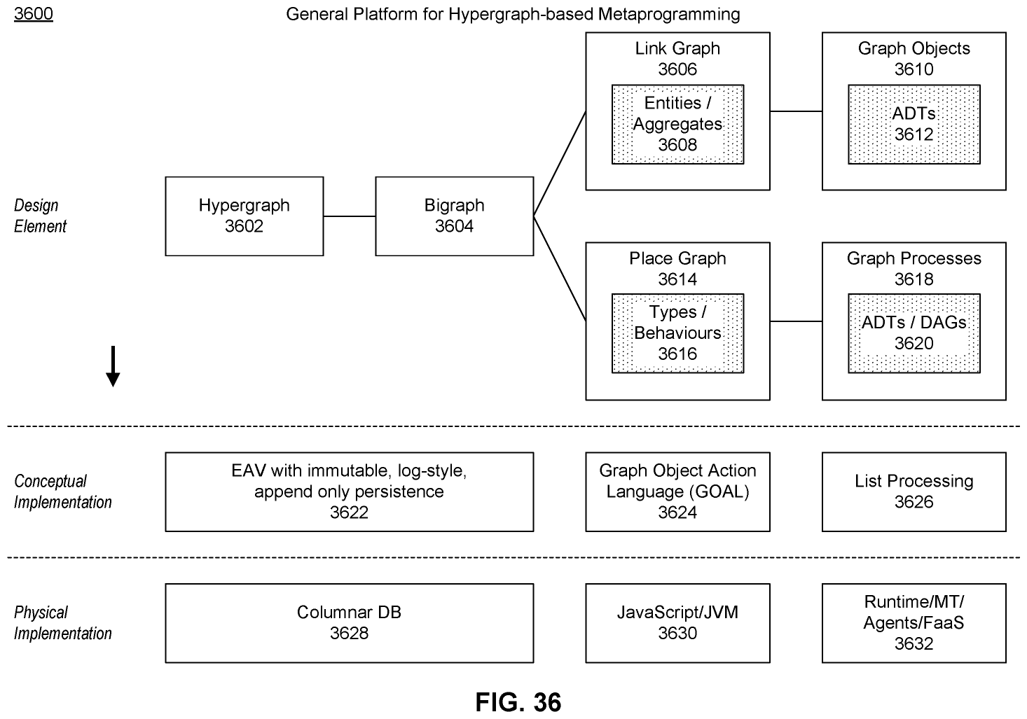

FIG. 36 is a block diagram of a general platform 3600 for hypergraph-based metaprogramming, according to some embodiments.

The diagram breaks down the design decisions and affordances realized in the architecture to deliver a real-time intelligent automation for complex, adaptive, distributed systems. Graph Object Action Language (GOAL) represents a language-based approach to modeling and processing complex objects with contracts that are composable into complex systems, a 5GL with 6th normal form.

Hypergraph provides GOAL with the basis for a declarative (constraint-based) language. The Hypergraph is conceptually implemented as an EAV with immutable, log-style, append-only persistence which affords Columnar, list processing, hyper-efficient storage and shared memory physically implemented as a columnar db.

In GOAL, the Hypergraph is implemented as a Bigraph, supporting the homoiconic aspect of the language, which enables the modeling and processing of both data and behavior, while the Bigraph logically separating the concerns. Since the Bigraph is part of the Hypergraph, it is conceptually implemented in the same way (i.e., tags as attributes on rows in EAV as described herein).a

The Bigraph consists of Link and Place Graphs. The Link Graph provides a reflective, graph-based DSL used to describe Entities and Aggregates in the language as Graph Objects (ADTs-Abstract Data Types). The Place Graph provides a reflective, graph-based DSL used to describe Types and Behaviors as Graph Processes (ADTs/DAGs-Abstract Data Types/Directed Acyclic Graphs), The Link Graph and Place Graph DSLs are implemented directly in GOAL, supporting a Dynamic, Functional, object, domain, interface, config, workflow language with prototypal inheritance physically implemented in a suitable programming language such as JavaScript, with the underlying metaprogramming types (ADTs and DAGs) implemented using Listing Processing, which affords expressive and hyper-efficient processing and serialization, physically implemented using Monadic Transformers as part of a server-less (agent) runtime.

The design elements found in the diagram and described above can be summarized as follows:

| Design | | | | | | |
|---|---|---|---|---|---|---|
| Element/ | | | Link Graph - | | | |
| Design | Hyper- | | Entities/ | Place Graph- | Graph Objects | Graph Processes |
| Decision | graph | Bigraph | Aggregates | Types/Behavior | (ADTs) | (ADTs/DAGs) |
| Language | Declarative | Homoiconic | Reflection/ | Reflection/ | Metaprogramming | Metaprogramming |
| Properties | (constraint- | | Graph-based | Graph-based | | |
| | based) | | DSL | DSL | | |
| | language | | | | | |
| Conceptually | EAV with | EAV with | Graph | Graph | List Processing | List Processing |
| implemented | immutable, | immutable, | Object | Object | | |
| as | log-style, | log-style, | Action | Action | | |
| | append-only | append-only | Language | Language | | |
| | persistence | persistence | (GOAL) | (GOAL) | | |
| Implementation | Columnar, | Columnar, | Dynamic, | Dynamic, | Expressive and | Expressive and |
| Affordances | list | list | Functional, | Functional, | hyper-efficient | hyper-efficient |
| | processing, | processing, | object, | object, | processing and | processing and |
| | hyper- | hyper- | domain, | domain, | serialization | serialization |
| | efficient | efficient | interface, | interface, | | |
| | storage and | storage and | config, | config, | | |
| | shared | shared | workflow | workflow | | |
| | memory | memory | language | language | | |
| | | | with | with | | |
| | | | prototypal | prototypal | | |
| | | | inheritance | inheritance | | |
| Physically | Columnar | Columnar | Javascript/J | Javascript/J | Runtime/MT/ | Runtime/MT/ |
| implemented | DB | DB | VM (or | VM (or | Agents/FaaS | Agents/FaaS |
| as | | | similar) | similar) | | |

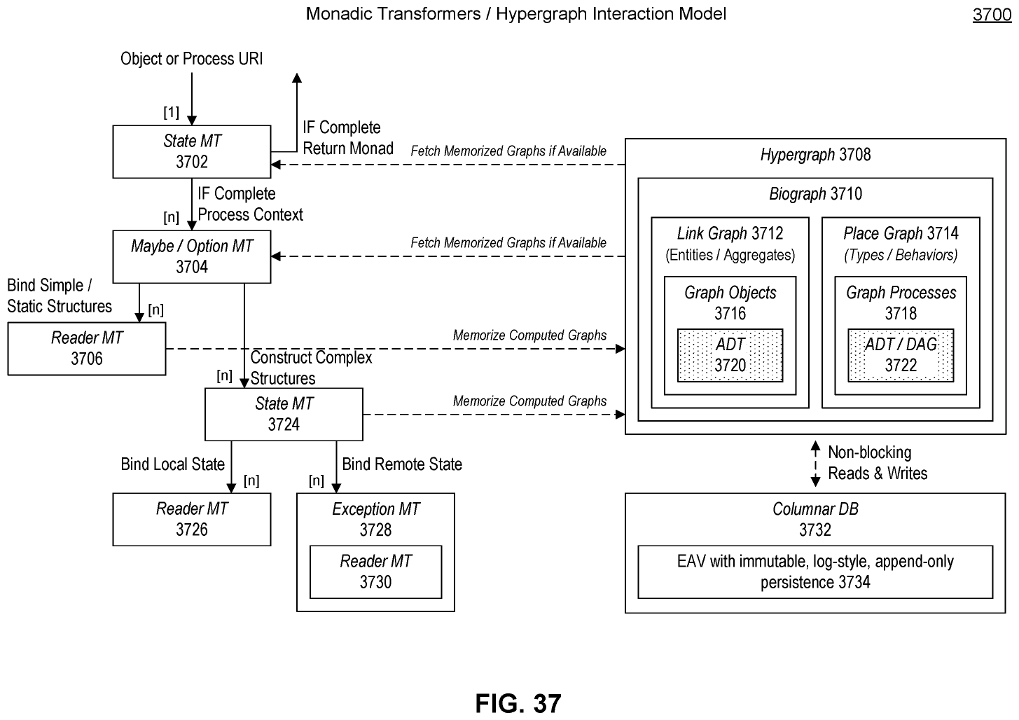

FIG. 37 is a block diagram of a monadic transformer/hypergraph interaction model 3700, according to some embodiments.

The diagram depicts a basic interaction pattern between the set of Monadic Transformers (MTs) implemented in GOAL, and the Hypergraph, in the context of interpreting a URI (for an graph object or process) modeled in the Hypergraph.

On the left of the diagram are the set of MTs which are invoked and chained by the system to contextualize the request, assembling a graph (object or process) and binding state (local and remote). The names on each MT refer to commonly known MT types/patterns—each of which is implemented as a pattern itself. On the right, is a depiction of the nested elements that compose the hypergraph, which is implemented as an EAV in a columnar database per the earlier descriptions.

The flow starts with a request, in the form of a URI corresponding to a graph in the Hypergraph. The graph could be either a Graph Object (a rich contextualized data object) or a Graph Process (a rich contextualized behavior), or potentially a composition of one or more of each (which itself is a Graph Object). A single “State MT” is dispatched by the system to contextualize the URI, converting it to a “stateful object” (i.e., Monad) corresponding to the requested Graph Object or Process. This initial MT acts as a wrapper for the entire interaction, sometimes referred to as a closure, and will dynamically dispatch other MTs to progressively assemble the object to be returned.

The initial “State Monad” immediately consults the Hypergraph to see if the request object has already been constructed and is in memory (i.e., memoized). If it is, the object is immediately fetched.

In most cases, this is not the case, and the MT dispatches one or more “Maybe/Option” MTs to evaluate the state of the graph as it is assembled. These MTs also consult the Hypergraph, but in this case fetch either an ADT (corresponding to a Graph Object to be assembled) or an ADT/DAG (corresponding to the Graph Process to be assembled). As these are underspecified graphs by definition (abstract), an additional set of MTs will be dispatched. The first MT is to bind any simple or static structures (e.g., fixed attributes of an object, links to policies, etc). This effectively creates a “prototype” which is then memoized (in the hypergraph) as a new version on the object, in effect creating an intermediary representation of the unfinished graph which can be used in future as a form of cache to accelerate future executions of the same process. Once the static structure is bound, if further context is required, another “State” MT is constructed. It again forms a closure over subsequent MTs, but in this case the set of MTs it creates are specifically used to bind Complex Structures (dynamic or real-time bind of context to the Monad). It spawns one or more “Reader” MTs which fetch local state from the Hypergraph via its parent MT (i.e., by forcing it to progressively pull more state from the Hypergraph), and it spawns one or more “Exception” MTs to fetch remote state (i.e., from the environment an object or process is operating in). In the case of the “Exception” MT, it wraps a special “Reader MT” which fetches information related to fetching the remote context by way of the parent MT (i.e., by forcing it to pull connection/protocol/format information from the Hypergraph-a “Process Graph” of its own). The “Exception” MT then carries out the remote fetch of state, and binds it to the parent MT, except in the case of a failure, where it then “handles” the exception by fetching Process Graph to automatically implement compensations and other corrective measures that are appropriate for recovery.

When the entire process is complete (i.e., all MTs have completed executing), the structure of MTs “collapse”, the recursion returning results up the execution path until only the original “State” MT remains, containing the assembled Graph Object or Graph Process, which it then returns as a contextualized result.

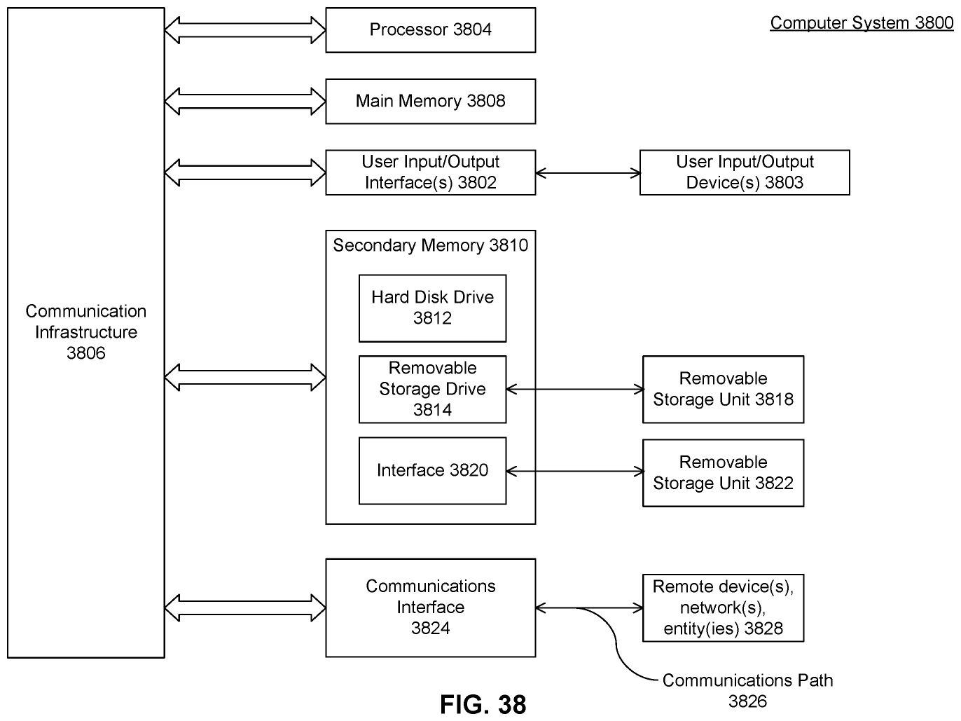

Various embodiments may be implemented, for example, using one or more well-known computer systems, such as computer system 3800 shown in FIG. 38. One or more computer systems 3800 may be used, for example, to implement any of the embodiments discussed herein, as well as combinations and sub-combinations thereof.

Computer system 3800 may include one or more processors (also called central processing units, or CPUs), such as a processor 3804. Processor 3804 may be connected to a communication infrastructure or bus 3806.

Computer system 3800 may also include user input/output device(s) 3808, such as monitors, keyboards, pointing devices, etc., which may communicate with communication infrastructure 3806 through user input/output interface(s) 3802.

One or more of processors 3804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 3800 may also include a main or primary memory 3808, such as random access memory (RAM). Main memory 3808 may include one or more levels of cache. Main memory 3808 may have stored therein control logic (i.e., computer software) and/or data.

Computer system 3800 may also include one or more secondary storage devices or memory 3810. Secondary memory 3810 may include, for example, a hard disk drive 3812 and/or a removable storage device or drive 3814. Removable storage drive 3814 may be a floppy disk drive, a magnetic tape drive, a compact disk drive, an optical storage device, tape backup device, and/or any other storage device/drive.

Removable storage drive 3814 may interact with a removable storage unit 3818. Removable storage unit 3818 may include a computer usable or readable storage device having stored thereon computer software (control logic) and/or data. Removable storage unit 3818 may be a floppy disk, magnetic tape, compact disk, DVD, optical storage disk, and/any other computer data storage device. Removable storage drive 3814 may read from and/or write to removable storage unit 3818.

Secondary memory 3810 may include other means, devices, components, instrumentalities or other approaches for allowing computer programs and/or other instructions and/or data to be accessed by computer system 3800. Such means, devices, components, instrumentalities or other approaches may include, for example, a removable storage unit 3822 and an interface 3820. Examples of the removable storage unit 3822 and the interface 3820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 3800 may further include a communication or network interface 3824. Communication interface 3824 may enable computer system 3800 to communicate and interact with any combination of external devices, external networks, external entities, etc. (individually and collectively referenced by reference number 3828). For example, communication interface 3824 may allow computer system 3800 to communicate with external or remote devices 3828 over communications path 3826, which may be wired and/or wireless (or a combination thereof), and which may include any combination of LANs, WANs, the Internet, etc. Control logic and/or data may be transmitted to and from computer system 3800 via communication path 3826.

Computer system 3800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 3800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 3800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 3800, main memory 3808, secondary memory 3810, and removable storage units 3818 and 3822, as well as tangible articles of manufacture embodying any combination of the foregoing. Such control logic, when executed by one or more data processing devices (such as computer system 3800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 38. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for mediating interactions with artificial intelligence technologies, including but not limited to generative AI, on behalf of human and system client requests made through a user-interface, application programming interface, or natural language interface, involving an automation platform that provides a process to ground and enrich the interactions with context in order to optimize the processing of the interactions, the quality of the related outputs of artificial intelligence technologies, and the related actions of the automation platform, which may be part of a larger activity, comprising:
receiving the request from a client;
tagging the request with interaction-specific embeddings determined by referencing a graph that implements concepts, types, and policies for an automation platform;
passing the tagged request to an artificial intelligence;
receiving a vector-based output from the artificial intelligence;
deterministically mapping the vector-based output to one or more tags corresponding to the concepts, types, and policies in the automation platform using the graph;
determining an action to complete in the automation platform based on the one or more tags;
performing the action in the automation platform; and
returning to the client a response indicating a result of the action.

2. The method of claim 1, wherein the artificial intelligence is a large language model, a generative artificial intelligence, a neural network, a natural language processor, a large action model, or other artificial intelligence technology.

3. The method of claim 1, the determining the action further comprising:
determining that a plurality of potential actions correspond to the one or more tags;
translating the one or more tags to a set of embeddings; and
ranking the set of embeddings of each potential action to reduce the plurality of potential actions to a single action.

4. The method of claim 1, the determining the action further comprising:
determining that a plurality of potential actions correspond to the one or more tags;
translating the one or more tags to a set of embeddings;
repeatedly passing the tagged request and the set of embeddings for the remaining potential actions to the artificial intelligence to reduce the plurality of potential actions to a single action.

5. The method of claim 1, the performing the action in the automation platform further comprising:
determining that additional client context is required to complete the action; and
prompting the client to provide the additional context.

6. The method of claim 1, wherein the request is a system request in a natural language received through a natural language interface, the tagging the request with interaction-specific embeddings further comprising:
translating the request using a natural language processing service to derive a text-based version of the natural language.

7. The method of claim 1, the returning the response to the client further comprising:
translating an output of an interaction with the artificial intelligence using a natural language processing service, wherein the output is a spoken response.

8. The method of claim 1, wherein the graph models the concepts, types, and policies of the automation platform using a symbolic, metaprogramming language that is interpreted at runtime with a monadic transformer as part of a function-as-a-service architecture.

9. The method of claim 1, the symbolic, metaprogramming language employs a Hindley-Milner type system.

10. The method of claim 1, wherein the graph comprises a physical data layer implemented as an entity, attribute, value data structure that records state changes in an append-only, log-style database.

11. The method of claim 1, wherein the graph comprises a bigraph that provides for discrete management of objects and abstract rewriting from types and transitions.

12. The method of claim 1, wherein the concepts, types, and policies model elements of the automation platform, targeted solution domains, and related collections of domain objects, respectively represented by an upper ontology, a domain knowledge graph, and a catalog of domain objects.

13. The method of claim 1, the deterministically mapping further comprising:
employing a vector-native database as an intermediary to translate between the vector-based output and the one or more tags.

14. The method of claim 1, wherein the request is a request to onboard solution elements, a request to compose solution elements into a service, a request to order a service, a request to deploy service, or a request to optimize a service.

15. The method of claim 14, wherein a domain of the application is networking and the application is a network service.

16. The method of claim 14, wherein the network service is a 5G radio access network with a secure edge gateway or an industrial internet-of-things application for computer-vision-based security.

17. The method of claim 1, wherein a domain of the application is code support for software developers, further comprising:
improving the artificial intelligence to generate optimized output by tuning the artificial intelligence with code samples and associated logs corresponding to the one or more tags.

18. The method of claim 17, wherein the request is triggered by an update to source code files in a code repository observed by the automation platform, further comprising:
passing code from the code repository to the artificial intelligence;
determining a set of recommendations based on the vector-based output from the artificial intelligence; and
displaying the set of recommendations as the response.

19. The method of claim 17, further comprising:
passing code and logs from the code repository to the artificial intelligence;
determining a set of recommendations based on the vector-based output from the artificial intelligence; and
displaying the set of recommendations as a document as the response.

20. The method of claim 1, further comprising:
retrieving a model of a requested large language model from the graph;
receiving a code sample and a log sample from a user;
tagging the code sample and the log sample with domain-specific embeddings determined by referencing the graph to create an encoded sample; and
employing an intermediary to tune the local instance of the requested large language model with the encoded sample.

21. The method of claim 13, wherein the domain is networking and the request is to order and establish a network service.

22. The method of claim 1, further comprising:
displaying cues in a client user-interface provided by the automation platform, wherein the cues indicate one or more types of prompts available for the artificial intelligence on a particular screen in the client user-interface.

23. The method of claim 1, wherein the graph is a hypergraph.

24. The method of claim 1, wherein the automation platform is deployable on-premise, in a cloud computing system, or at a network edge.

25. A system for mediating interactions with artificial intelligence technologies, including but not limited to generative AI, on behalf of human and system client requests made through a user-interface, application programming interface, or natural language interface, involving an automation platform that provides a process to ground and enrich the interactions with context in order to optimize the processing of the interactions, the quality of the related outputs of artificial intelligence technologies, and the related actions of the automation platform, which may be part of a larger activity, comprising:
a memory; and
at least one processor coupled to the memory and configured to:
receive the request from a client;
tag the request with interaction-specific embeddings determined by referencing a graph that implements concepts, types, and policies of an automation platform;
pass the tagged request to an artificial intelligence;
receive a vector-based output from the artificial intelligence;
deterministically map the vector-based output to one or more tags corresponding to the concepts, types, and policies in the automation platform using the graph;
determine an action to complete in the automation platform based on the one or more tags;
perform the action in the automation platform; and
return to the client a response indicating a result of the action.

26. A non-transitory computer-readable device having instructions stored thereon that, when executed by at least one computing device, causes the at least one computing device to perform operations for processing a request in a natural language with a domain-oriented architecture leveraging generative artificial intelligence, the operations comprising:
receiving the request from a client;
tagging the request with interaction-specific embeddings determined by referencing a graph that implements concepts, types, and policies of an automation platform;
passing the tagged request to an artificial intelligence;
receiving a vector-based output from the artificial intelligence;
deterministically mapping the vector-based output to one or more tags corresponding to the concepts, types, and policies in the automation platform using the graph;
determining an action to complete in the automation platform based on the one or more tags;
performing the action in the automation platform; and
returning to the client a response indicating a result of the action.
